(19) United States
(12) Patent Application Publication
(10) Pub. No.: US 2003/0230443 A1
(43) Pub. Date: Dec. 18, 2003

(54) Advanced composite hybrid-electric vehicle

(76) Inventors: David Cramer, Basalt, CO (US); David Taggart, San Carlos, CA (US); Timothy Moore, Boulder, CO (US); David Cooper, Witney (GB); Serve Ploumen, Mechelen (NL); Malcolm Sim, Swindon (GB); David Wareing, Peterborough (GB); Chris Wright, Beacon Cove (AU)

Correspondence Address: MICHAEL D. BEDNAREK, SHAW PITTMAN, 1650 TYSONS BOULEVARD, MCLEAN, VA, 22102, US

(21) Appl. No.: 10/337,730

(22) Filed: Jan. 8, 2003

Related U.S. Application Data
(60) Provisional application No. 60/345,638, filed on Jan. 8, 2002.
(60) Provisional application No. 60/350,015, filed on Jan. 23, 2002.

(51) Int. Cl. B60K 1/00

(52) U.S. Cl. 180/65.5

(57) ABSTRACT

An advanced composite hybrid-electric vehicle including one or more of lightweight, advanced composite structures, modular rear suspension and traction motor units, fuel-cell hybrid-electric powertrains, integrated electromagnetic and pneumatic suspension systems, and a digital network-based control system and information management architecture that uses a fault tolerant ring main power supply.

This application claims the benefit of U.S. Provisional Applications Nos. 60/345,638, filed Jan. 8, 2002 and 60/350,015, filed Jan. 23, 2002, which are herein incorporated by reference in their entirety.

### BACKGROUND

1. Field of the Invention

The present invention relates generally to hybrid-electric vehicles, and, more particularly, to hybrid-electric vehicles incorporating lightweight advanced composite structures, modular rear suspension and traction motor units, fuel-cell hybrid-electric powertrains, integrated electromagnetic and pneumatic suspension systems, and/or a digital network-based control system and information management architecture that uses a fault tolerant ring main power supply.

2. Background of the Invention

The strategic, business, and social need for fuel-efficient and clean vehicles is evident worldwide. In developing countries where there is accelerating growth and sales of automobiles, policymakers have an opportunity to direct this growth toward clean and efficient vehicles. In industrialized countries, consumers and policymakers are beginning to demand or require high environmental performance without compromising safety, amenity, driving performance, or cost. Globally, the transportation sector's seemingly insatiable thirst for petroleum compromises national security by creating strong petroleum dependencies on unstable regions. The United States, for instance, imports 53% of its petroleum and Europe imports 76%, making them heavily dependent on petroleum exported from the politically volatile Middle East.

The same dynamic is emerging in developing countries. China, for instance, currently imports 30% of its petroleum, but with vehicle sales growing 10% per year, by 2010 this figure is expected to climb to 50%. Thus, China is rapidly heading the same direction as North America and Europe by becoming heavily dependent on unstable regions of the world for a key input to its economy.

Recognizing this need, the global auto industry has made advances in developing cleaner engines, improving driveline efficiency, and lightweighting. The industry increasingly uses high-strength steel, aluminum, magnesium, plastics, and composites, all to varying degrees, to achieve modest weight savings. Nevertheless, much more technical progress is required in order to improve fuel economy significantly and reduce emissions fleet-wide. Currently, automakers are focusing development on hybrid-electric and fuel cell drive systems. Additional changes will be required to the entire vehicle platform to make these advanced drive systems cost competitive with conventional drive systems in the near- and mid-term.

### SUMMARY OF THE INVENTION

Recognizing the weight, range, performance, size, and cost challenges associated with fuel-cell and hybrid propulsion systems, the present invention provides a hybrid-electric vehicle that incorporates one or more of lightweight, advanced composite structures, modular rear suspension and traction motor units, fuel-cell hybrid-electric powertrains, integrated electromagnetic and pneumatic suspension systems, and a digital network-based control system and information management architecture that uses a fault tolerant ring main power supply.

### BRIEF DESCRIPTION OF THE DRAWINGS

The accompanying drawings, which are included to provide a further understanding of the invention and are incorporated in and constitute a part of this specification, illustrate embodiments of the invention and together with the description server to explain the principles of the invention. In the drawings:

FIG. 1 is a schematic diagram that illustrates an exemplary advanced composite lightweight vehicle design, according to an embodiment of the present invention.

FIG. 2 is a schematic diagram that shows an isometric view of the exemplary body structure of FIG. 1.

FIG. 3 is a schematic diagram of an exploded isometric view of an advanced composite safety cell, according to an embodiment of the present invention.

FIG. 4 is a graphical flowchart illustrating a preferred assembly sequence for the exemplary vehicle body structure of FIG. 1, according to an embodiment of the present invention.

FIGS. 4A-4N are schematic diagrams that illustrate the steps of FIG. 4 in more detail and on individual sheets.

FIG. 5 is a schematic diagram of a subframe according to an embodiment of the present invention.

FIG. 6 is a schematic diagram of a front crush structure according to an embodiment of the present invention.

FIG. 7 is a schematic diagram of a screen surround according to an embodiment of the present invention.

FIG. 8A is a schematic diagram of a bodyside according an embodiment of the present invention.

FIG. 8B is a schematic diagram that illustrates the side view-of a left bodyside, according to an embodiment of the present invention.

FIG. 8C is a schematic diagram that illustrates a plan view of the left bodyside of FIG. 8B.

FIG. 8D is a schematic diagram that illustrates a cross-sectional view of the bodyside of FIG. 8B along line A-A, showing a detail of a joint between a B-pillar of the bodyside and a B-frame.

FIG. 8E is a schematic diagram that illustrates a cross-sectional view of the bodyside of FIG. 8B along line B-B, showing how the bodyside joins with a front bulkhead lower.

FIG. 8F is a schematic diagram that illustrates a cross-sectional view of the bodyside of FIG. 8B along line C-C, showing how the bodyside joins with a floor.

FIG. 8G is a schematic diagram that illustrates a cross-sectional view of the bodyside of FIG. 8B along line D-D, showing how the bodyside joins with a tailgate ringframe.

FIG. 8H is a schematic diagram that illustrates a cross-sectional view of the bodyside of FIG. 8B along line E-E, showing a joint between the bodyside and a roof.

FIG. 8I is a schematic diagram that illustrates a cross-sectional view of the bodyside of FIG. 8B along line F-F, showing how the bodyside and a screen surround are joined.

FIG. 8J is a schematic diagram that illustrates a cross-sectional view of the bodyside of FIG. 8B along line G-G.

FIG. 9 is a schematic diagram that illustrates a floor component according to an embodiment of the present invention.

FIG. 10 is a schematic diagram that illustrates a firewall upper according to an embodiment of the present invention.

FIG. 11A is a schematic diagram that illustrates a firewall lower according to an embodiment of the present invention.

FIG. 11B is a schematic diagram illustrating an exemplary fabrication design of the firewall lower of FIG. 11A, according to an embodiment of the present invention.

FIG. 12 is a schematic diagram of a roof according to an embodiment of the present invention.

FIG. 13 is a schematic diagram of a B-frame according to an embodiment of the present invention.

FIG. 14 is a schematic diagram of a C-frame according to an embodiment of the present invention.

FIG. 15 is a schematic diagram of a tailgate ringframe according to an embodiment of the present invention.

FIG. 16 is a schematic diagram of a bodyside wedge according to an embodiment of the present invention.

FIG. 17 is a schematic diagram of a rear floor according to an embodiment of the present invention.

FIG. 18 is a schematic diagram of an exploded view of an exemplary exterior skin applied to the vehicle body structure of FIG. 1, according to an embodiment of the present invention.

FIG. 19 is a schematic diagram that illustrates the assembly and design of an exemplary closure for the vehicle body structure of FIG. 1, according to an embodiment of the present invention.

FIG. 20 is a table comparing the design features of the present invention to conventional approaches.

FIG. 21 is a schematic diagram that illustrates a vehicle dynamics system according to an embodiment of the present invention.

FIG. 22 is a schematic diagram of an exemplary electrically actuated steering system according to an embodiment of the present invention.

FIG. 23 is a schematic diagram of an electrically actuated caliper and carbon/carbon rotor and pads, according to an embodiment of the present invention.

FIG. 24 is a schematic diagram of an exemplary rear left brake sub-assembly, according to an embodiment of the present invention.

FIG. 25 is a schematic diagram of an exemplary front brake assembly, according to an embodiment of the present invention.

FIG. 26 is a schematic diagram of an electrically actuated braking system, according to an embodiment of the present invention.

FIGS. 27A and 27B are schematic diagrams of electromagnetic/pneumatic struts as applied to both a front (left) suspension assembly and a rear (right) suspension assembly, respectively, according to an embodiment of the present invention.

FIG. 28 is a schematic diagram that shows electromagnetic/pneumatic struts in relation to other suspension components and a subframe, according to an embodiment of the present invention.

FIG. 29 is a schematic diagram showing an exemplary pneumatic/hydraulic system for a suspension system, according to an embodiment of the present invention.

FIG. 30 is a flowchart describing an exemplary control scheme for a suspension system, according to an embodiment of the present invention.

FIGS. 31A and 31B are schematic diagrams that illustrate a carbon-reinforced composite A-arm, according to an embodiment of the present invention.

FIGS. 32A and 32B are finite element models of the A-arm shown in FIGS. 31A and 31B, according to an embodiment of the present invention.

FIG. 33 is a schematic diagram of an exemplary integrated rear suspension module, according to an embodiment of the present invention.

FIG. 34A is a schematic diagram of a cross-section of a composite trailing arm, according to an embodiment of the present invention.

FIG. 34B is a schematic diagram of a top view of the composite trailing arm shown in FIG. 34A.

FIG. 34C is a schematic diagram of a side view of the composite trailing arm shown in FIG. 34A.

FIGS. 35A and 35B are finite element models of the composite trailing arm shown in FIGS. 34A, 34B, and 34C, according to an embodiment of the present invention.

FIG. 36 is a schematic diagram that illustrates rear suspension modules mounted to rear wheels of a vehicle, according to an embodiment of the present invention.

FIG. CR1 is a schematic diagram that illustrates the layout of the major propulsion components of an exemplary powertrain system, according to an embodiment of the present invention.

FIG. CR2A is a schematic diagram of a top view of the powertrain system of FIG. CR1.

FIG. CR2B is a schematic diagram of a side view of the powertrain system of FIG. CR1.

FIG. CR2C is a schematic diagram of a front view of the powertrain system of FIG. CR1.

FIG. CR3 is an electrical schematic diagram of the exemplary powertrain system of FIG. CR1.

FIG. CR4 is a table describing an exemplary power management system, according to an embodiment of the present invention.

FIG. CR5 is a table that describes an exemplary propulsion control strategy for the powertrain components of FIGS. CR1 and CR2, according to an embodiment of the present invention.

FIG. CR6 is a schematic diagram of an exemplary coolant design system, according to an embodiment of the present invention.

FIG. D1 is a schematic diagram of an exemplary ring main power supply, according to an embodiment of the present invention.

FIG. D2 is a schematic diagram an exemplary dual-fused junction box, according to an embodiment of the present invention.

FIG. D3 is a schematic diagram that illustrates exemplary connections between the vehicle safety systems of the power distribution network of FIG. D1, according to an embodiment of the present invention.

FIG. D4 is a schematic diagram showing exemplary hard-wired inputs to the central controller of FIG. D1, according to an embodiment of the present invention.

FIG. D5 is a schematic diagram showing body controller wiring to the central controller of FIG. D1, according to an embodiment of the present invention.

FIG. D6 is a schematic diagram showing exemplary controller area network wiring, according to an embodiment of the present invention.

FIG. D7 is a schematic diagram of exemplary fault tolerant network wiring, according to an embodiment of the present invention.

FIG. D8 is a schematic diagram of exemplary telematics control wiring, according to an embodiment of the present invention.

FIG. D9 is a schematic diagram of exemplary audio amplifier wiring, according to an embodiment of the present invention.

FIG. D10 is a schematic diagram of an overall controller and network architecture, according to an embodiment of the present invention.

FIG. D11 is a schematic diagram of an exemplary user interface, according to an embodiment of the present invention.

FIG. D12 is a schematic diagram of an exemplary driver's display screen, according to an embodiment of the present invention.

FIG. D13 is a schematic diagram of an exemplary entertainment display screen, according to an embodiment of the present invention.

FIG. D14 is a schematic diagram of an exemplary navigation display screen according to an embodiment of the present invention.

FIG. D15 is a schematic diagram of an exemplary climate control display screen according to an embodiment of the present invention.

FIG. D16 is a schematic diagram of an exemplary ride setting display screen according to an embodiment of the present invention.

FIG. D17 is a schematic diagram of an exemplary guide display screen according to an embodiment of the present invention.

FIG. D18 is a schematic diagram of an exemplary identity setting display screen according to an embodiment of the present invention.

FIG. D19 is a schematic diagram of an exemplary diagnostics setting display screen according to an embodiment of the present invention.

FIG. D20 is a schematic diagram of schematic of an exemplary intervention settings display screen according to an embodiment of the present invention.

FIG. D21 is a schematic diagram of an exemplary plug-ins setting control panel according to an embodiment of the present invention.

FIG. D22 is a schematic diagram of an exemplary energy settings control panel according to an embodiment of the present invention.

FIG. D23 is a schematic diagram of an exemplary side stick and control pad, according to an embodiment of the present invention.

FIG. D24 is a schematic diagram of an exemplary method for actuation of a side stick, according to an embodiment of the present invention.

FIG. D25 is a table that describes an exemplary jog-wheel control, according to an embodiment of the present invention.

FIG. D26 is a flowchart that describes an exemplary process-for using a jog-wheel, according to an embodiment of the present invention.

### DETAILED DESCRIPTION OF THE INVENTION

Reference will now be made in detail to the preferred embodiments of the present invention, examples of which are illustrated in the accompanying drawings.

Integrated Design and Manufacturing Approach for Affordable Volume Production of Advanced Composite Automotive Structures

An aspect of the present invention provides an integrated design and manufacturing approach for affordable volume production of advanced composite automotive structures. This design and manufacturing approach can be applied to a full-size, but lightweight, automobile design to yield a highly efficient and affordable hybrid-electric automobile for general-purpose use. The approach greatly simplifies component design to minimize hard point integration, local complexity, and embedded details, while maximizing and taking advantage of global complexity, tailored load paths, self-fixturing and detoleranced assembly, and parts reduction. The interdependent production process involves the unique application of existing technologies to create preforms for subsequent part forming in a highly automated and repeatable manner consistent with volume production of 50,000 completed body structures per annum.

The design approach of this aspect of the present invention can be used for automobiles in general, and passenger style and sport utility style vehicles specifically.

An embodiment of the invention incorporates a process for continuous, tailored lamination of aligned composite materials in such a way that either pre-formed or pre-consolidated sheets are made available for subsequent infusion molding or stamping processes respectively. The infusion processes are similar to those already in widespread use such as resin transfer molding (RTM) or vacuum assisted resin transfer molding (VARTM). The stamping process is similar to that currently used to stamp steel automotive structures. These processes are described in more detail in the related co-pending application Ser. No. 09/916,254, filed Jul. 30, 2001, which is herein incorporated by reference in its entirety.

For either approach, liquid infusion or solid state stamping respectively, component design must be tailored to the processes to have the best chance of achieving performance and cost goals. The processing aspect of this embodiment of the invention incorporates aspects of several available technologies including fiber or tape placement, stretch-broken and commingled fiber yarns, binderized pre-forming, heated consolidation, and NC cutting and kitting, and can be used with either thermoplastic or thermoset matrix resins.

This aspect of the invention addresses the design and production of affordable advanced composite automotive structures using repeatable, monitorable, and production-friendly approaches and processes. The design approach is tailored specifically to provide a lowest fabrication cost solution, not necessarily the lightest weight solution. The processing approach is tailored specifically to provide repeatable, monitorable, and versatile production of engineered performs to provide affordable production of 50,000 units per year.

To date, no design or production solutions for advanced composite structures have been successful at production volumes higher than 5,000-10,000 units per year. For the most part, none of the solutions has attempted to incorporate a design approach that focuses primarily on cost reduction, as opposed to weight reduction. Moreover, none have attempted to integrate the fabrication processes of the present invention, which focus on repeatable, monitorable low cost and low labor content approaches.

Advanced composites are defined herein as highly aligned reinforcements of carbon, glass, or aramid fibers in a suitable polymer matrix of either thermoset or thermoplastic resins. The use of such highly aligned reinforcements is based on the following perception: The modulus of steel is 30,000,000 lbs/in², whereas the modulus of aluminum is 10,000,000 lbs/in². The modulus of a typical, higher quality glass epoxy prepreg is around 4,000,000 lbs/in². The composite materials currently being used by the automotive industry have even less stiffness than this and therefore do not offer the potential for dramatic improvements in structural performance.

Thus, the invention recognizes that, to benefit from the advantages of using composites in automobiles, the unique characteristics of composites must be incorporated into both the design and the production of the vehicle in a way that allows their inherent advantages to be realized, while avoiding long process cycle times and high labor content. This aspect of the invention therefore integrates the production demands of higher volume automotive structures with the higher performance available from advanced composite materials, in a way that yields repeatable, affordable performance.

This aspect of the invention addresses the fundamental elements required for a breakthrough in affordable high performance and high volume automotive structures to become a reality. Issues this invention successfully address are: 1) a perspective of what comprises the structure of an automobile that yields certain design freedoms that are exploited in the design and assembly approach of the components comprising that structure, 2) a simple and robust approach to bonded assembly of components, which eliminates completely the need for mechanical fasteners for general assembly, relieves the tolerance requirements of the assembled components, and provides a degree of self-fixturing that yields less costly and faster assembly, 3) elimination of the need for general repairs of the advanced composite structure under most conditions, 4) innovative use of an aluminum sub-assembly to perform functions that are not particularly amenable to advanced composites, thus eliminating the need for expensive or hard to produce composite components, 5) innovative use of unreinforced exterior skin to uncouple the shape of the exterior surface from the highly reinforced body structure, thereby enabling a more simplified and less costly design solution, 6) innovative integration of several specific design features that contribute to the overall affordability and performance of the vehicle structure including: one piece transverse ring frames, integral sills, integral seat attachments, minimal parts count, and integral thermal and acoustic insulation, 7) a production process developed specifically to minimize touch labor between part design and near-finished part, while providing highly repeatable, tailorable, versatile, and controllable processes, minimizing scrap materials, enabling in-line process monitoring and control, and yielding aligned “continuous” like fibrous reinforcement in a variety of laminate architectures using the same equipment.

In taking this approach, this aspect of the present invention provides several benefits in terms of cost, structural performance, mass, durability, and modularity/tailorability.

In terms of cost, the design approach of the present invention, coupled with the advanced composite structure manufacturing process described in the related co-pending application Ser. No. (09/916,254, incorporated herein by reference), provide an advanced composite, carbon-fiber-reinforced automotive safety cell that could be produced at attractive volumes for a reasonable cost. The design approach of the present invention therefore fulfills a desire shared by all OEMs, which would like to produce lightweight composite vehicle structures, without a cost penalty at the vehicle and production levels. Currently, the entire automotive industry acknowledges that there is no such process currently available that can affordably produce composite vehicle structures at volumes greater than 10-20 k per year. Production cost based on the design and manufacturing approach of the present invention is estimated to be dramatically lower than any known carbon reinforced automotive structural solution, and competitive at the vehicle level with conventional design and production approaches.

The present invention also has benefits relating to structural performance. Conventional design and production of automobile structures involves stamped sheet metal components that use complex geometries to provide inherent stability. Assembly may include a range of processes such as welding, bonding, attachments, and mechanical fasteners. A typical steel body structure contains at least seventy major pressings, and the fabrication of each pressing requires numerous steps. In addition, these seventy pressings do not include closures or the assembly of any structures outside of what could be called the “safety cell.” This conventional approach, while extremely low cost at high volume, yields significant structural shortcomings and breaks down economically at volumes under 100 k per year. For example, structural shortcomings include welded joints at the “corner” of the torque box formed by the roof, body sides, and floor. The corner is the worst location for a spot welded joint because the process results in a hinge effect that minimizes the bending integrity of the corner, thus compromising resistance to side impact and rollover crash situations. Conventional assembly methods are also notorious for producing a wide range of tolerance in terms of fit-up and final dimensions of the structure, and for degrading rapidly over time due to fatigue. In contrast to these conventional methods and processes, the design approach of this aspect of the present invention separates the structure from the vehicle's unreinforced exterior skin, which is styled and colored, and thereby enables shape optimization of the structural components to better suit structural integrity and low cost production.

In terms of mass, in this aspect of the present invention, the combination of the lightweight materials, the structural design approach, the use of highly automated, repeatable processes, and a fully bonded assembly approach provide a vehicle structure that meets all applicable performance requirements at a significantly lower mass than any known conventional steel or other composite material approach.

In terms of durability, in this aspect of the present invention, the considered material selections, design approach, and assembly method contribute to dramatic reductions in the ill effects of the service environment, especially in comparison to conventional approaches. In particular, in the prior art, conventional stamped and welded body structures can lose bending and torsional stiffness within a year of purchase. These parameters are directly linked with road feel, ride and handling, noise, vibration and harshness (NVH), and crash safety.

In terms of modularity/tailorability, in this aspect of the present invention, the integrated design approach to the body structure enables production of different vehicle variants at a reduced incurred cost compared to conventional approaches. The present invention is able to provide this cost-effective modularity/tailorability because the investment for production of a single variant is far less than for a conventional stamped and welded steel structure, and because the general design and assembly approach are applicable even if the geometry and size of the components are changed to accommodate different vehicle requirements.

Overall, this aspect of the present invention includes one or more of the following features: 1) fastenerless, detoleranced, and self-fixturing assembly; 2) highly aligned but discontinuous carbon fiber reinforced components; 3) a part design that is compatible with globally complex and locally simple design philosophies; 4) the use of fiber placement technology to produce tailored performs of either binderized materials or fully impregnated materials; and 5) the use of a combination of solid-state stamping or performing and resin infusion to form final component shapes from the tailored blanks.

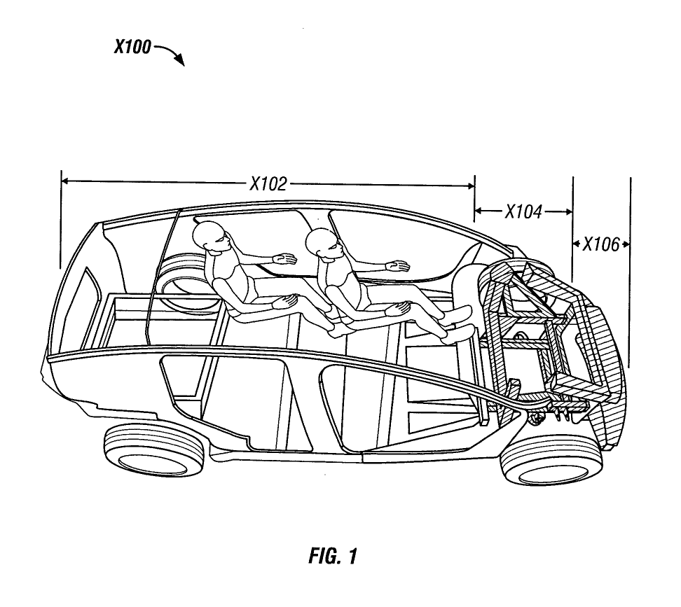

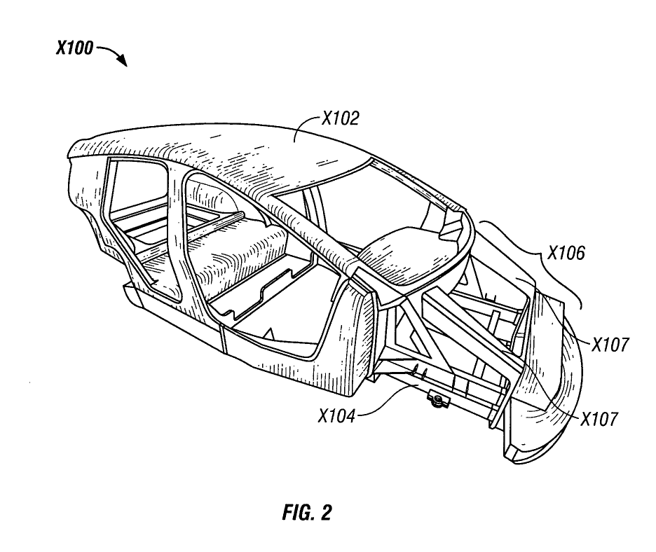

FIGS. 1-20 illustrate an exemplary design implementing the features described above.

FIG. 1 illustrates an exemplary advanced composite lightweight vehicle design, according to an embodiment of the present invention. For illustrative purposes, FIG. 1 and the subsequent related figures present a particular structural configuration. However, as one of ordinary skill in the art would appreciate, the design features of the present invention are equally applicable to other specific vehicle designs. For this reason, and notwithstanding the particular benefits associated with using the present invention for the particular illustrated design, the invention described herein should be considered broadly useful for any vehicle design.

As shown from a top-level structural configuration in FIG. 1, the exemplary vehicle body structure X100 includes three major structural sections, including an advanced composite safety cell X102, an aluminum subframe X104, and a front crush structure X106. The sectional layout of body structure X100 is unique for an automotive structure in that each section is designed specifically to absorb the energy that it will experience in its specific portion of the impact pulse during a crash event. Composites are used in front crush structure X106 to absorb energy in a sacrificial manner. Aluminum is used in subframe X104 to provide the majority of energy absorption because aluminum's crush behavior is very well understood. In addition, the complex design of subframe structure X104 is more affordable to produce out of aluminum than advanced composite. Advanced composites are used in safety cell X102 because this area typically encompasses the majority of the mass of a conventional steel vehicle structure and therefore represents the most potential for significant mass reduction.

FIG. 2 shows an isometric view of the exemplary body structure X100. As shown, advanced composite safety cell X102 includes all structure aft of aluminum subframe X104. Subframe X104 is attached to the front of safety cell X102. Front advanced composite crash structure X106 is disposed forward of subframe X104 and is attached to both subframe X104 and also safety cell X102. To attach to safety cell X102, front crash structure X106 includes A-pillar upper members X107 that span subframe X104 and attach to safety cell X102.

Of particular importance to the present invention is the geometry of the components in advanced composite safety cell X102. In a preferred embodiment of the present invention, all the components in safety cell X102 are designed specifically to be produced by the manufacturing process described in the related co-pending application Ser. No. (09/916,254, incorporated herein by reference), which utilizes advanced fiber placement technology to laminate “blanks” for subsequent thermoplastic stamping. In accordance with that manufacturing process and with the need to minimize production costs, the components of safety cell X102 preferably have very gentle geometries to facilitate fast cycle time and low-cost production.

As an example of this geometry, an aspect of the present invention minimizes the local complexity of the components of safety cell X102. Thus, in a preferred embodiment, every component in safety cell X102 is designed with no out-of-plane design features to minimize production cost.

Another aspect of the present invention provides integral and tailored load paths in the components of safety cell X102. In this manner, the load paths of safety cell X102 use component features required for other functions, such as the cant rail portion of the roof and the sill in the floor required for side impact protection.

Another aspect of the present invention provides fastenerless assembly of safety cell X102. In a preferred embodiment, a simple blade-clevis assembly interface is used for the assembly of every component in the safety cell. This simple joint design simplifies assembly by relieving the tolerance of the assembly interface in two of three dimensions, while providing a large bond area for adhesive bonding in a balanced double lap joint configuration, which is the best joint design for durability and load carrying capacity.

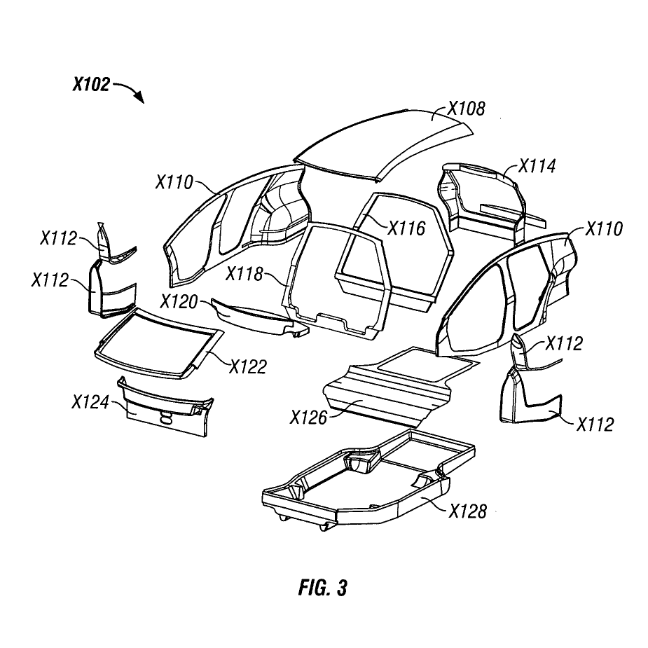

FIG. 3 shows an exploded isometric view of advanced composite safety cell X102, demonstrating the components and assembly interfaces of safety cell X102 according to an embodiment of the present invention. As shown, safety cell X102 includes a roof X108, bodysides X220, bodyside wedges X112, a tailgate ringframe X114, a C-frame X116, a B-frame X118, a firewall upper X120, a screen surround X122, a firewall lower X124, a rear floor X126, and a floor X128.

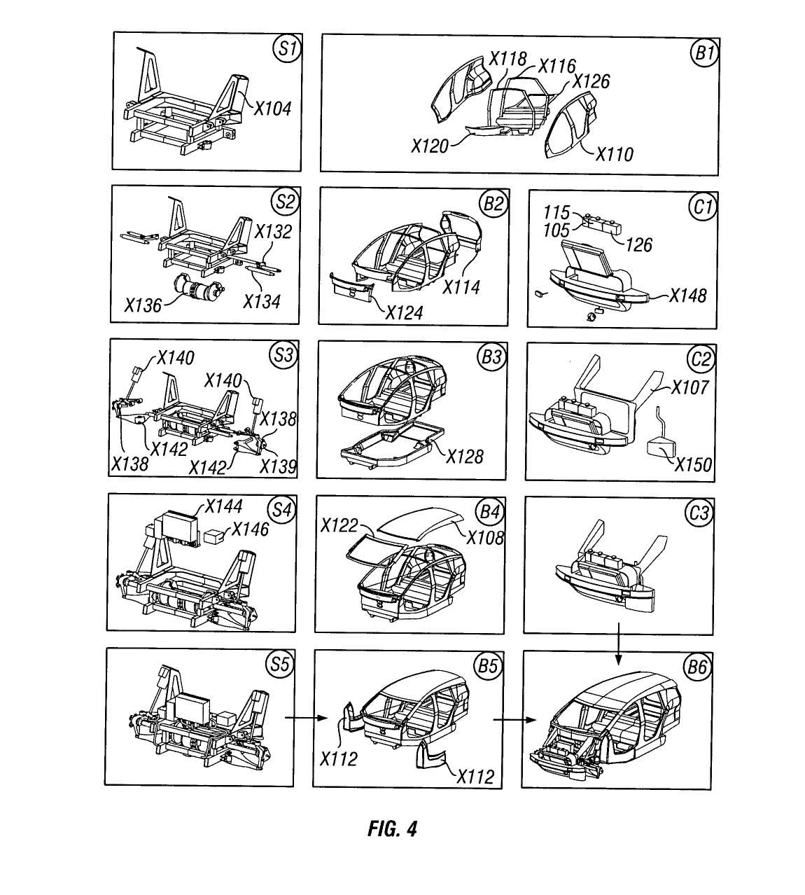

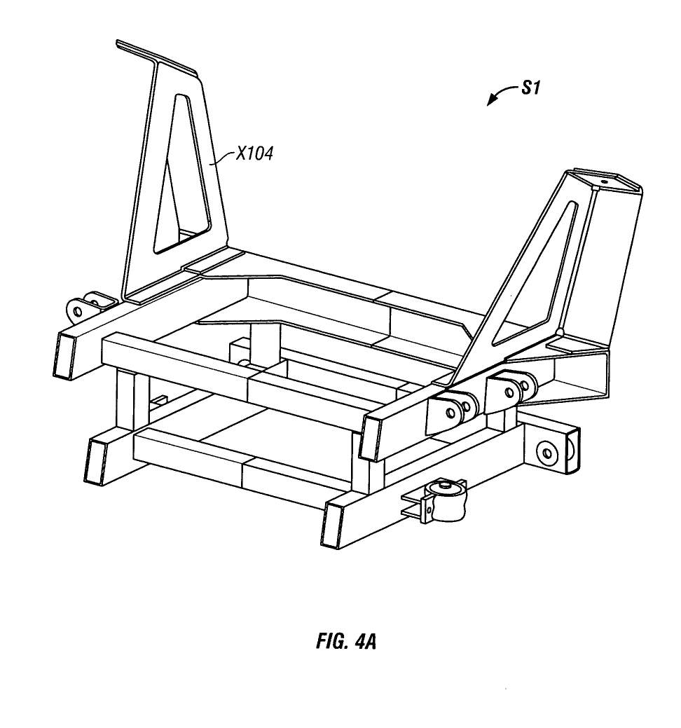

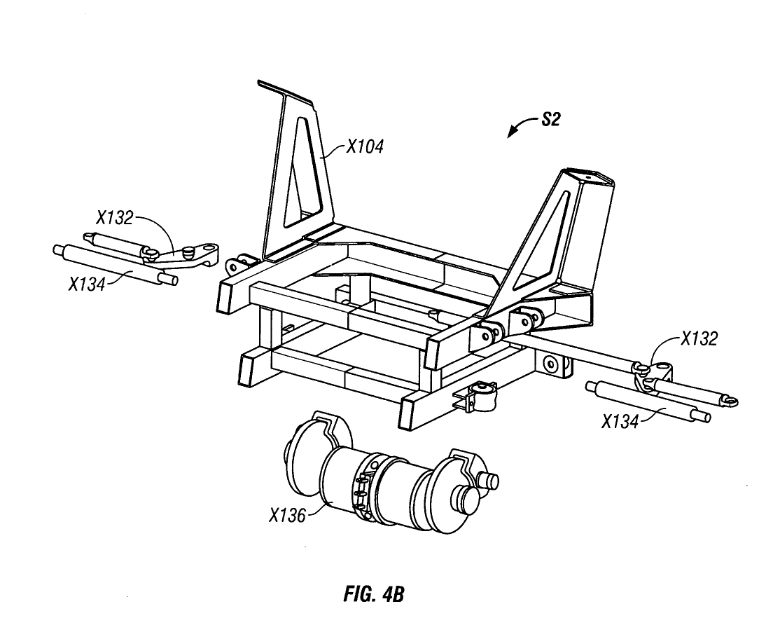

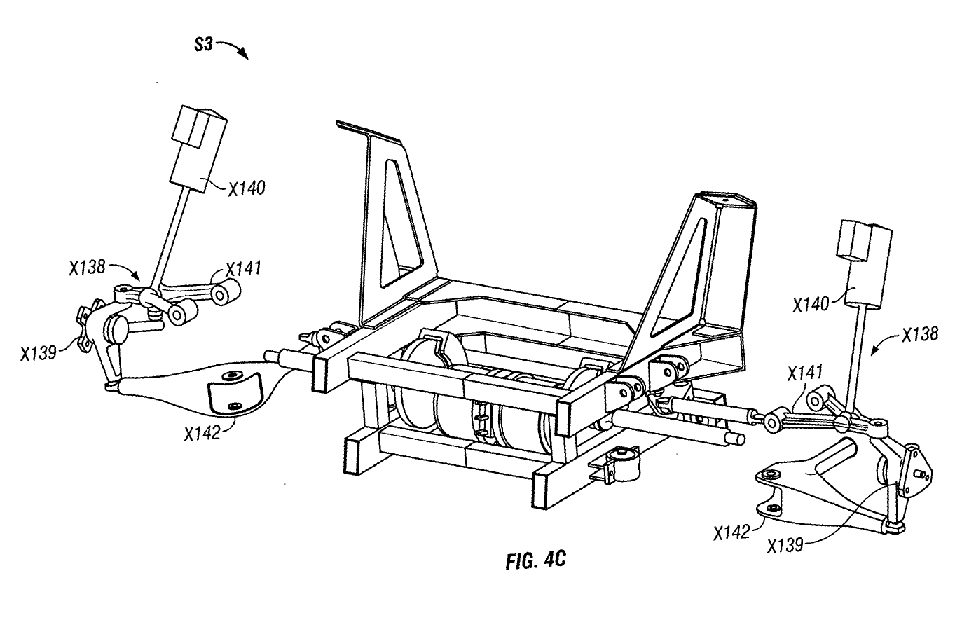

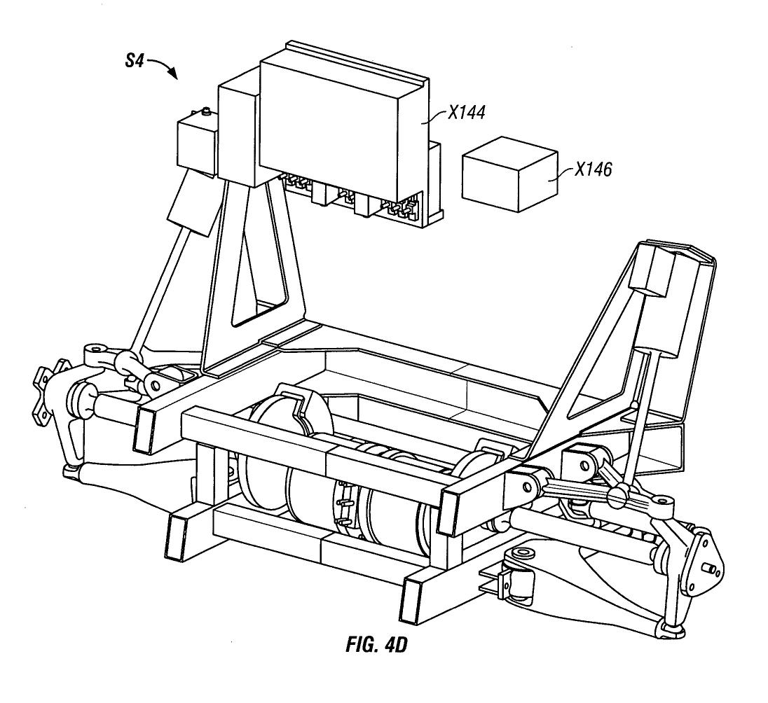

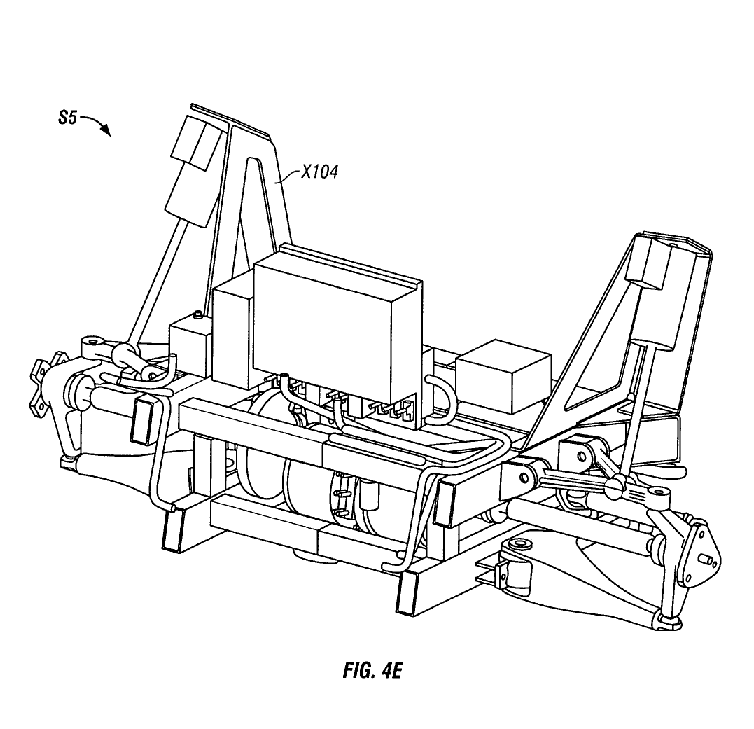

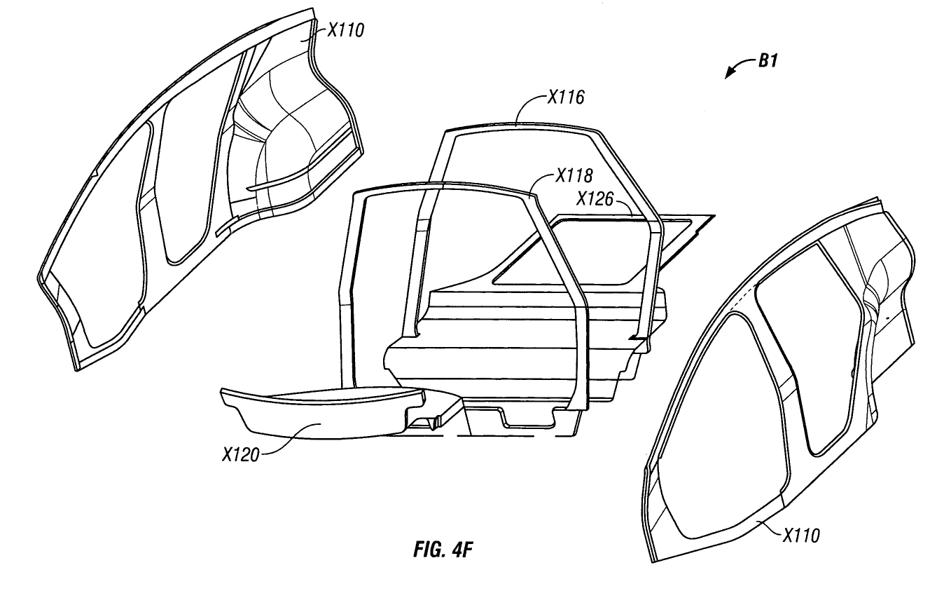

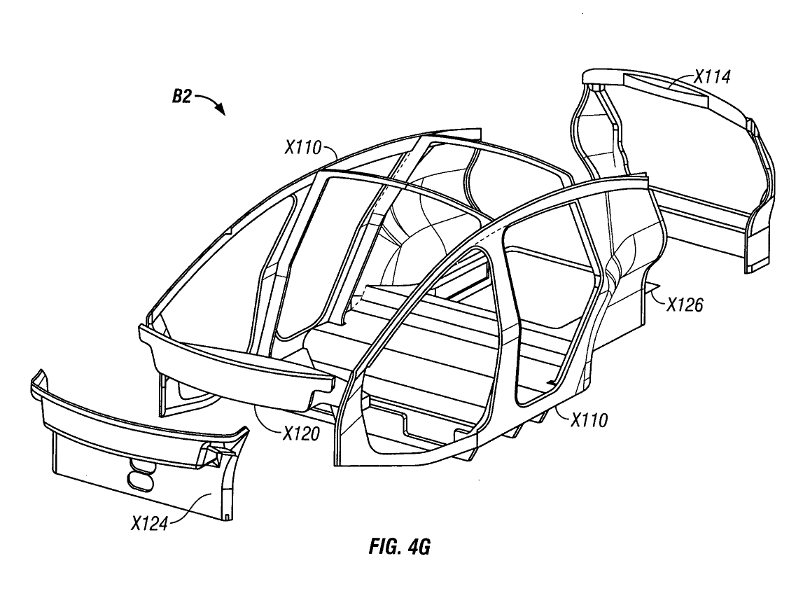

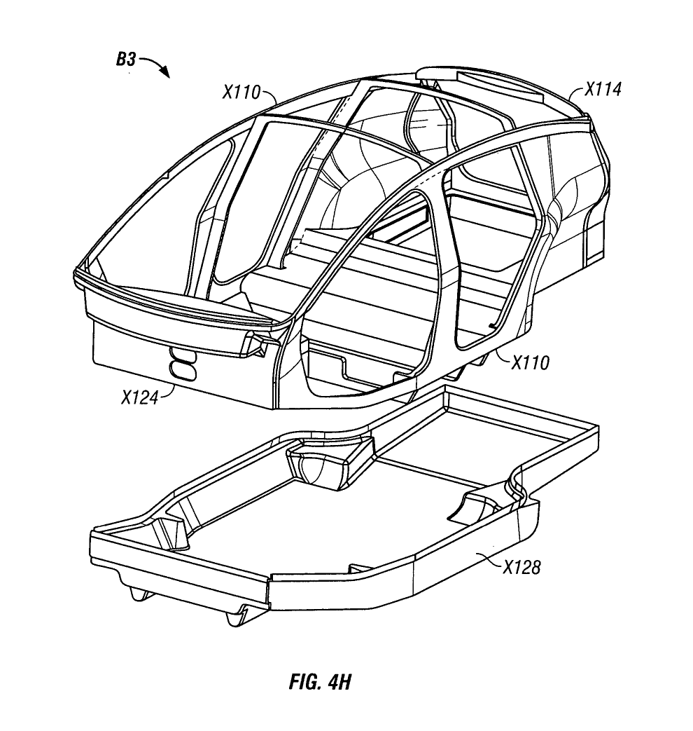

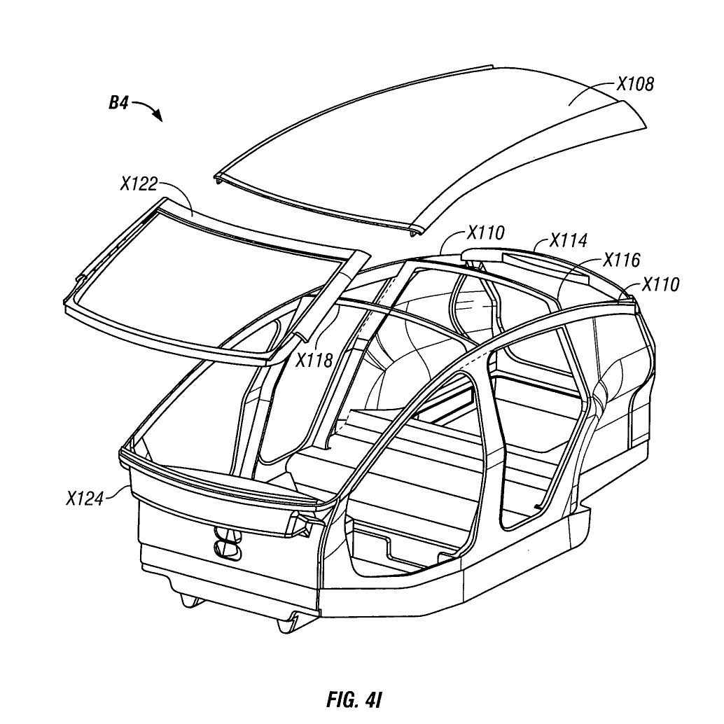

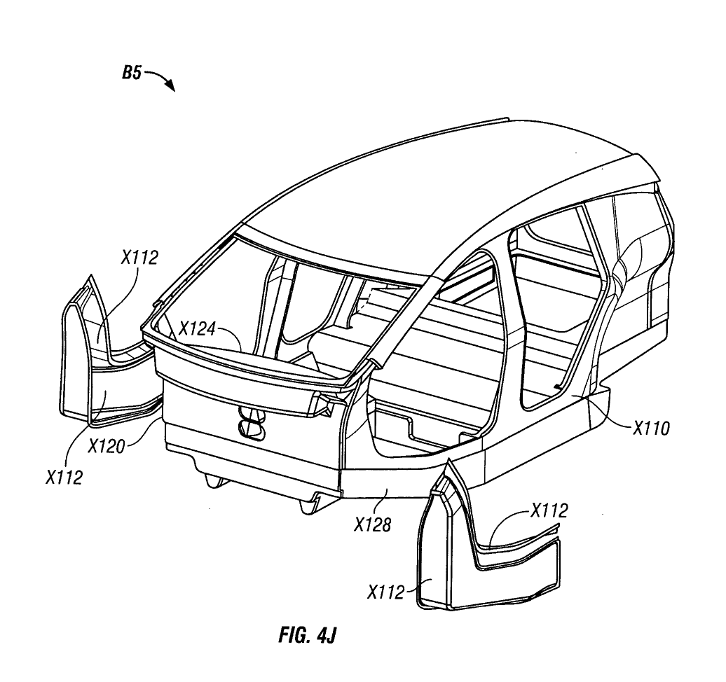

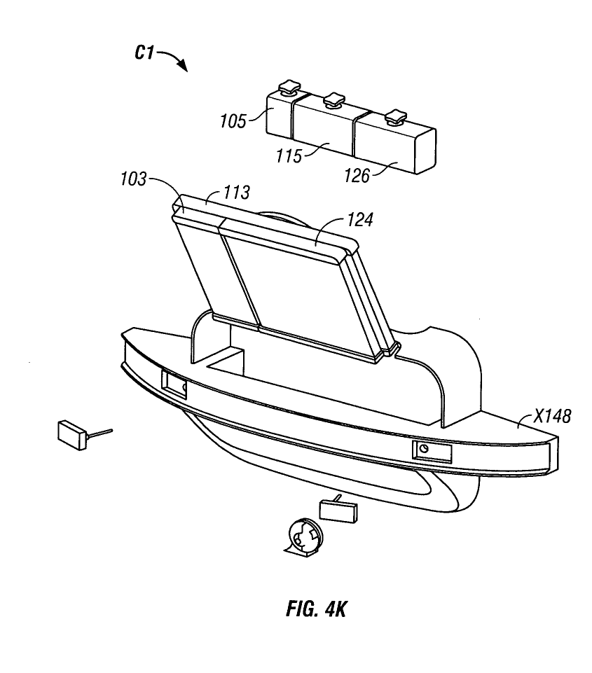

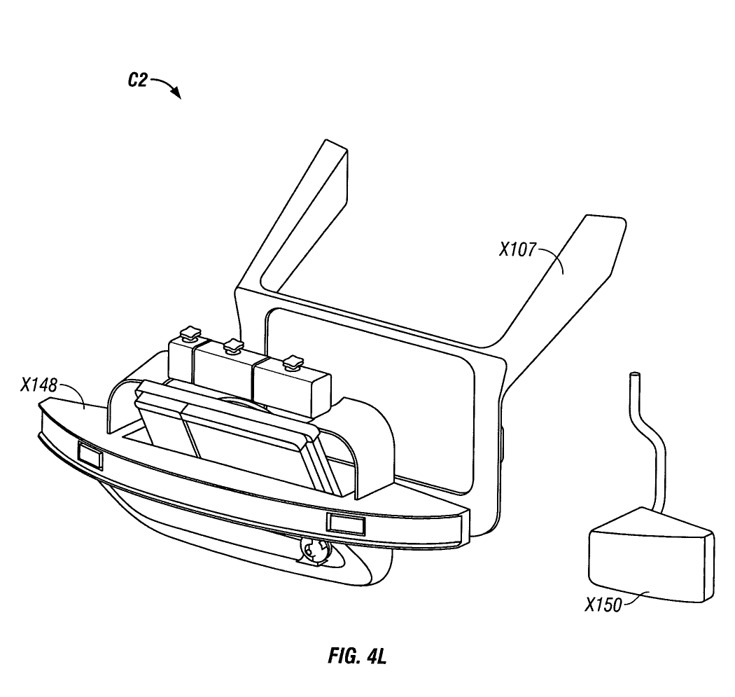

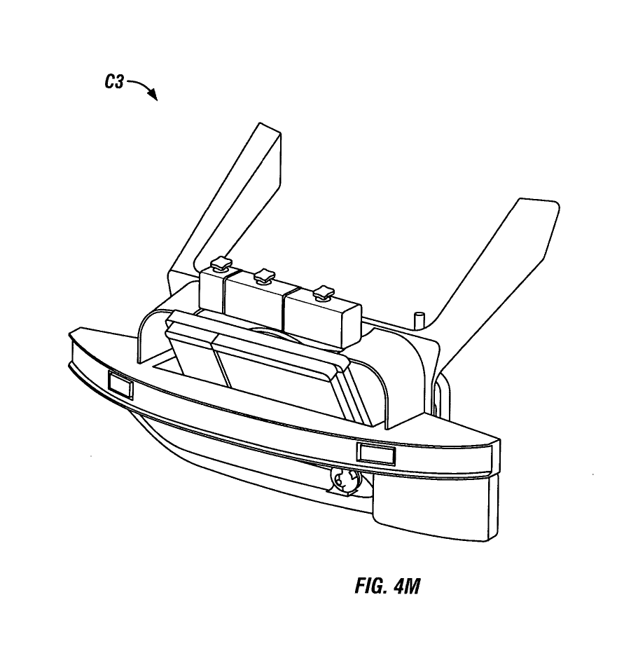

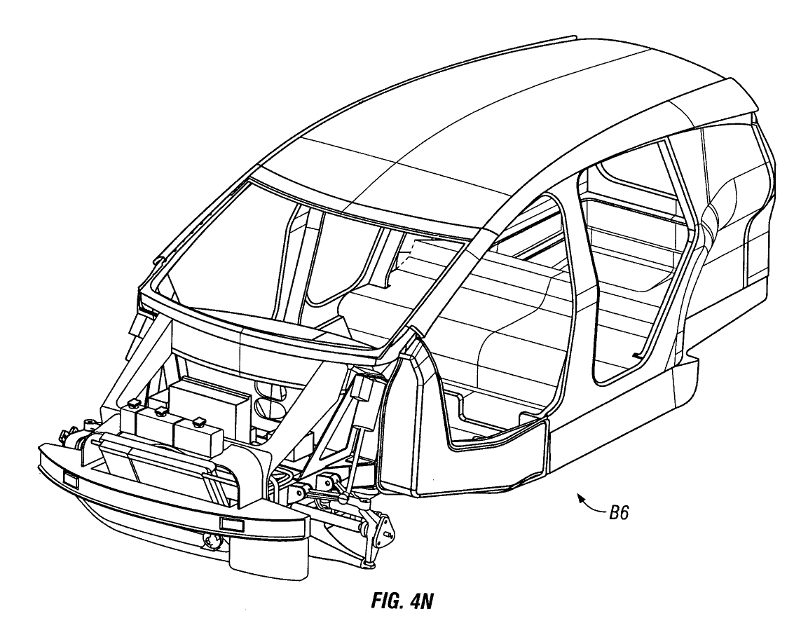

FIG. 4 illustrates a preferred assembly sequence for the exemplary vehicle body structure X100 of FIG. 1. As described above, vehicle body structure X100 includes the advanced composite safety cell X102, the front aluminum subframe X104, and the front crush structure X106. As shown in the FIG. 4, the assembly sequence proceeds from top to bottom and left to right, and involves the initial separate assemblies of subframe X104 and its associated components (steps S1-S4), safety cell X102 (steps B1-B4), and front crush structure X106 (C1-C3) and its associated components. Then, in the final assembly sequence (steps S5 to B5 to B6), subframe X104 is attached to safety cell X102, and the front crush structure X106 is then attached to safety cell X102 and subframe X104. Thus, in the exemplary flowchart of FIG. 4, an upper step must be completed before a lower step in the same vertical chain and a left step must be completed before a step to its right in the same horizontal chain. Steps in different vertical chains can be completed in series or in parallel.

FIGS. 4A-4N illustrate the steps of FIG. 4 in more detail, on individual sheets, each marked with its corresponding step (i.e., B1-B6, S1-S5, and C1-C3).

As shown in step S1 (FIGS. 4 and 4A), assembly of the subframe and its components begins with the aluminum subframe X104. Then, in step S2 (FIG. 4 and 4B), steering links X132 and axles X134 and traction motors/brake assemblies X136 are mounted on subframe X104. In step S3 (FIGS. 4 and 4C), suspension assemblies X138 are mounted on subframe X104. As shown, suspension assemblies X138 include electromagnetic struts X140 that attach to subframe X104 and to aluminum upper control arm X141, and carbon-reinforced composite lower suspension arms X142 that attach to subframe X104 and to steering knuckle X139. Finally, in step S4 (FIGS. 4 and 4D), front motor controller X144 and 42-volt accessory battery X146 are mounted on subframe X104. Having completed the assembly of subframe X104 and its associated components, in step S5 (FIGS. 4 and 4E), subframe X104 and its associated components are ready to be attached to safety cell X102. First, however, safety cell X102 must be assembled.

Thus, as shown in step B1 (FIGS. 4 and 4F), assembly of safety cell X102 begins by attaching B-frame X118, C-frame X116, and firewall upper X120 to rear floor X126, and attaching bodysides X110 to firewall upper X120, B-frame X118, C-frame X116, and rear floor X126. Then, in step B2 (FIGS. 4 and 4G), tailgate ringframe X114 is attached to bodysides X100 and rear floor X126, and firewall lower X124 is attached to bodysides X100 and firewall upper X120. In step B3 (FIGS. 4 and 4H), the components assembled to this point are then mounted on floor X128, attaching floor X128 to, for example, firewall lower X124, bodysides X110, rear floor X126, and tailgate ringframe X114. In step B4 (FIGS. 4 and 4I), roof X108 and screen surround X122 are mounted on top of the components assembled to this point. For example, as shown in FIG. 4, roof X108 is attached to bodysides X110, B-frame X118, C-frame X116, and tailgate ringframe X114. Screen surround X122 is attached to, for example, firewall lower X124, bodysides X110, and roof X108. Finally, in step B5 (FIGS. 4 and 4J), bodyside wedges X112 are attached to the components assembled to this point. For example, bodyside wedges X112 are attached to bodysides X110, firewall upper X120, firewall lower X124, and floor X128. Safety cell X102 is then ready to attach to subframe X104 and front crush structure X106.

As shown in step C1 (FIGS. 4 and 4K), the assembly of front crush structure X106 begins by mounting coolant expansion tanks 105, 115, and 126 and heat exchangers 103, 113, and 124 on a bumper structure X148. In step C2 (FIGS. 4 and 4L), a fluid bottle X150 and A-pillar upper X107 are mounted on bumper structure X148. In step C3 (FIGS. 4 and 4M), front crush structure X106 and its associated components are ready to attach to subframe X104 and safety cell X102.

For the final assembly, in step B6 (FIGS. 4 and 4N), subframe X104 is attached to safety cell X102, and front crush structure X106 is attached to subframe X104 and safety cell X102. Subframe X104 attaches to, for example, firewall upper X120, firewall lower X124, and floor X128. Front crush structure X106 attaches to, for example, firewall upper X120 and subframe X132. Assembly of the core vehicle structure is thus complete.

A preferred embodiment of the present invention uses blade-clevis joints to assemble the components as shown in FIG. 4. This type of joint enables the same assembly joint to be used to assemble all the components, while still providing a degree of self-fixturing capability to simplify assembly.

The individual components of FIGS. 3 and 4 will now be shown and described in more detail.

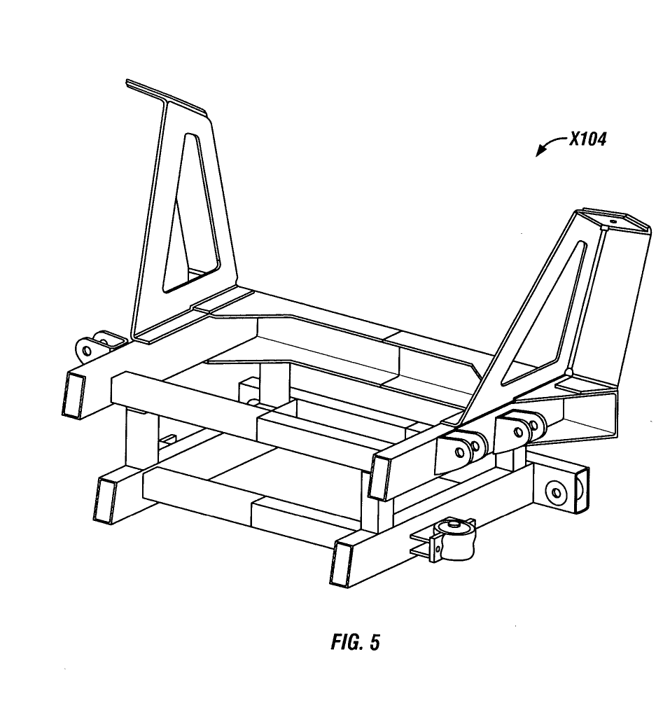

FIG. 5 illustrates subframe X104 according to an embodiment of the present invention. In a preferred embodiment, subframe X104 is a welded aluminum structure, built from constant cross-section aluminum tubing to minimize production costs. Subframe X104 houses and reacts to the loads of numerous vehicle components. In addition, subframe X104 serves as the interface between the front suspension components and the rest of the vehicle, and provides an intermediate crush structure between the front composite crush structure X106 and safety cell X102. Using aluminum, whose strength and crush behavior are very well characterized, enables a very efficient crush zone to be designed while also performing the other functions assigned to subframe X104. In addition, the well-known properties and performance of aluminum minimize development risks. The relatively low cost of aluminum also helps minimize production costs. Notwithstanding the benefits of aluminum, an alternative embodiment of the present invention provides a subframe X104 made of an advanced composite.

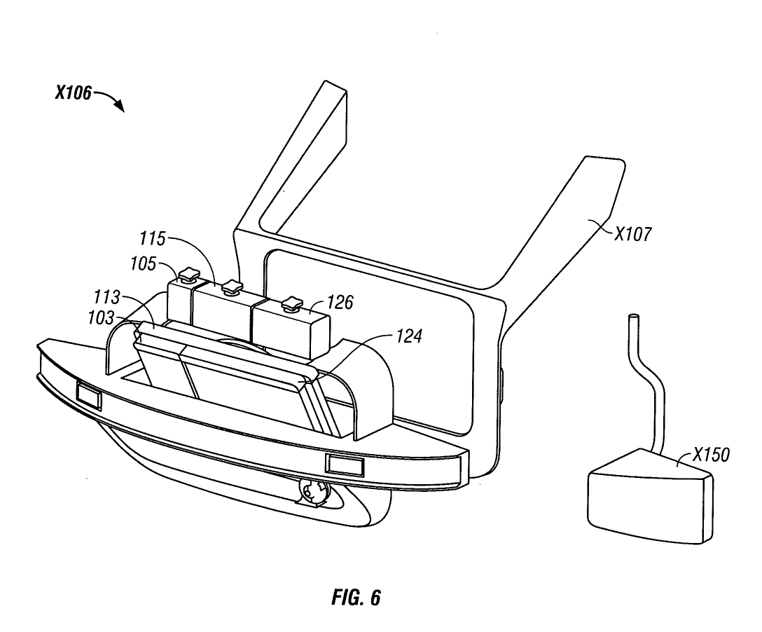

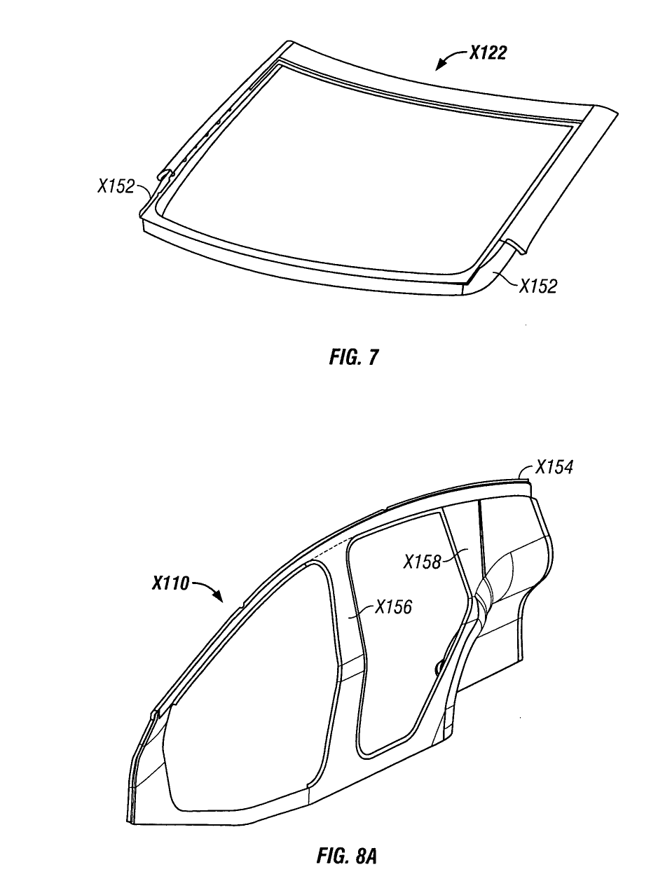

FIG. 6 illustrates front crush structure X106, according to an embodiment of the present invention. Preferably, front crush structure X106 is made from an advanced composite. This front-most component of the vehicle structure houses heat exchangers 103, 113, and 124, expansion tanks 105, 115, and 126, and fluid bottle X150.

Front crush structure X106 absorbs and distributes crash energy up to 15 mph. Structure X106 absorbs this energy through its own destruction during a crash event. The design of front crush structure X106 transfers the energy and loads that it absorbs into aluminum subframe X104. In particular, structure X106 transfers loads through its A-pillar upper X107 and to the integrated load paths of advanced composite safety cell X102.

FIG. 7 illustrates screen surround X122, according to an embodiment of the present invention. Screen surround X122 accommodates the windscreen (e.g., windshield) and provides the load path between A-pillar upper X107 of front crush structure X106 and the cant rails of the roof (described below). In a preferred embodiment, screen surround X122 includes blades X152 for attaching screen surround X122 to a clevis feature around the perimeter of bodysides X110. Screen surround X122 provides the upper load path between front crush structure X106 and the upper cant rail of safety cell X102. Screen surround X122 also provides transverse reinforcement for firewall upper X120 and provides a frame for the front windscreen.

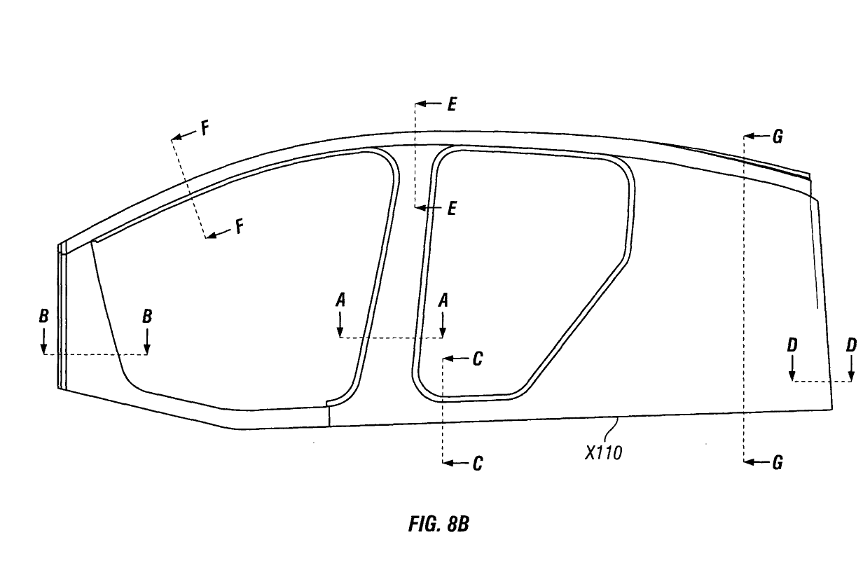

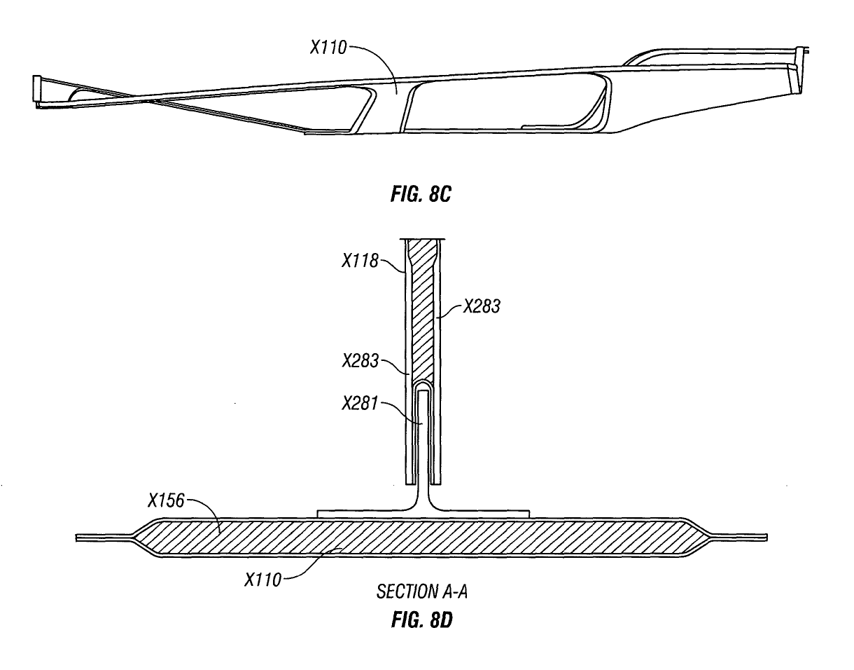

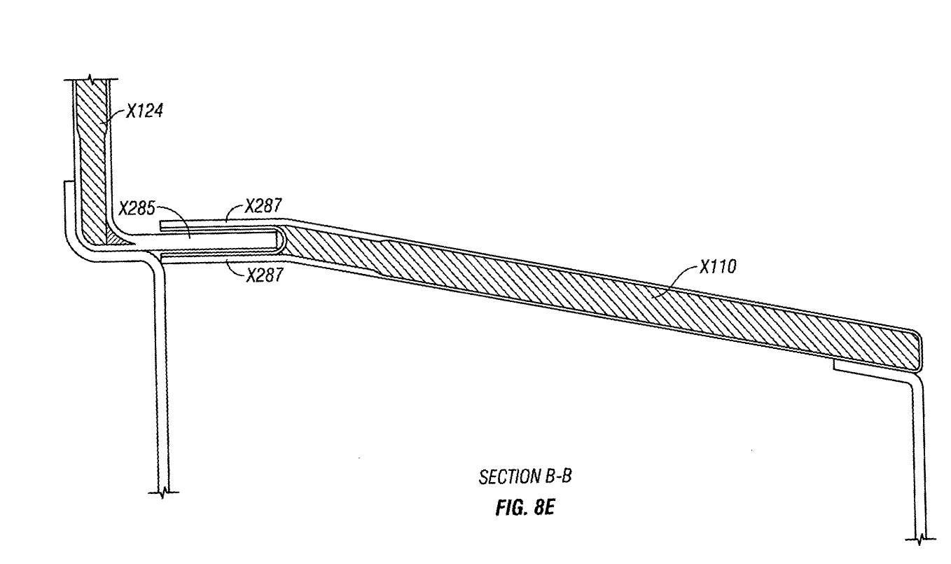

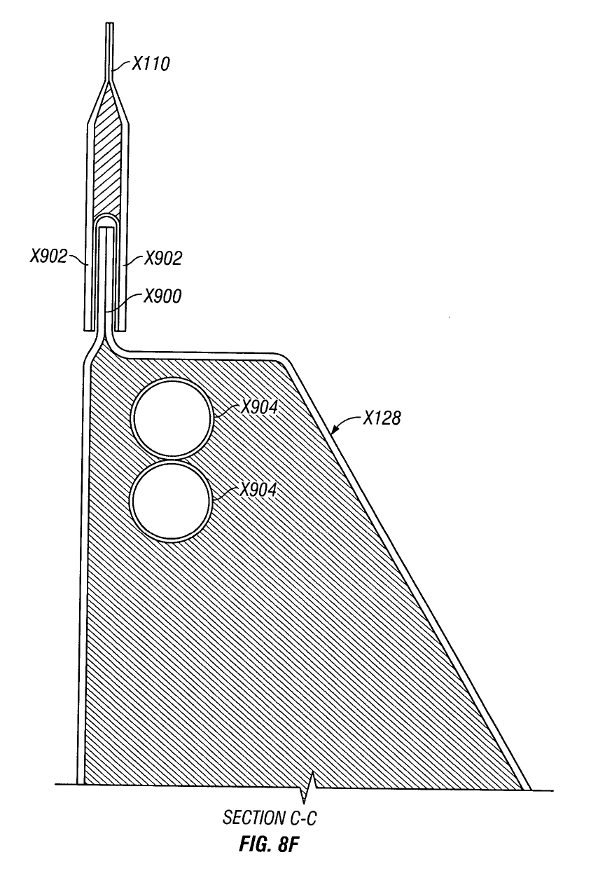

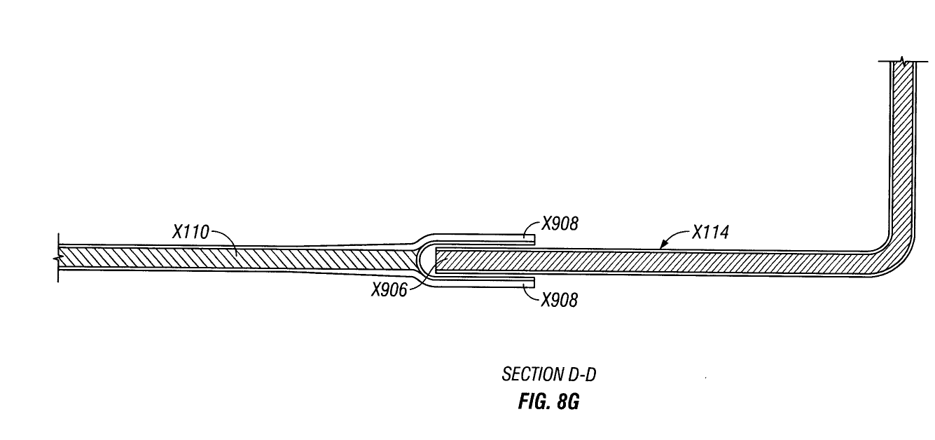

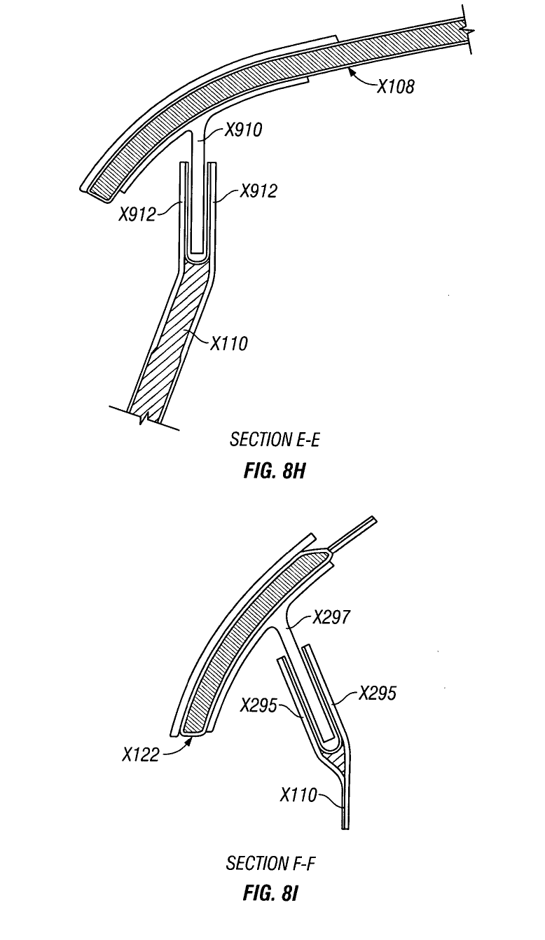

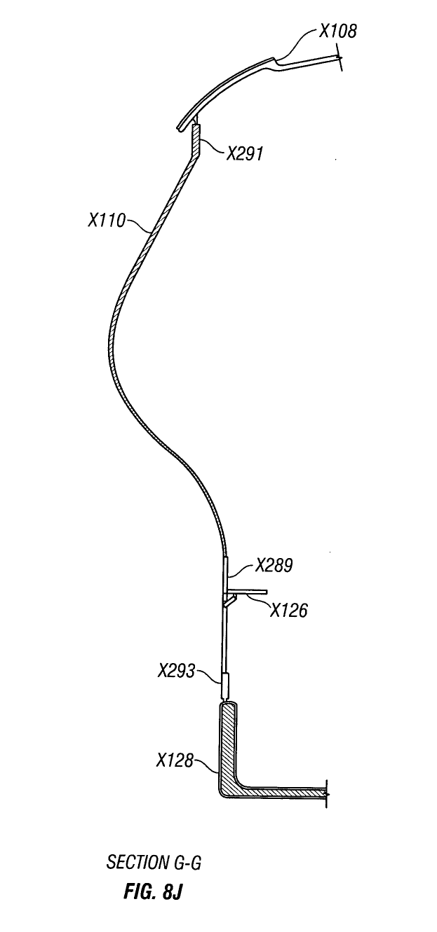

FIG. 8A illustrates a bodyside X110 according an embodiment of the present invention. Bodyside X110 is an important structural component, which integrates numerous structural and assembly features into one globally complex component, provides upper and lower crash load paths via a cant rail and sill, and contributes to torsional stiffness. Bodyside X110 incorporates two key load paths to transfer loads from subframe X106 in the lower portion of bodyside X110, and from A-pillar upper X107 via the upper portion of bodyside X110. A clevis assembly interface X154 is incorporated around the perimeter of bodyside X110 to interface with blades formed in the components that join bodyside X110. In a preferred embodiment, clevis assembly interface X154 is oriented in a vertical plane such that interfacing components can be fitted in an orthogonal fashion. A co-processed blade feature is incorporated into B-pillar X156 and C-pillar X158 of bodyside X110, which interfaces with a clevis feature of the transverse ring frames (B-frame X118 and C-frame X116). In another embodiment, bodyside X110 uses a thin foam sandwich core to enhance structural stability, while providing desirable thermal and acoustic insulation.

FIG. 8B illustrates the side view of a left bodyside X110. Sections A-A through G-G are marked and illustrated in FIGS. 8D through 8J. FIG. 8C shows a plan view of left bodyside X110, showing the shallow depth of draw of the part, which simplifies tooling and manufacturing difficulty.

FIG. 8D illustrates a detail of the joint between B-pillar X156 of bodyside X110 and B-frame X118. B-frame X115 has a clevis joint X283 into which blade X281 on the inner side of B-pillar X156 slots. Blade X281 is made part of bodyside X110 during its manufacture. The facing parts of the blade and clevis joints are bonded together using an adhesive.

FIG. 8E illustrates section B-B, showing how bodyside X110 joins with front bulkhead lower X124 using a blade and clevis joint. In this case, blade X285, which is part of front bulkhead lower X124, slots into clevis X287 in bodyside X110 and the parts are bonded together with adhesive between the blade and clevis.

FIG. 8F illustrates section C-C, showing how bodyside X110 joins with floor X128. These parts join by slotting blade X900 on the sill of floor X128 into clevis X902 on the lower edge of bodyside X110. Adhesive between blade X900 and clevis X902 bond the two parts together. This figure also shows how cooling lines for the propulsion system X904 could be integrated into the sill.

FIG. 8G illustrates section D-D, showing how the back edge of bodyside X110 joins with tailgate ringframe X114. In this case, blade X906 of tailgate ringframe X114 is a sandwich structure and slots into clevis X908 on bodyside X110 and adhesive between the blade and clevis bonds the parts together.

FIG. 8H illustrates section E-E, showing the joint between bodyside X110 and roof X108. As shown, blade X910 slots into clevis X912 on the upper edge of bodyside X110 and is adhesively bonded to attach the parts.

FIG. 8I illustrates section F-F, showing how bodyside X110 and screen surround X122 are joined using a blade and clevis joint. Blade X297, which is part of screen surround X122, slots into clevis X295, which forms the upper edge of bodyside X110. The joint is held together with adhesive.

FIG. 8J illustrates section G-G, which shows the relatively shallow profile of bodyside X110 at this section. It also shows the joint between roof X108 and bodyside X110 (at point X291) and between bodyside X110 and floor X128 (at point X293). This figure also illustrates where rear floor X126 joins with bodyside X110 (at point X289).

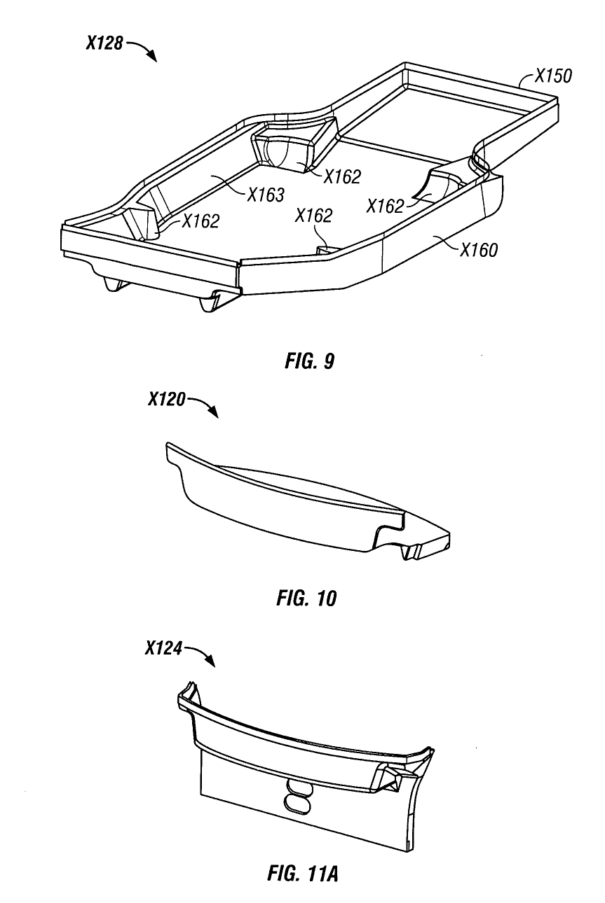

FIG. 9 illustrates floor X128 according to an embodiment of the present invention. Floor X128 serves as a critical component of safety cell X102, integrating the main front crash load paths via side sills X160 and central crush wedges X162, as well as floor mounts, rear suspension interfaces, and other assembly features. In a preferred embodiment, floor X128 includes sandwich stiffened floor sills X163 to improve lower crash load paths. Floor X128 significantly contributes to the overall torsional stiffness of safety cell X102, and provides transverse stiffness and a smooth external underbody surface. The elimination of conventional floor substructure via the use of sandwich construction contributes to excellent interior headroom with a relatively small frontal area. In a further embodiment of the present invention, air and fluid conduits are formed in floor X128.

FIG. 10 illustrates firewall upper X120 according to an embodiment of the present invention. Firewall upper X120 provides torsional stiffness and side impact protection. In particular, firewall upper X120 is a single integrated component that transfers loads transversely across safety cell X102, while providing a very stiff horizontal shear plane to reinforce safety cell X102 against severe side impacts. In addition, firewall upper X120 provides a solid structural backup for airbag and instrument panel attachments.

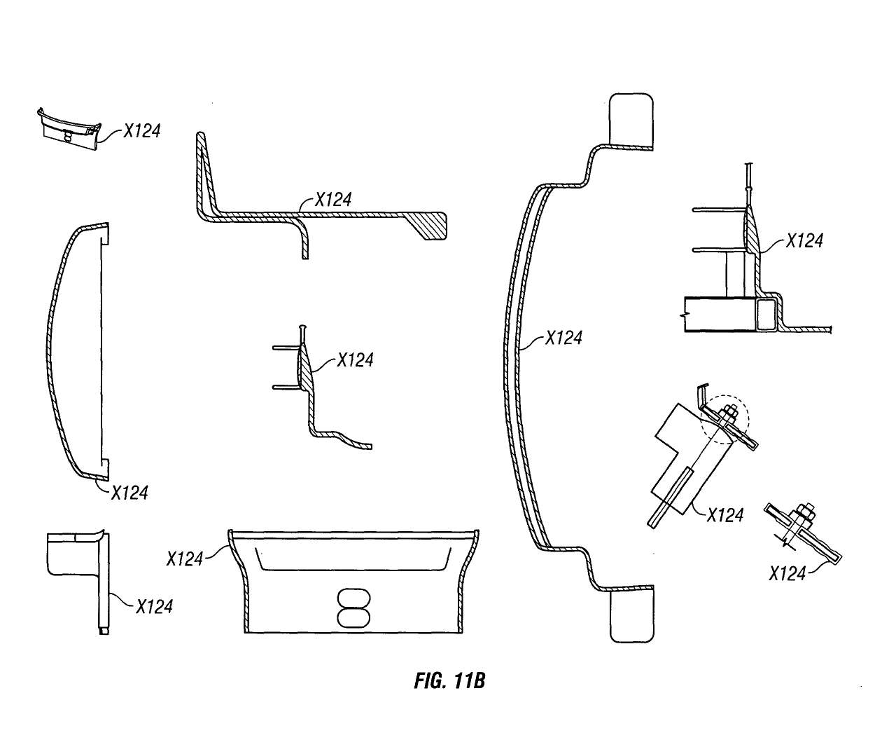

FIG. 11A illustrates firewall lower X124 according to an embodiment of the present invention. Like firewall upper X120, this single integrated component provides a very stiff vertical shear plane that resists vehicle torsional deformation. Firewall lower X124 also provides transverse stiffness to resist side impact loads. In addition, firewall lower X124 provides a stiff interface to the aluminum subframe X104.

FIG. 11B illustrates an exemplary fabrication design of firewall lower X124, according to an embodiment of the present invention. The design incorporates the joint details, fabrication details, and materials as shown in FIG. 11B.

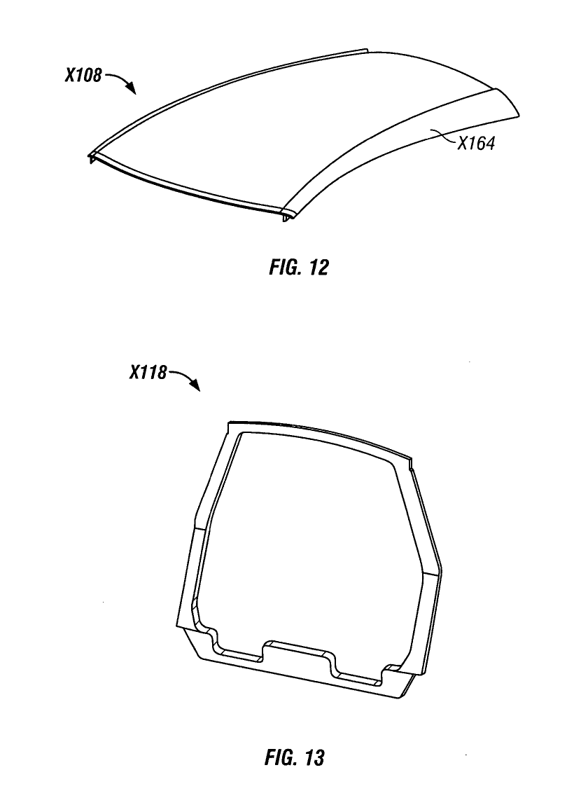

FIG. 12 illustrates roof X108 according to an embodiment of the present invention. Roof X108 provides safety cell X102 with a key horizontal shear plane and integrates an upper crash load path into cant rails X164. Cant rails X164 and screen surround X122 provide the upper crash load path. Roof X128 also includes blade assembly interfaces (not shown) that mate with transverse frames X116 and X118. In addition, roof X108 provides vehicle body structure X100 with an aerodynamic exterior surface.

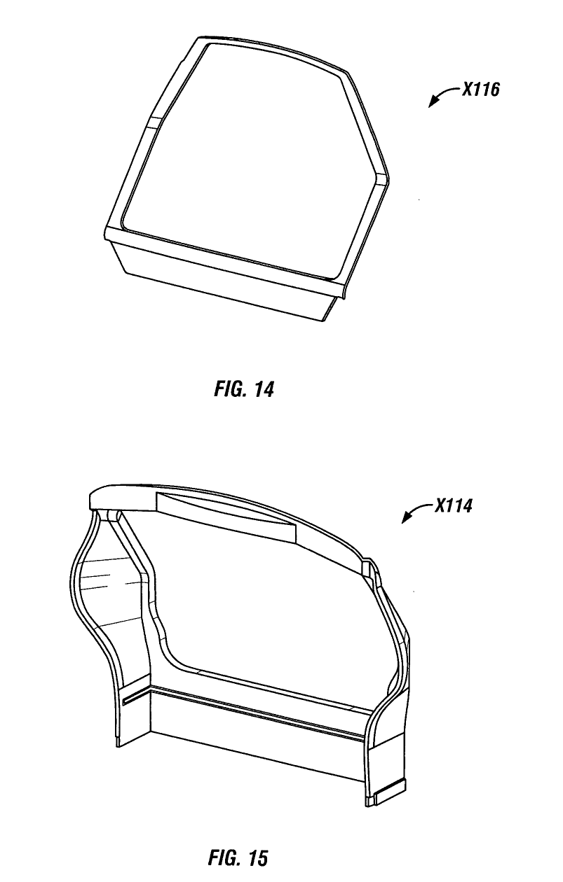

FIG. 13 illustrates B-frame X118 according to an embodiment of the present invention. B-frame X118 attaches to the B-pillars X156 of bodysides X110 and to rear floor X126 and roof X108. Preferably, B-frame X118 is bonded to bodysides X110 using a blade/clevis assembly joint. In this position, B-frame X118 provides safety cell X102 with a continuity of flexural stiffness in the corner of safety cell X102. This flexural stiffness significantly improves rollover and side impact protection and torsional rigidity, especially in comparison to conventional spot-welded, stamped steel structures, which typically suffer from a lack of flexural stiffness.

FIG. 14 illustrates C-frame X116 according to an embodiment of the present invention. C-frame X116 attaches to the C-pillars X158 of bodysides X110 and to rear floor X126 and roof X108. Like B-frame X118, C-frame X116 provides safety cell X102 with a continuity of flexural stiffness in the corner of safety cell X102, which significantly improves rollover and side impact protection.

FIG. 15 illustrates tailgate ringframe X114 according to an embodiment of the present invention. As shown, tailgate ringframe X114 integrates a number of functions such as a rear transverse frame, a rear crush structure attachment, door seal interfaces, and door hinge and actuation interfaces.

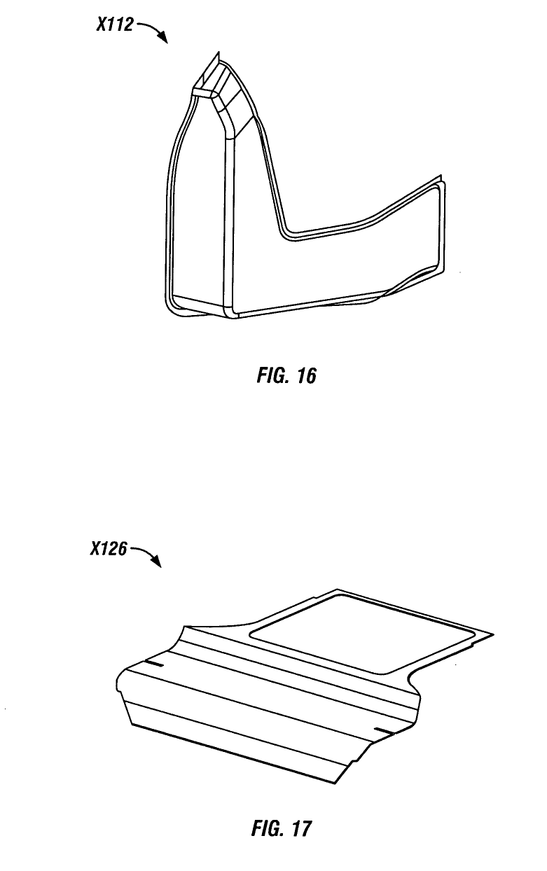

FIG. 16 illustrates a bodyside wedge X112 according to an embodiment of the present invention. Bodyside wedge X112 performs a number of functions contributing to the overall impression of quality of the vehicle and the side impact safety performance of the vehicle. In particular, wedge X112 provides a desirable hinge attach geometry that promotes a quality door slam and seal. Wedge X112 also provides a layer of crush capability to absorb side impact energy in crash situations, and further protect safety cell X102 from damage at federally mandated requirements.

FIG. 17 illustrates a rear floor X126 according to an embodiment of the present invention. Rear floor X126 accommodates a number of functions and components. For example, rear floor X126 provides a base for rear seat supports, covers the hydrogen storage tanks, provides an attachment for a rear component access cover, and provides stability for the rear crash load paths.

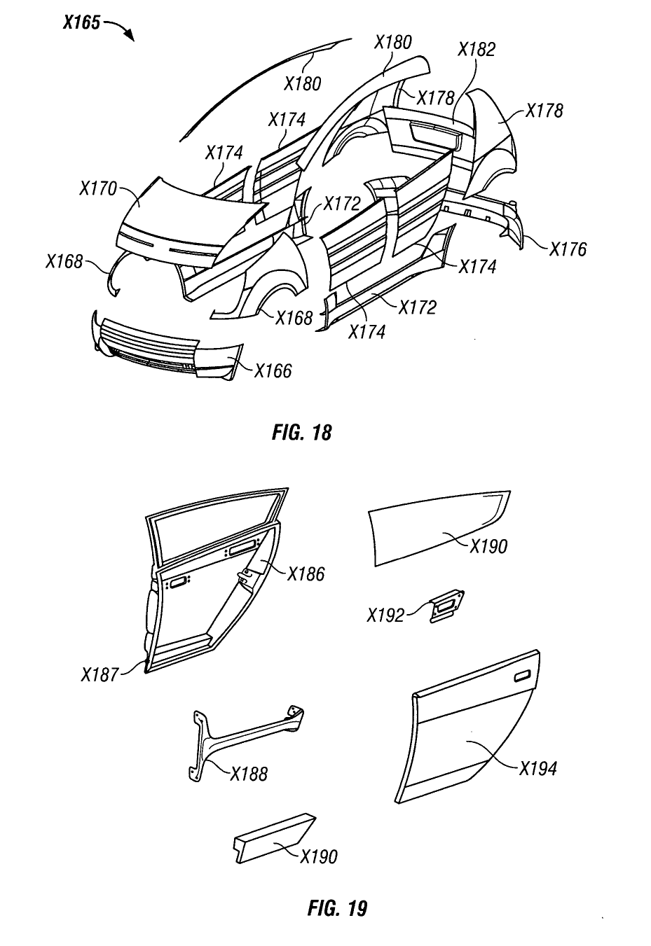

FIG. 18 illustrates an exploded view of an exemplary exterior skin X165 applied to the vehicle body structure X100 of FIG. 1, according to an embodiment of the present invention. As shown, exterior skin X165 includes a front bumper panel X166, front quarter panels X168, a hood panel X170, bottom sill panels X172, door panels X174, rear bumper panel X176, rear quarter panels X178, roof rail panels X180, and rear door panel X182. In a preferred embodiment, exterior skin X165 is non-structural and is made of an unreinforced thermoplastic material. In this manner, exterior skin X165 provides an aerodynamic surface, enables a variety of coloring and styling, provides inherent dent resistance, and affords a degree of customer tailorability by enabling replacement of individual panels or all of the panels to affect the style or theme of the vehicle. By using a core structure surrounded by a non-structural skin, the present invention separates the structure components of the vehicle from its external geometry. In doing so, the vehicle structure can be optimized for low cost, without having to conform to and perform as the external surface of the vehicle. Moreover, the non-structural external skin can be optimized for low cost, for dent resistance, and for providing color and finish without the use of conventional painting and its associated cost and environmental impacts. This approach also enables a degree of customer tailorability that can be an attractive selling feature for vehicles utilizing this structural design approach.

FIG. 19 illustrates the assembly and design of an exemplary closure X184 for vehicle body structure X100, according to an embodiment of the present invention. Although illustrated as a front left door, one of ordinary skill in the art would appreciate that the illustrated design is applicable to any closure, such as a rear passenger side door or a rear hatch. As shown in FIG. 19, closure X184 includes a door inner panel X186, an integrated side intrusion beam X188, energy absorbing foam inserts X190, a hardware cassette X192, and an exterior skin panel X194.

Door inner panel X186 serves as the main structure of closure X184, providing the necessary stiffness. In addition, door inner panel X186 serves as an interior trim surface on which padding can be added where required, for example, to meet U.S. Federal Motor Vehicle Safety Standards. Door inner panel X186 can also incorporate armrests for controls. A door pocket X187 can be formed by adding a front piece to door inner panel X186.

Integrated side intrusion beam X188 is disposed inside door inner panel X186 and provides further rigidity and protection against side impacts. Notably, beam X188 is located on the exterior side of door inner panel X186.

Energy absorbing foam inserts X190 are also disposed inside door inner panel X186, on the exterior side of panel X186. Foam inserts X190 absorb energy in side impact situations. Foam inserts X190 also provide vibration and noise reduction.

Hardware cassette X192 is disposed inside door inner panel X186, within an opening penetrating panel X186. Hardware cassette X192 can accommodate various door mechanisms, such as hinges, latches, and window mechanisms.

Exterior skin panel X194 covers inner door panel X186 and the components within panel X186. Exterior skin panel X194 is preferably self-colored, easily removable, damage tolerant, and swaged for stability.

As shown in FIG. 19, the design and assembly approach for closure X184 is the opposite of a conventional automobile. In the present invention, the structural portion of closure X184 is on the inside (inner door panel X186), and the intrusion beam X188 and non-structural skin (X194) are on the outside. This configuration enables door inner panel X186 to double as a trimmed interior surface, by allowing the untrimmed carbon composite surface to show through to the interior of the vehicle. This dual design therefore saves cost and weight. In addition, because the inner panel X186 provides the structure, the outer skin X194 can be unreinforced, allowing ease of replacement, tailoring, or access for service or repair of the door interior.

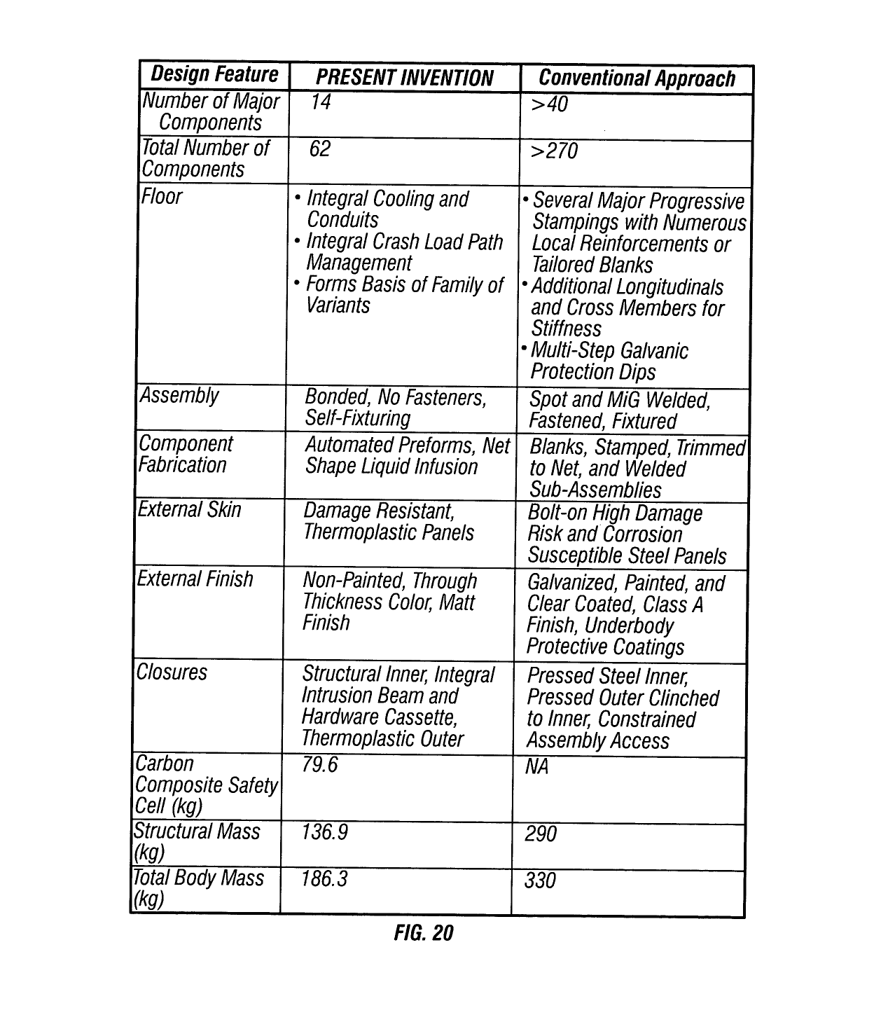

The advanced composite design of the vehicle body structure X100 described above provides several advantages over conventional steel automotive structure technology. The table of FIG. 20 describes some of these advantages. As shown, the present invention reduces weight, minimizes fabrication and assembly costs, eliminates conventional painting, and provides a safe and durable vehicle structure. As an example of weight savings, an overall vehicle structural mass can be reduced from 330 kg for a conventional automobile to 187 kg for an advanced composite vehicle structure according to the present invention, which represents a weight savings of approximately 57%.

Lightweight and Tailorable Vehicle Dynamics System with Optimizations for Lightweight and Hybrid-Electric Automobiles

An aspect of the present invention provides a lightweight and tailorable vehicle dynamics system with optimizations for lightweight and hybrid-electric automobiles. This aspect of the present invention performs in a synergistic manner with a full sized but lightweight automobile design to efficiently and cost-effectively provide consistent performance over a broad range of vehicle payload and driving conditions. The dynamics system emphasizes digital information management and control, advanced materials, and modular design that contributes directly to its value as a stand-alone system of an automobile, and its value in the context of enabling the desired performance of the entire vehicle.

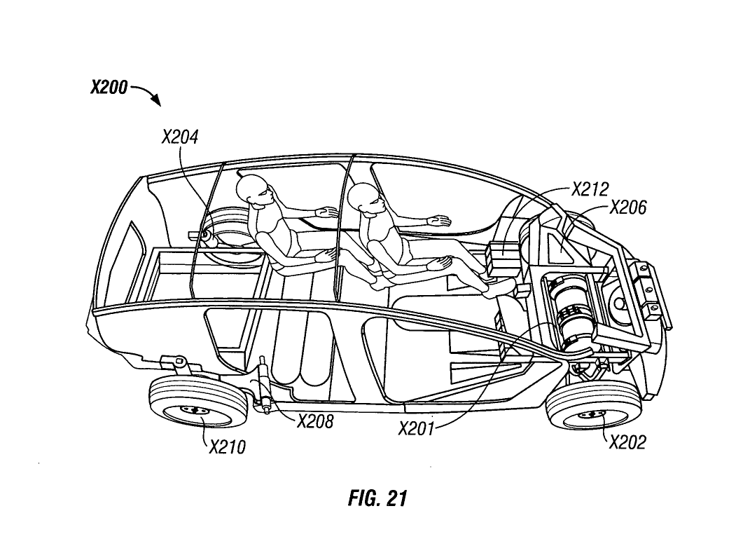

As represented in FIG. 21, the vehicle dynamics system X200 according to this aspect of the present invention includes one or more of the following elements: 1) a lightweight, affordable electrically actuated steering system X201; 2) an electrically actuated lightweight durable braking system X202; 3) an integrated electromagnetic/pneumatic suspension system X204; 4) lightweight composite suspension components X206; 5) modular rear suspension and traction motor units X208; and 6) an active tire contact patch control system X210. Each of these elements is controlled by a vehicle information management and control system with an integrated dynamics controller X212. These elements are described in more detail below under corresponding subheadings.

Based on the elements shown in FIG. 21, this aspect of the invention provides semi-active independent suspension at each corner of the vehicle, electrically-actuated carbon-based disc brakes, modular rear corner drivetrain hardware and suspension, and electrically actuated and controlled steering. The invention includes one or more of energy-efficient active ride height, attitude, roll stiffness, and damping control, active tire contact patch monitoring and control, and lightweight, high-performance braking. Components are fabricated from materials that meet the system and lifecycle requirements.

The vehicle dynamics system of the present invention provides benefits in the areas of vehicle dynamics, mass, durability, and modularity or tailorability.

In terms of vehicle dynamics, the present invention meets the challenge of achieving desirable ride, handling, and stability of a full size vehicle with very low mass. Vehicle dynamics are very sensitive to the ratio of sprung mass to unsprung mass, amount and position of the payload, and the components, and their configuration and function applied in the suspension at each corner of the vehicle. The dynamics system of the present invention deals with this challenge in a way that overcomes many historical shortcomings of lightweight vehicle design.

In terms of mass, the combination of the materials used, the design and selection of the components, innovative use of digital control, and low overall vehicle mass contribute to a significant reduction in the mass of the dynamics system of the present invention, especially in comparison to the dynamics system of a conventional and equivalently sized automobile. The design of the present invention also eliminates some minor components, while permitting the use of certain lightweight components that would not otherwise be appropriate for application outside of vehicles driven by professional drivers.

In terms of durability, based on considered material selections and the exploitation of digital electronics, the present invention provides a dynamics system that can surpass the lifetime of the dynamics system of a conventional and equivalently sized automobile.

In providing modularity/tailorability, the integrated design approach to the rear corners and the use of digital electronics throughout the system of the present invention provide a high degree of inherent modularity and tailorability, which is currently not practical in conventional equivalently sized automobiles.

With these benefits in mind, the vehicle dynamics system of this aspect of the present invention includes one or more of the following features:

The use of advanced composites in the suspension components to reduce their mass and enable beneficial structural integration without compromising affordability or durability;

The application and integration of semi-active pneumatic springs and active electromagnetic damping as suspension struts to accommodate a high curb-to-gross vehicle mass ratio, variation in the position of the payload's center of gravity, while reducing the compromises in handling vs. ride/comfort typical of conventional systems, permitting control of ride height and active damping with minimized energy consumption, and expanding capability for negotiating rough terrain;

The incorporation of semi-active pneumatic anti-roll control to permit adjustment of roll stiffness in response to changes in payload or gross vehicle mass, vehicle speed, roughness of terrain, and driver-selectable preferences;

The replacement of a conventional steering rack with a bell-crank steering linkage, dual electric steering motors, and digital by-wire control;

The integration of the rear suspension component with the structural mounting and casing for electric traction motors, transmission (constant-mesh reduction gears), knuckle, bearing, and spindle or hub;

The use of electrically actuated calipers with carbon/carbon brake pads and rotors to accommodate the unique material and braking characteristics of the carbon/carbon materials, thereby reducing mass, providing exceptional performance, and making carbon-carbon pads and rotors feasible in consumer and commercial automotive products by presenting a consistent and predictable relationship between driver input and deceleration of the vehicle;

The use of active tire pressure monitoring and control to manage contact patch quality and thus, to a large degree, the vehicle's ride, handling, and stability in a wide range of environmental conditions and varying driver competence; and

The integrated control and coordination of suspension, to collectively provide dynamic stability control in response to either destabilization by external forces (aerodynamic or road surface inputs) or in attempting to best realize driver intentions in the context of traction-limiting road surfaces or limits of vehicle capability in extreme maneuvers.

To illustrate the interaction of the system elements of FIG. 21, this specification describes below three operational scenarios of the integrated vehicle dynamics system X200: 1) adjustment of suspension, steering, and brakes for a change in payload mass and distribution; 2) absorption of a bump on the outside edge of a turn while cornering at highway speeds on an otherwise smooth surface; and 3) stability control in response to a transient cross-wind gust or extreme evasive driver input.

1) Adjustment of suspension, steering, and brakes for a change in payload mass and distribution:

As additional passengers or payload are added to the vehicle of FIG. 21, position transducers in the electromagnetic suspension arms (the dampers) X204 at each corner of the vehicle detect a change from a current setting of static vehicle ride height. In response to this sensor input, controller X212 adds air pressure to both the pneumatic springs and the pneumatic anti-roll links of the electromagnetic/pneumatic suspension system X204. The default stiffness of the electromagnetic dampers is also adjusted accordingly. This adjustment maintains consistent ride height, spring-rate natural frequency, and default stiffness for anti-roll and dampers.

These component subsystems would, at the same time, be optimized for mass distribution. If, for example, all payload were added at the right rear corner, the rear springs would be adjusted more than the front, and the right rear even more still, until the vehicle height at each of the four corners is returned to what it was when the vehicle last came to rest (e.g., allowing for one or more wheels to be on a raised or depressed feature of the terrain). Additionally, the default stiffness for the rear anti-roll link and dampers would be adjusted more than the front to maintain designed under/over-steer characteristics, regardless of any subsequent dynamic actuation of chassis systems to further enhance vehicle stability.

Controller X212 would also use the data from the suspension position transducers of electromagnetic/pneumatic system X204 to calculate the change in overall vehicle mass from its curb mass (unladen state). Based on this calculation, controller X212 would then adjust the degree of electrical steering “assist” provided by steering system X201 to give the driver consistent steering feel and effort, regardless of changes in payload. Notably, this electrical steering “assist” would only be simulated by steering system X201, since there is no physical linkage between the steering wheel or other input device and the steering actuators. Responsiveness to steering effort could also be varied according to vehicle speed, for example, to facilitate parking maneuvers or to effectively dampen driver input at higher speeds to enhance stability.

As part of this operational scenario, braking system X202, as controlled by controller X212, automatically compensates for overall vehicle mass along with brake temperature, moisture content, and other factors, simply by providing the brake caliper force required to consistently match driver inputs to a corresponding factory-specified vehicle deceleration. However, the data regarding distribution of payload mass is also used to adjust the proportioning of brake actuation, thus matching brake torque distribution to relative traction at each wheel. (This is the base distribution before activation of continuously-variable dynamic torque control at each corner to prevent wheel lock-up.)

2) Absorption of a bump on the outside edge of a turn while cornering at highway speeds on an otherwise smooth surface:

As highway speeds (e.g., greater than 50 mph) are approached, controller X212 signals electromagnetic/pneumatic suspension system X204 to slightly lower the vehicle height and gradually increase both the pneumatic stiffness of the semi-active anti-roll links and the default stiffness of the electromagnetic dampers in proportion to the averaged vehicle speed (e.g., over 15 sec). The automation of this adjustment is based on the underlying assumptions that the size of allowable bumps on high-speed roads is relatively small, and that, as vehicle speed increases, minimization of body roll becomes more desirable as part of maintaining vehicle stability. The primary anti-roll stiffness (e.g., for all but very short-duration transient inputs) will thus have been set via the relatively slow-acting semi-active pneumatic link in the anti-roll system.

As a turn is initiated, the electromagnetic dampers augment the anti-roll system by stiffening on the side of the vehicle toward the outside of the turn. The degree of change in electromagnetic damping is continuously adjusted as necessary in sub-millisecond iterations, so as to enhance rather than upset vehicle stability. When a bump, moderate or severe, is encountered, the damper at that wheel rapidly softens to allow the wheel to ride up over the bump. Because the dampers are electromagnetic, this can be accomplished in under a millisecond, which equates, at 60 mph for example, to an appropriate reaction before the bump has entered less than about 10-15% into the tire contact patch. If the bump (or dip) is of a significant height (or depth), and the same input is not also measured and similarly dealt with at the opposite wheel, thus signifying a one-wheel bump, then the damper at the opposite corner simultaneously stiffens to counter the transfer of the bump input across the vehicle through the anti-roll link. While the coupling of the anti-roll link will, at speed, raise the effective spring rate at the corner where the one-wheel bump is introduced, the bump input will have been isolated at that corner for the purpose of ride comfort without the typical compromise of anti-roll stiffness and thus vehicle stability.

3) Stability control in response to a transient cross-wind gust or extreme evasive driver inputs (e.g., steering and/or braking or accelerating):

Aerodynamic input sufficient to upset vehicle stability initially results in body roll and/or a change in trajectory. Suspension position transducers in electromagnetic/pneumatic suspension system X204 detect body roll. Yaw sensors in suspension system X204 detect change in trajectory. In response to this sensor data, controller X212 modifies distribution of suspension damping and drivetrain torque to stabilize the vehicle. If needed, in extreme cases, regenerative and/or friction braking torque would also be selectively applied or redistributed (e.g., if the driver had already initiated a braking event). Stiffening the appropriate electromagnetic suspension dampers, on a sub-millisecond basis, counters the transient body roll torque. Changes in distribution of wheel torque inputs counter increases in tire slip angle.

In the case of an extreme evasive maneuver that might otherwise destabilize the vehicle by exceeding the limits of traction, suspension dampers, brakes, and drive system, controller X212 coordinates the torque at each corner of the vehicle to best realize driver intent (e.g., as determined by steering and braking or acceleration inputs). As discussed above for aerodynamic inputs, rapid damper adjustments enhance body roll control and rapid adjustment (including reduction or addition) of drive system torque at each wheel offsets changes in tire slip angle. If the vehicle trajectory continues to diverge from the intended course given by driver input, selective application of friction brakes can be used as an additional corrective measure.

Because the system is fully networked, dynamics controller X212 has access to brake torque and wheel speed data along with rate of deceleration, suspension position, steering angle, and yaw angle. Based on this data, controller X212 can provide the closest possible match to driver intent without allowing the vehicle to enter an uncontrollable skid, slide, or spin. Because the brake calipers are electrically actuated, just as the suspension dampers (and drivesystem, when applying this innovation in a hybrid-electric or similar vehicle) are, the braking caliper force can be continuously and independently varied at each corner of the vehicle in a fraction of a millisecond. These adjustments would be in response to driver input, actual brake torque (detected by a strain gauge in the caliper mount), wheel speed (detected by a hall-effect sensor), vehicle deceleration (data from air-bag system g sensor), and commands from the vehicle dynamics controller. Given the semi-active optimization of ride height, spring rate, and anti-roll stiffness for vehicle payload mass and distribution and speed, the performance potential of carbon-based brakes, and the continuously variable and exceptionally rapid response of electromagnetic dampers and brake calipers, this networked chassis system X200 can provide stability control superior to conventional systems.

System Element: Lightweight, Affordable Electrically Actuated Steering System for Automobiles:

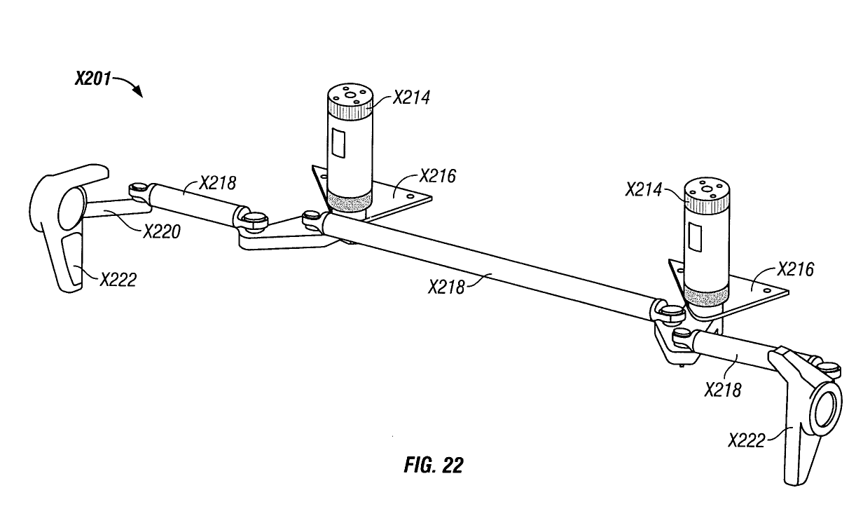

According to an embodiment of the present invention, electrically actuated steering system X201 of vehicle dynamics system X200 (see FIG. 21) consists of electrically actuated steering with no mechanical link between the driver and steered wheels. As shown in FIG. 22, dual electric motors X214 apply steering force to the wheels through a set of low cost and lightweight bell cranks X216 and tubular composite mechanical links X218. Electric motors X214 attach to spindles (not shown) attached to bell cranks X216. The outside tubular links X218 connect to steering knuckle levers X220 on the steering knuckles X222. Steering knuckles X222 attach to the front wheels (not shown).

Electric motors X214 are controlled by controller X212 (see FIG. 21). Controller X212 is linked to a steering input device used by the driver. This steering input device can be any device such as a steering wheel, side stick, or yoke. Sensors in the steering input device interpret the driver's intentions. Controller X212 assesses the signals from the sensors and optimizes the vehicle dynamics accordingly (e.g., also taking into account the current status of vehicle speed, braking, lateral acceleration, tire contact patch, roughness of terrain, and environmental conditions). Controller X212 then sends commands to the two electric motors X212 attached to a spindle (not shown) that activates the bell cranks X216 in the steering linkage. Links X218 and X220 in turn actuate the front knuckles X222 to physically steer the front wheels (not shown). The steering movement is fed back into controller X212, along with the other various data sources, to complete the loop.

Electrically actuated steering system X201 replaces a conventional steering rack of various configurations and enables both fault tolerance and full digital integration with vehicles dynamic controller X212 through actuation by dual electric motors X214. Important aspects of this embodiment of the present invention include the use of two electric motors, digital control of those motors, the configuration of the steering linkage, the design of the components comprising that linkage, and the steering performance attributes they provide.

The exemplary steering system X201 of FIG. 22 enables continuously adjustable, high-performance steering dynamics and maintenance of Ackerman angle over a range of vehicle ride heights, in a modular, energy-efficient, and relatively low cost package. The system also enables alternatives to the conventional steering wheel.

In an embodiment of this aspect of the present invention, electrically actuated steering system X201 uses simple, constant cross-section advanced composite tubes as linkages X218, which reduce weight at an affordable cost. Steering system X201 also incorporates leveraging bell cranks X216 to simplify the system. The use of two motors X214 provides the necessary maximum power for the worst-case driving load cases, while providing backup power (redundant power) under normal driving conditions. The electric motors also provide high-resolution control of the steering system, which can be tailored by the driver and modified in real-time by controller X212 to best meet driving conditions.

The electric by-wire steering of this aspect of the present invention has a number of benefits over a conventional system. The deletion of a conventional steering column removes weight and cost and is also a safety improvement as the steering column does not intrude into the passenger cabin. Not having a steering column and rack also frees up packaging space in the front end of the vehicle, enabling other technologies and efficiencies to be exploited.

The linkage design of FIG. 22 also overcomes the problems of producing sufficient Ackerman in a steering system, which is crucial to overall vehicle efficiency and to minimize abnormal tire wear. In particular, links X218 are designed to minimize loads on adjacent bearings and joints, which means that lighter and cheaper joints can be used. In addition, links X218 are designed to minimize frictional energy due to non-optimal transfer angles. Because the steering is a pure by-wire technology, this feature could be integrated into the vehicle's central information management and control system X212 so that steering input, speed, and feel could all be adjusted according to the dynamic and environmental conditions that prevail, as well as to the driver's preferences.

Another advantage of the steering system of FIG. 22 is the ease with which it can be adapted for both left hand and right hand drive versions of a vehicle.

System Element: Electrically Actuated, Lightweight, And Durable Braking System For Automobiles:

Referring again to FIG. 21, in this aspect of the present invention, braking system X202 electronically integrates the control and function of independent brake sub-assemblies at each corner of the vehicle with that of the overall vehicle information management and control system X212. According to an embodiment of the present invention, braking system X202 includes control software and operating algorithms, performance monitoring sensors, carbon/carbon brake pads and rotors, and electrically actuated calipers.

While carbon/carbon brakes, made from a composite material comprising carbon fiber reinforcement within a carbon matrix, can perform better than conventional brakes, even at reduced mass, they typically are unsuitable for general automotive applications because of their inherent non-linear friction behavior that changes significantly with changes in temperature and humidity. To overcome this limitation, braking system X202 incorporates electrically actuated calipers that are not physically connected to the driver's brake pedal. This electrically actuated carbon/carbon braking system X202 reduces mass, provides long disc and pad life—possibly lasting as long as the vehicle itself, reduces brake fade, improves consistency of performance relative to driver input, and improves anti-lock capability.

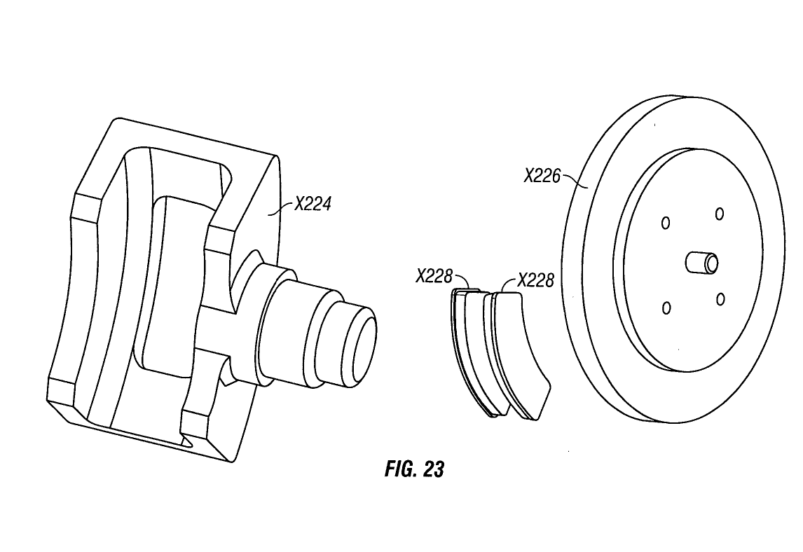

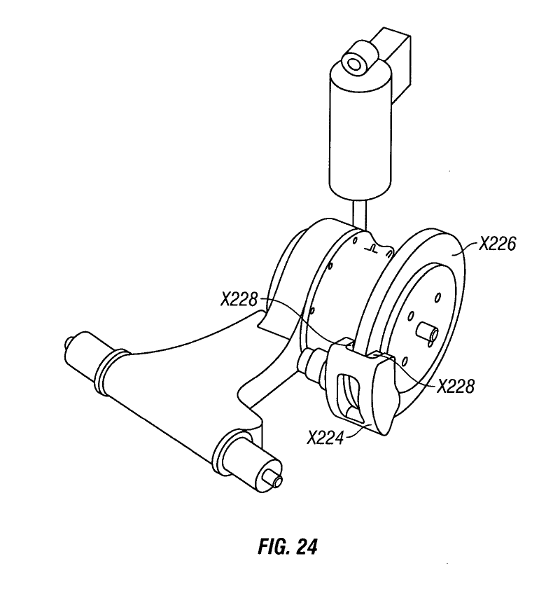

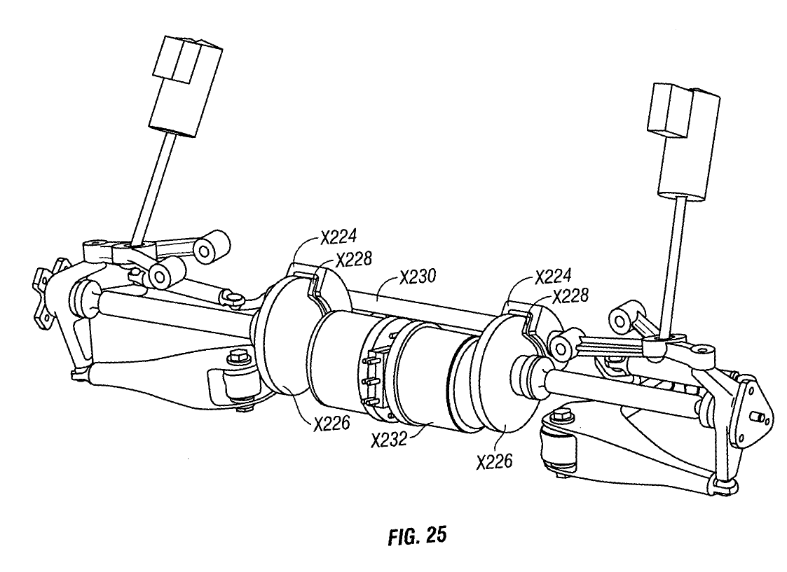

FIG. 23 illustrates an electrically actuated caliper X224 and carbon/carbon rotor X226 and pads X228, according to an embodiment of the present invention. FIG. 24 illustrates an exemplary rear left brake sub-assembly, including electrically actuated caliper X224 and carbon/carbon rotor X226 and pads X228, mounted outboard in relation to the rear suspension corner. FIG. 25 shows an exemplary front brake assembly, including electrically actuated calipers X224 and carbon/carbon rotors X226 and pads X228, and mounted inboard in relation to the front suspension corners. In the example of FIG. 25, electrically actuated calipers X224 are mounted to the housing X230 of the traction motor X232, which saves mass and cost in comparison to providing separate mounting points for calipers X224.

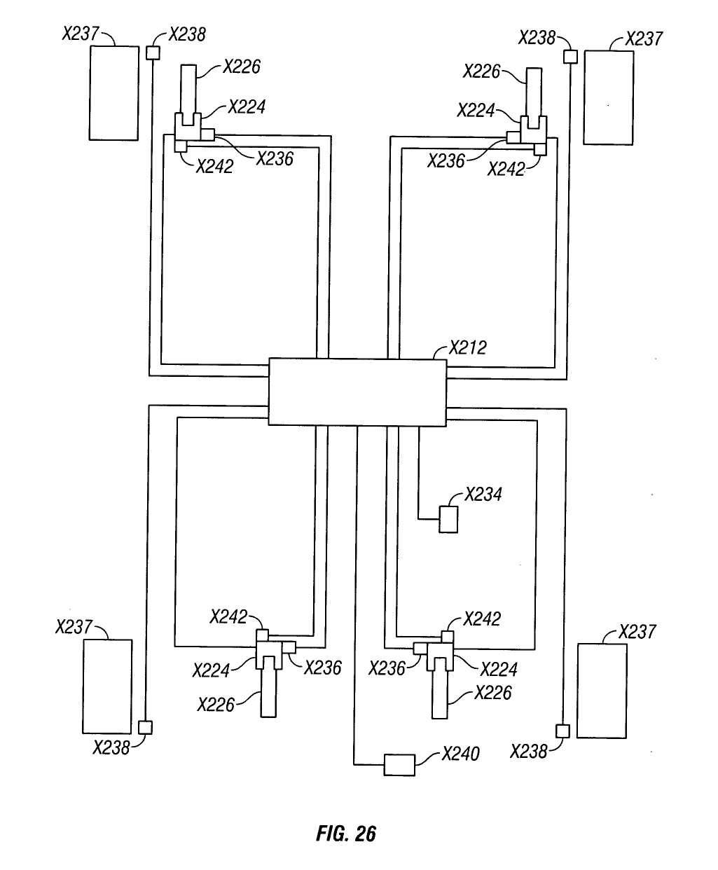

As shown in FIG. 26, in an embodiment of this aspect of the present invention, braking system X202 includes a pressure sensitive input device X234 (e.g., a pressure transducer on a brake pedal), brake torque sensors X236 at each wheel X237 (e.g., strain gauges on the caliper mounts), wheel speed sensors X238 (e.g., typical hall-effect devices), a vehicle deceleration sensor X240 (e.g., could access data from g sensor for airbag system), brake rotor and pad temperature sensors X242 (e.g., thermocouples), electrically actuated calipers X224, carbon-carbon pads and rotors X226 (e.g., discs), and a central controller X212. Preferably, there is no hydraulic link between the driver input and the brake hardware. Also, preferably, the system is entirely electric including monitoring, application, and control.

The use of lightweight, high-performance carbon-carbon brake pads and rotors is made possible by physically de-coupling the driver's brake input from the brake caliper actuation. Driver input is instead translated, via a pressure transducer and controller, into a request for a given rate of vehicle deceleration to be achieved by the caliper/pad pressure appropriate for the temperature and moisture content of the brake friction materials. The braking system is tasked with achieving the desired rate of deceleration with an optimal distribution of brake caliper forces and associated braking torque at each wheel. The electrically actuated caliper therefore accommodates the unique properties of carbon/carbon brake pads, which can change dramatically under different moisture content and temperature conditions.

Based on sensor data for vehicle mass, including current payload and mass distribution, vehicle speed, environmental conditions, and pad and rotor temperatures, controller X212 determines an initial braking force at each wheel to achieve the desired deceleration from the driver input. Individual wheel speed sensors X238 and brake torque sensors X236 then provide immediate feedback as to relative effect at each wheel. Controller X212 then re-optimizes the caliper forces at each wheel based on this feedback and in combination with an overall vehicle deceleration force measurement. This process repeats in sub-millisecond iterations to provide the closest feasible match of actual vehicle deceleration to the driver's request, compensating for conditions such as brake friction material status, road surface condition, and limits of tire traction.

In an important aspect of the integrated vehicle dynamics system of the present invention, braking system X202 receives commands from dynamics controller X212, which has access not only to brake torque, wheel speed, and rate of deceleration, but also suspension position and steering and yaw angles. Controller X212 can therefore apply the brakes at each corner of the vehicle as needed to contribute to overall vehicle stability control, even when the driver is not providing a brake system input. Controller X212 provides the closest possible match to driver intent without allowing the vehicle to enter an uncontrollable skid, slide, or spin.

In comparison to conventional braking systems, electrically actuated calipers X224 eliminate the need for the typical conventional hydraulic system including, for example, brake lines, seals, brake booster, master cylinder, proportioning valves, and a complex anti-lock fluid pressure modulation system. Thus, the present invention provides a significant weight savings, a reduction in system complexity, many performance improvements, and attractive life cycle, maintenance, and environmental benefits.

In addition, by using lightweight carbon/carbon materials in the rotor and pads, the unsprung mass of the wheel assembly can be reduced, which improves ride, handling, and stability.

The pressure applied by electrically actuated calipers X224 is continuously variable and can be controlled very precisely, very rapidly, and independently at each wheel, thus enabling improved anti-lock, traction-control, and stability-control functionality. Furthermore, NVH (noise, vibration, and harshness) is also improved by the provision of completely silent and vibration-free anti-lock braking without the need for conventional fluid pressure modulation pump and valves.

Electrical actuation of the brakes permits the use of high-performance, low-mass carbon/carbon materials in the rotor and pads of the brake system, which heretofore would have been impractical for non-race applications due to the non-linear friction-temperature/moisture characteristics of these materials. Thus, electrically actuated calipers make it possible to use carbon-carbon brake rotors (discs) and pads for general automotive purposes (i.e., other than racing), and thereby provide reduced mass, improved peak performance, improved consistency of performance, and extended durability.

System Element: Integrated Electromagnetic/Pneumatic Suspension System for Automobiles:

Referring again to FIG. 21, in this aspect of the present invention, the electrically and physically integrated electromagnetic/pneumatic suspension system X204 combines an adjustable air spring for variable ride height and spring rates, a continuously tunable pneumatic transverse link to limit body roll, and an actively controlled electromagnetic damping mechanism. Suspension system X204 uses an electromagnetic linear ram with integrated pneumatic spring, such as is produced by Guilden Ltd. (U.K.) and Advanced Motion Technologies (U.S.A.) (hereafter referred to as “AMT”). This aspect of the present invention provides overall control of vehicle ride height, attitude, and stability, with the addition of energy-efficient, semi-active body roll control.

This aspect of the present invention applies linear ram technology, such as AMT's technology, to lightweight vehicles to overcome the challenge of providing consistent driving dynamics over a wide range of vehicle gross mass and driving conditions with a minimum of energy consumption, cost, and complexity. The integrated control system continuously adapts ride height and spring, damping, and anti-roll characteristics to payload, driver inputs and preferences, and road conditions. Furthermore, this aspect of the present invention permits semi-active variable anti-roll characteristics with minimal energy consumption, and without the over-sizing of the linear rams that would result from attempting to counter all body-roll forces via the ram's electromagnetic damping.

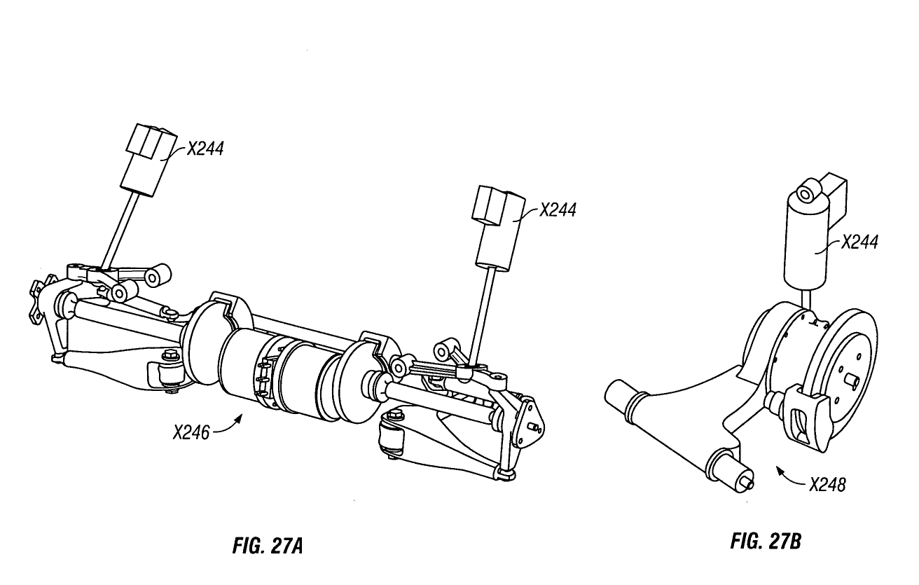

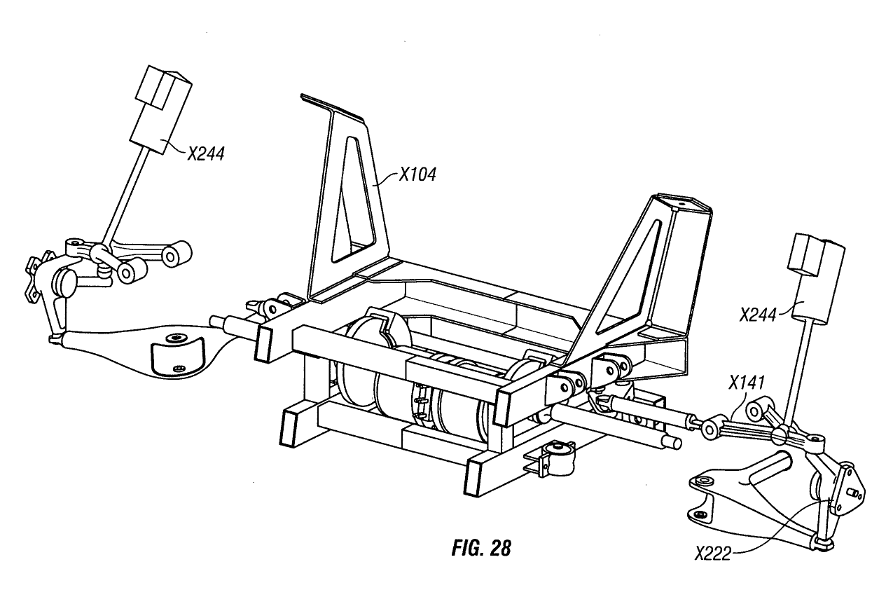

In an embodiment of the present invention, FIGS. 27A and 27B illustrate electromagnetic/pneumatic struts X244 as applied to both a front (left) suspension assembly X246 and a rear (right) suspension assembly X248, respectively. To provide further context, FIG. 28 shows struts X244 in relation to other suspension components and subframe X104. Subframe X104 is preferably a single welded aluminum component that performs several functions, including reacting the loads from the many suspension and powertrain components, reacting and distributing crash loads, and reacting traction loads.

According to an embodiment of this aspect of the present invention, integrated automotive suspension system X204 includes a set of four pneumatic/electromagnetic linear-ram suspension struts, a pneumatically variable transverse link at each axle, and a digital control system with links to other vehicle sub-systems. The invention includes control parameters, component specifications, and configurations to provide—with minimal energy consumption and in some cases net energy gains—the simultaneous semi-active optimization of suspension in response to driver preferences and transient inputs, payload mass and distribution, road surface, and aerodynamic forces.

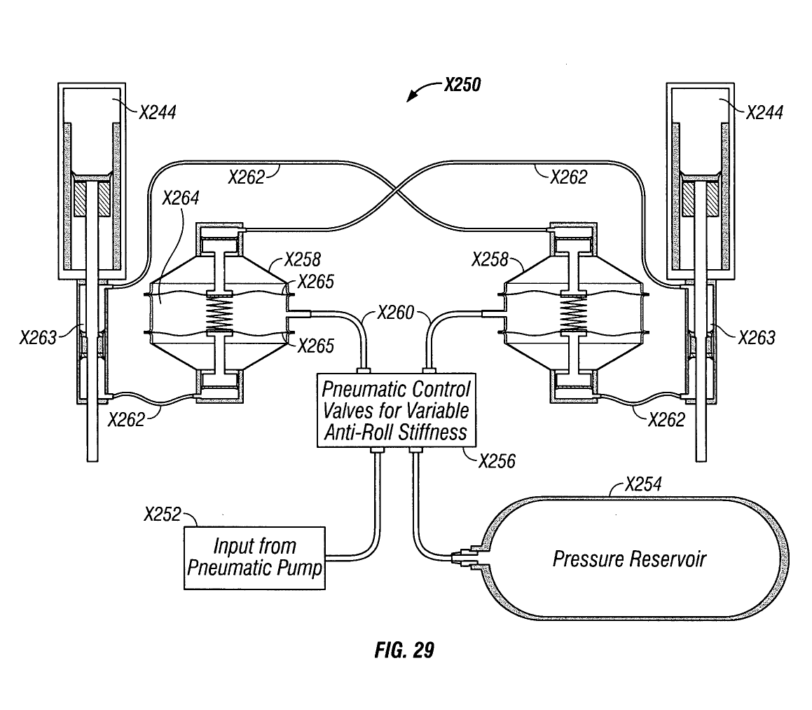

FIG. 29 illustrates an exemplary pneumatic/hydraulic system X250 of suspension system X204. As shown, system X250 includes a pneumatic pump X252, a pressure reservoir X254, pneumatic control valves X256, hydraulic anti-roll struts X263, and electromagnetic/pneumatic struts X244. For simplicity, only two of the preferable four struts X244 are shown (representing the suspension system for one of two axles on a four-wheeled vehicle). Pneumatic lines X260 and hydraulic links X262 connect the components as shown in FIG. 29. Pneumatic elements X258 act as continuously variable pneumatic anti-roll links, which are connected through hydraulic links X262 to electromagnetic/pneumatic struts X244, thus achieving a controllable and continuously variable link between the mechanical motion in the suspension struts on opposite sides of the vehicle.

The linear rams of electromagnetic/pneumatic struts X244 include a variable air spring and variable electromagnetic damper. The pressure in the air spring can be increased or decreased to change the static strut length under load and to adjust the spring rate. The electromagnetic resistance load in the damper can be varied in under one millisecond, or up to 1,000 times per vertical cycle of the strut piston. In this manner, the overall suspension system X204 can take advantage of the widely and, in the case of damping, rapidly variable, characteristics of the linear ram components.

The mechanical motion of struts X244 is linked transversely (across the vehicle) to counter body roll. The link itself is isolated, so that a failure that might compromise anti-roll stiffness does not affect the pneumatic springs. And, because it operates independently of electromagnetic/pneumatic struts X244, the pneumatic/hydraulic transverse link (including X252, X254, X256, and X263) can be implemented with a wide variety of active, semi-active, and passive suspension spring and damper options and configurations. Hydraulic elements X263 are connected to the variable pneumatic element X258 at the center of the transverse link X262 to the left and right struts. Alternatively, this can be done pneumatically. The stiffness of the transverse link X262 is then adjusted by varying the pressure in the isolated pneumatic segment X264, either by adding pressure from a pre-pressurized reservoir X254 or by venting excess pressure. Diaphragms X265 with relatively large surface area reduce the pressure required in the variable pneumatic portion of the roll-control link. As an example, working pressure is on the order of 60-120 psi. Thus, minimal energy inputs are required for tuning the anti-roll characteristics with changes in driver preferences, payload, quasi-average vehicle speed, and road surface conditions. The peak power associated with the frequent tuning of this system is further reduced by the use of reservoir X254, and therefore a smaller pump X252. Control of fast transients in body roll and pitch is then augmented by rapidly varying the damping rate—or degree of powered actuation—of each individual electromagnetic strut during acceleration, braking, cornering, and aerodynamic inputs. The semi-active transverse link and the electromagnetic struts together comprise an energy-efficient fully active suspension.

This solution for semi-active variable control of body roll permits downsizing the electromagnetic struts X244 to meet only the requirements of damping fast-transient bump, pitch, and roll inputs, thus augmenting the tunable pneumatic anti-roll system just as they augment the pneumatic springs. As a result, energy consumption associated with the continuously-variable control of body roll can be well below what would be required if all roll control were accomplished via electromagnetic rams alone and/or with rapid and frequent adjustment of the pneumatic springs.

According to an embodiment of the present invention, vehicle ride height is adjusted via the air springs either in direct relation to driver selection of settings (e.g., for rough terrain or deep snow) or automatically to compensate for changes in payload mass and/or distribution and for changes in average vehicle speed (e.g., automatically defaulting to normal height over a preset rough-terrain maximum speed of 35 mph, and then lowering further at highway speeds of 55 mph or higher). Changes in ride height can be executed over a period on the order of 5-15 seconds (depending on the magnitude of change) to avoid disrupting passengers and to minimize energy consumption and pump or reservoir capacities. Spring rates are thus also adjusted with changes in load on the vehicle as a whole and on each of the four suspension struts individually.

Both the stiffness of the transverse anti-roll links and the default electromagnetic resistance load on the dampers is adjusted in keeping with payload mass and distribution plus driver preferences (e.g., for emphasis on extra nimble handling or ride comfort). These anti-roll and damping characteristics are then continuously varied—still as a semi-active function—in accordance with driver acceleration, braking, and steering inputs (e.g., cross-wind wind gusts or bumps and dips in the road surface). Finally, active control of and power input to the linear rams can, just as rapidly, apply active forces—as distinguished from the reactive forces of damping—to further counter dynamic inputs.

All key suspension variables can be controlled via a stability-control algorithm in the vehicle's central information management and control system X212, which optimizes the behavior of each strut according to real-time dynamic conditions and driver inputs. Controller X212 draws upon input from driver preference settings; acceleration, braking, and steering inputs; vehicle speed, mass, and payload-distribution data; and feedback from sensors detecting the real-time dynamics of the vehicle, road surface conditions, and aerodynamic forces (such as cross winds) as a function of wheel speeds, yaw rates, slip angles, and suspension travel.

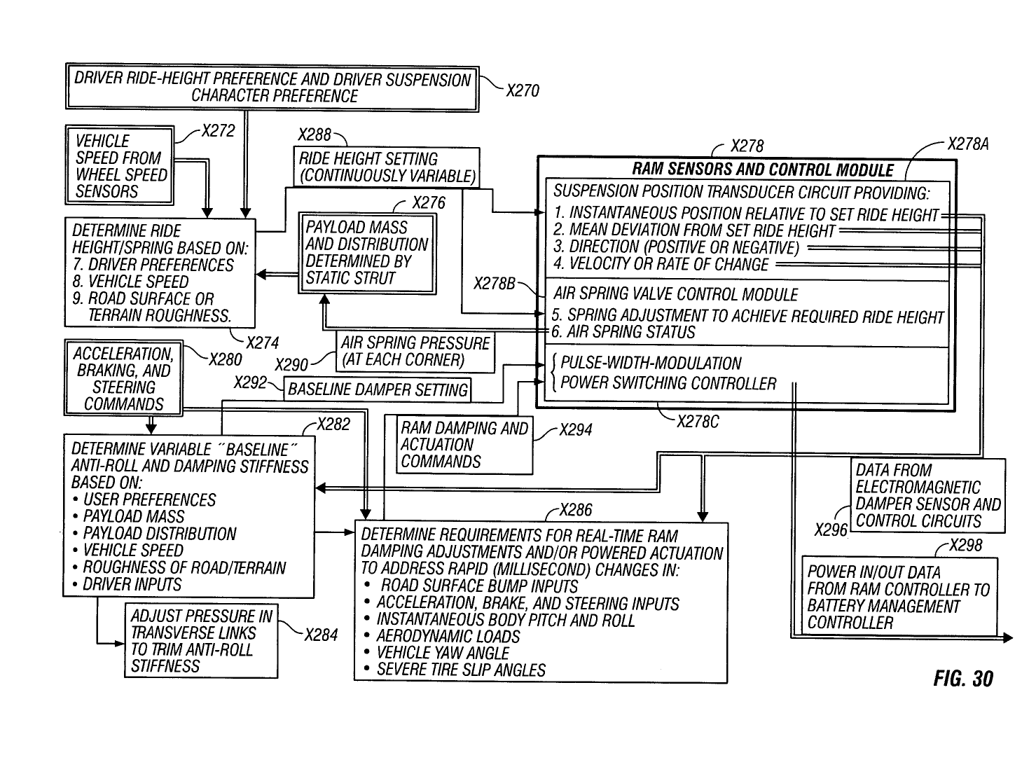

FIG. 30 illustrates an exemplary control flowchart for the operation and control of the suspension system, according to an embodiment of the present invention. In this example, the suspension system includes variable pneumatic springs and anti-roll systems with electromagnetic damper/actuators. In FIG. 30, the single-line arrows represent commands sent to various system controllers. The double-line arrows represent information flows between controllers. The double-line boxes represent decisions made by various system controllers related to the suspension.

As shown, the ram sensors and control module X278 contains three main systems: a suspension position transducer circuit X278A, an air spring valve control module X278B, and a pulse-width-modulation power switching controller X278C. In a preferred embodiment, module X278 is an AMT ServoRam™ sensor and control module.

Suspension position transducer circuit X278A receives continuously variable ride height settings X288 and provides information about the operation and status of each suspension corner, such as instantaneous position relative to the baseline ride height setting, mean deviation from the ride height setting, direction of travel, and the velocity of each ram.

Air spring valve control module X278B receives continuously-variable ride height settings X288 and, in response, adjusts air pressure in each spring as determined by vehicle dynamics controller X212 and reports the pressure at each corner X290.

Pulse-width-modulation power switching controller X278C receives baseline damper settings X292 and transient commands X294 (e.g., damping and actuation) and reports information on power consumption and power generation. Controller X278C contains power switches, a three-phase rectifier, and diode-based isolation to perform high- and low-velocity damping with the ram. High velocity damping generates electricity, which is then stored in the LLD batteries 100 and 101. Low velocity damping consumes energy from the LLD 100 and 101. Information regarding how much power is consumed and generated is sent to the battery management controller X298. Controller X278C receives both baseline damper settings X292 and transient commands X294 that together determine its behavior in real time.

The data generated by sensors and control module X278 is fed back X296 to the vehicle dynamics controller X212 to determine real-time adjustments to the suspension behavior X286 and to determine the variable “baseline” anti-roll and damping stiffness X282. The real-time (e.g., millisecond timeframe) damping adjustments X286 are determined by, for example, road surface bump inputs; acceleration, brake, and steering inputs; instantaneous body pitch and roll; aerodynamic loads; vehicle yaw angle; severe tire slip angles; and from the baseline damping and stiffness X282.

Baseline anti-roll and damping stiffness X282 is determined by, for example, user preference settings, payload mass, mass distribution in the vehicle, speed, roughness of the road surface, and driver acceleration, braking, and steering inputs X280. The pressure in the transverse links is set X284 in order to adjust anti-roll stiffness to the desired level.

The ride height setting X274 that is fed to circuit X278A and module X278B is determined as a function of vehicle speed X272, driver ride-height preference settings (e.g., rough terrain vs. normal) and suspension character preferences (e.g., sport, standard, luxury) X270, payload mass and mass distribution X276, and air spring pressure at each corner X290.

The air spring of this aspect of the present invention enables optimization of spring rate, maintenance and adjustment of vehicle ride height with changes in driving conditions or driver preferences, and adjustment of vehicle attitude regardless of the payload or its location in the vehicle. Likewise, the electromagnetically variable damping and pneumatically adjustable anti-roll link can be tuned for changes in gross vehicle weight, speed, traction conditions, roughness of terrain, and driver preference. Damping, spring rate, and anti-roll stiffness together can be controlled by the vehicle's central information management and control system X212, thereby allowing high resolution and fast optimization of suspension characteristics under different dynamic conditions.

In addition to the improvements in overall vehicle characteristics, this invention significantly reduces the suspension system's contribution to total vehicle weight and improves vehicle tailorability and upgradability. Such parameters are crucial to success in the increasingly competitive sales environment in terms of initial sales, resale, and life cycle cost reduction.

System Element: Innovative Design and Production Approach for Lightweight Composite Automotive Suspension Components:

This aspect of the present invention provides a design and production approach for advanced composite suspension components that incorporates specific design and processing features, which contribute directly to improved vehicle performance and affordable component production. FIG. 21 illustrates suspension components X206 according to this aspect of the present invention. In this example, suspension components X206 are lightweight composite lower suspension arms (or “A-arms”) mounted at each corner of the front suspension assembly.

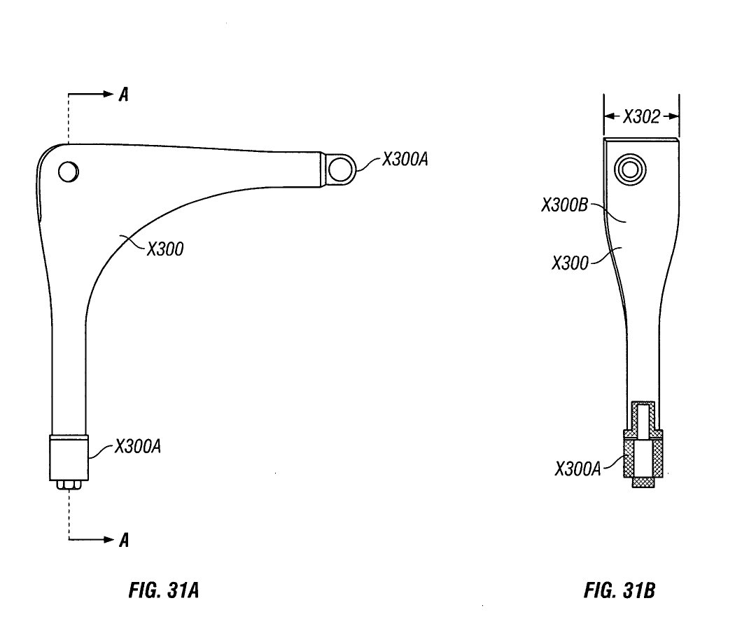

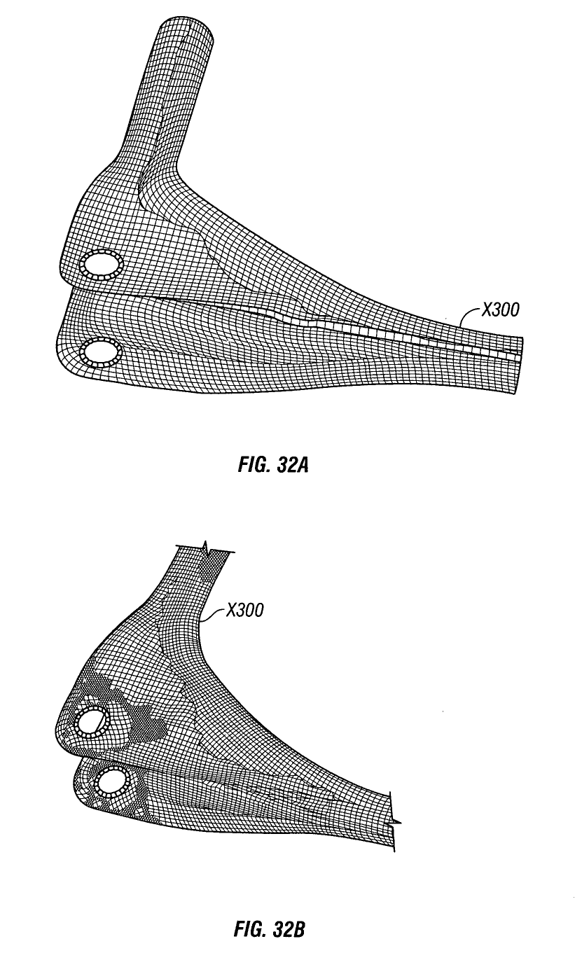

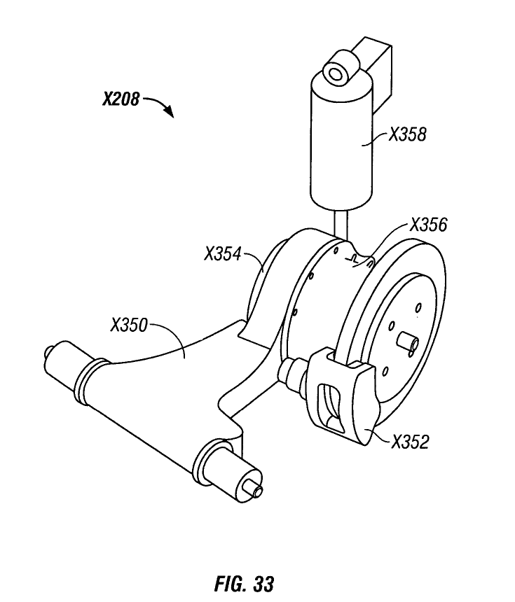

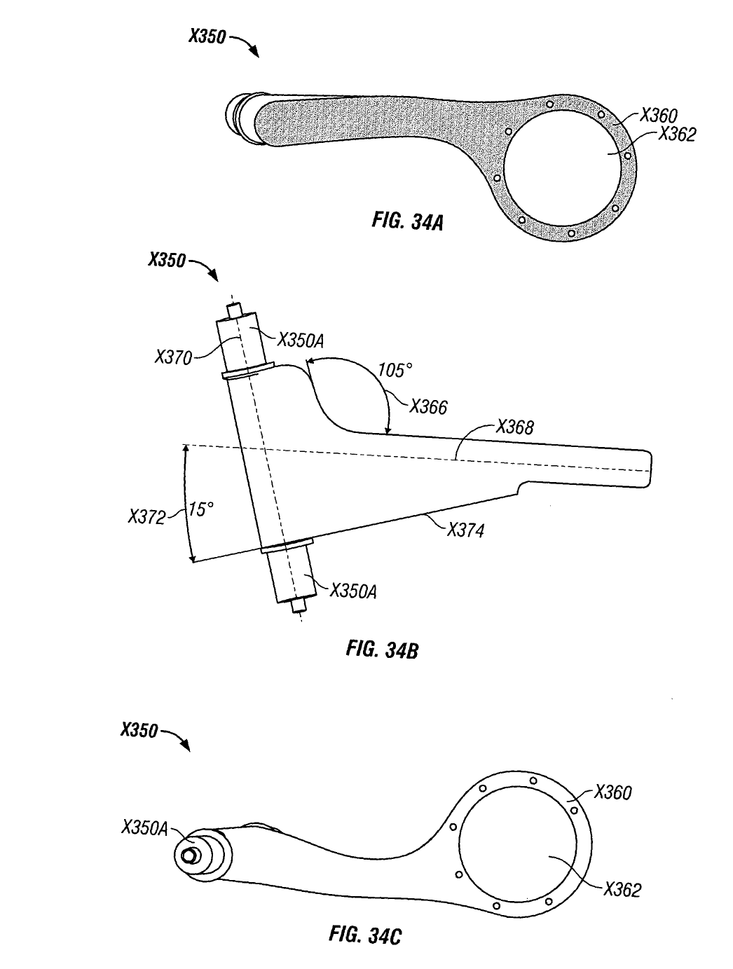

FIGS. 31A and 32B illustrate a carbon-reinforced composite A-arm X300 constructed according to the present invention. As shown, A-arm X300 features a large solid cross-section to minimize mass and simplify production tooling. The cross-section A-A shown in FIG. 31B demonstrates this large cross section X302. A-arm X300 also incorporates a generous tapered geometry to reduce stress concentrations, as is best shown in the solid and finite element models of FIGS. 32A and 32B.

Based on the large cross-section and tapered geometry, this aspect of the present invention provides advanced composite suspension components that are producible with an economically acceptable volume production process (e.g., 50,000 vehicle sets per year or more). In a further embodiment, the invention incorporates tailored reinforcement and co-processed metallic interfaces. In particular, the invention applies a large included volume (LIV) design philosophy that plays to the positive attributes of composite materials, by avoiding locally complex design features, maximizing the moment of inertia of a component's cross-section, and maximizing a component's long-term durability by reducing the applied load on the component. Further features of the invention include the use of large diameter bonded metallic interfaces X300A to facilitate the low load concentration transfer of applied loads and the incorporation of conventional automotive bushings to avoid the cost of custom designed bushings.

This aspect of the present invention involves a specific design strategy and interdependent production approach. The design strategy uses LIV shaping to manage loads, uses bonded metallic inserts to manage mechanical interfaces, and uses tailored reinforcement to manage internal loads and provide desired durability.

The LIV philosophy imposes simple, high moment of inertia shaping to a component to best exploit the advantages of carbon-reinforced polymers in terms of structural efficiency and ease of processing. Components made according to the present invention have closed cross-sections X300B that approach maximum internal volume for a given surface area. In the case of suspension components, this closed cross-section is quite different from conventional stamped sheet metal components, which typically use solid components with open cross-sections.

In an embodiment of the present invention, all mechanical interfaces include a simple, large diameter, sleeve type single lap bonded metallic bushing or insert. The bonded insert represents a very simple and reliable solution to the often complex problem of having to locally transfer loads from one interfacing structure to another. The use of bonded inserts enables a very simple geometric interface for the composite, contributing to low cost and structural efficiency, while using a metal detail to transfer the loads from the mating detail into the composite component in as efficient a manner as possible, and insuring uniform load distribution into the composite material.

In an embodiment of the present invention, the use of tailored reinforcement via cut and kit preforms enhances the component's ability to manage the applied loads in as efficient a manner as possible, while being careful not to introduce additional cost into the production process.

In contrast to the present invention, conventional components are typically mass-produced steel or aluminum. Although these conventional components may perform well over the lifetime of the vehicle, they are typically heavy, thereby compromising weight and optimal performance for durability and low cost. The approach of the present invention, on the other hand, provides for a significantly lighter weight component with equivalent durability and the potential for competitive cost.

Suspension components constructed of advanced composite materials (e.g., carbon fiber reinforced thermoplastic) are considerably lighter and can provide improved stiffness over conventional metal components. The lighter weight and improved stiffness reduce unsprung mass, which has proved to be a critically important aspect in the design of lightweight vehicles for acceptable ride and handling. Improved stiffness in the suspension component also gives greater control of compliance in the overall suspension of the vehicle, as each component can be better tailored to its particular role. Advanced composite suspension components also enable optimized structural shaping for the applied loads and surrounding packaging, thereby providing additional design freedoms.

This aspect of the present invention can be applied to most swingarm type suspension components provided their application is considered from the outset of the vehicle design effort, and accommodation provided in an appropriate fashion. In addition, notwithstanding the particular benefits associated with advanced composite suspension components, this aspect of the present invention can be applied to any structural vehicle component. Indeed, features such as LIV shaping, large cross-sections, and tapered geometries have beneficial applications to many different automobile components.

System Element: Modular Rear Suspension and Traction Motor Unit for Automobiles:

This aspect of the present invention provides an integrated rear suspension module X208, as shown in FIG. 21. Module X208 is a carbon fiber reinforced trailing arm type suspension component that functionally integrates the structural attachment for an integrated motor and gearbox, and serves as the primary structural member between the wheel and the vehicle. Designed to be modular, module X208 can be removed and fitted with either a wheel with an integrated wheel motor and brakes or a wheel/brake system only.

FIG. 33 illustrates an exemplary integrated rear suspension module X208, according to an embodiment of the present invention. As shown, module X208 includes a composite trailing arm X350, a brake assembly X352, a motor X354, a transmission X356, and a suspension strut X358. Composite trailing arm X350 is preferably made from carbon fiber reinforced polymer and incorporates a housing for motor X354. Motor X354 is preferably a hub motor attached to trailing arm X350 and mounted within its integral housing. Transmission X356 is preferably a step down epicyclic gearbox that is coupled in series to motor X354. Motor X354 and transmission X356 are designed to dispense with the need for a conventional knuckle, half shaft, and spindle.

FIGS. 34A-34C illustrate composite trailing arm X350 in greater detail, showing key interface details and the integrally molded bushing X350A. As shown, trailing arm X350 includes an integrally formed housing X362 and housing face X360, as well as bushings X350A for mounting trailing arm X350 to a vehicle body. Trailing arm X350 can be molded to suit any vehicle geometry. As shown in FIGS. 34A-34C, for example, the angle X366 between the front to back vehicle axis X368 and the mounting axis X370 is 105 degrees, and the angle X372 between the front to back vehicle axis X368 and the inboard side X374 of trailing arm X350 is 15 degrees.

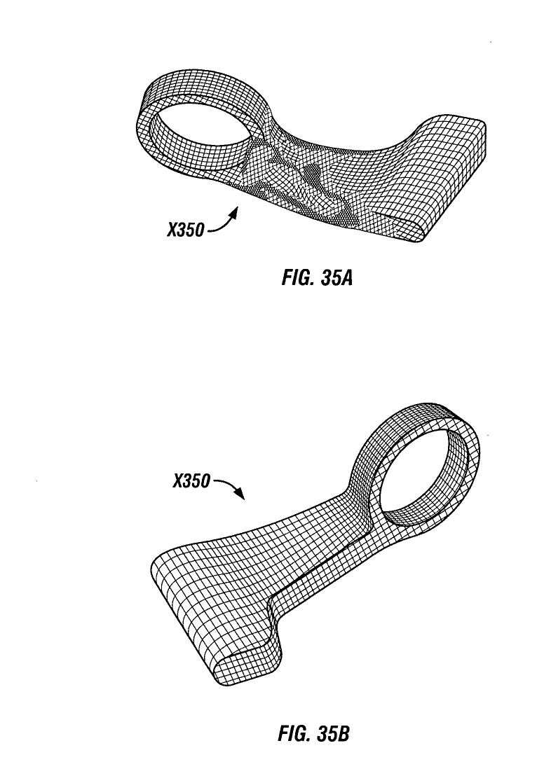

FIGS. 35A and 35B illustrate a solid model of composite trailing arm X350.

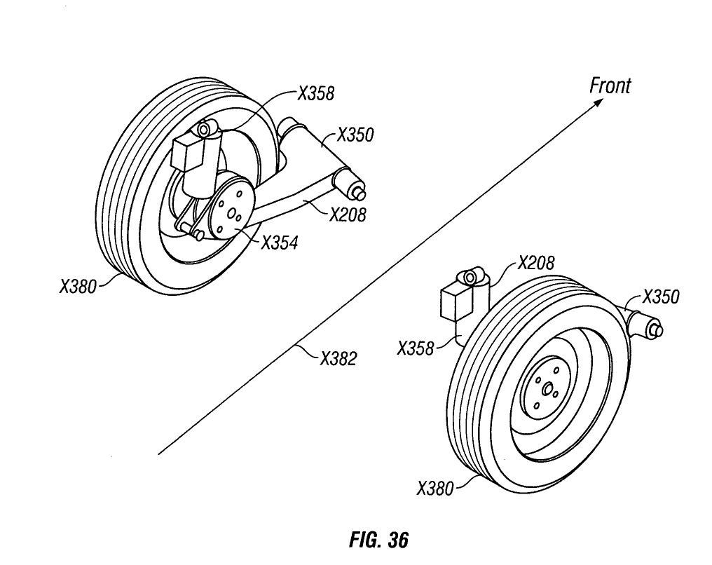

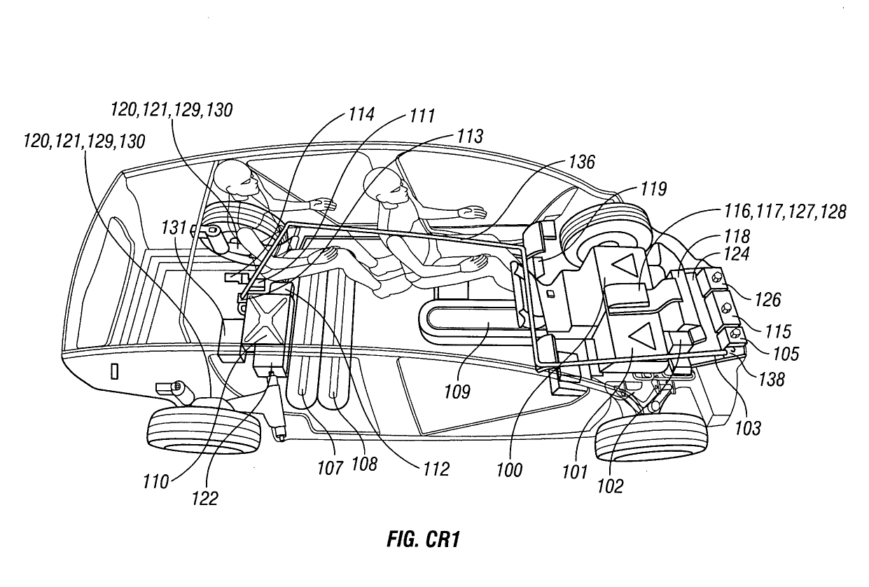

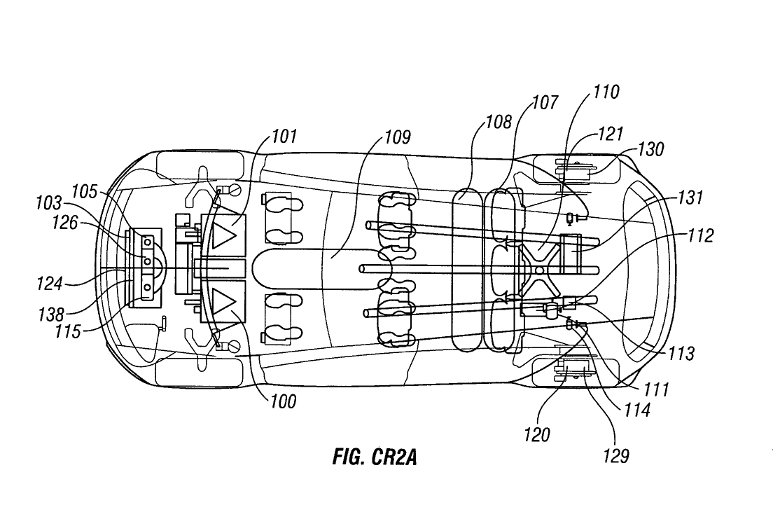

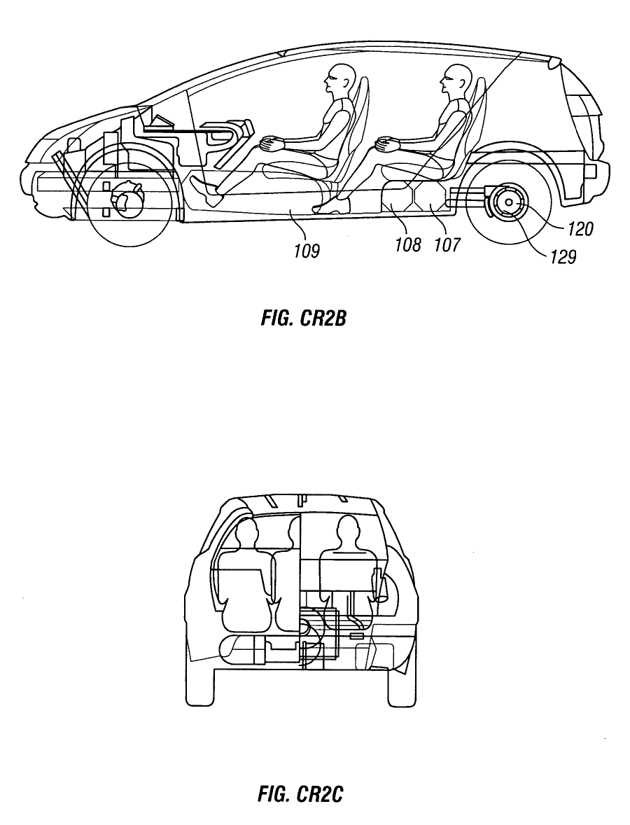

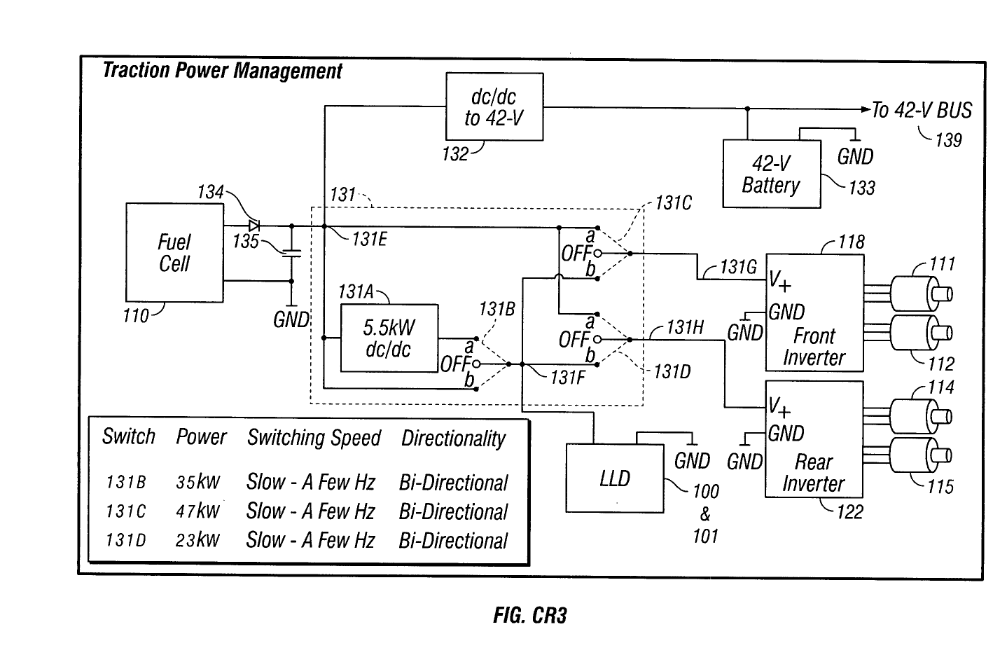

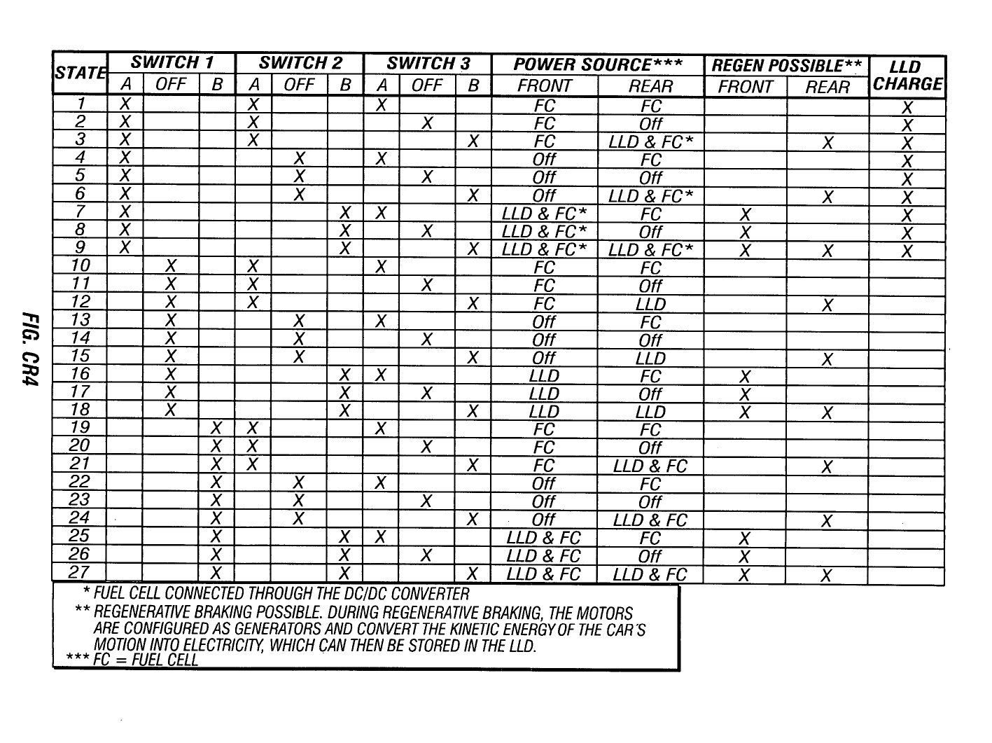

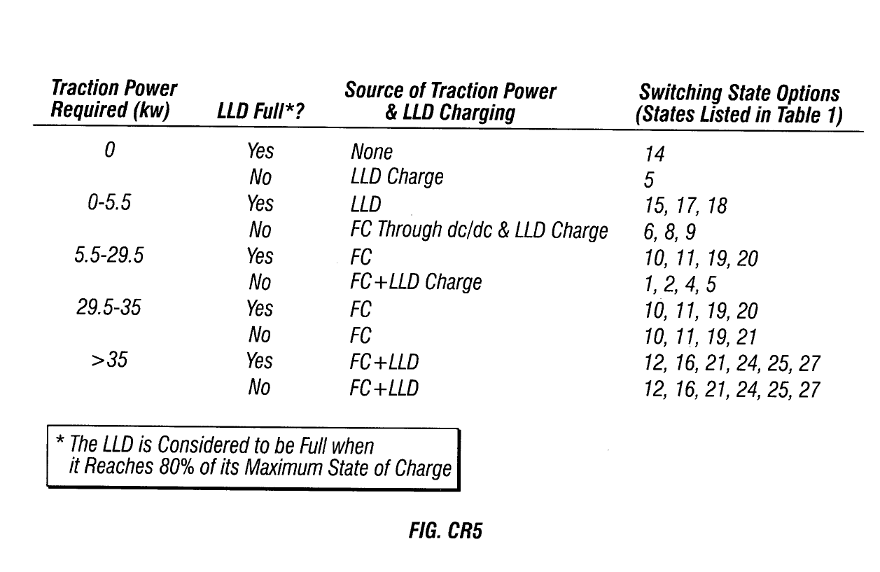

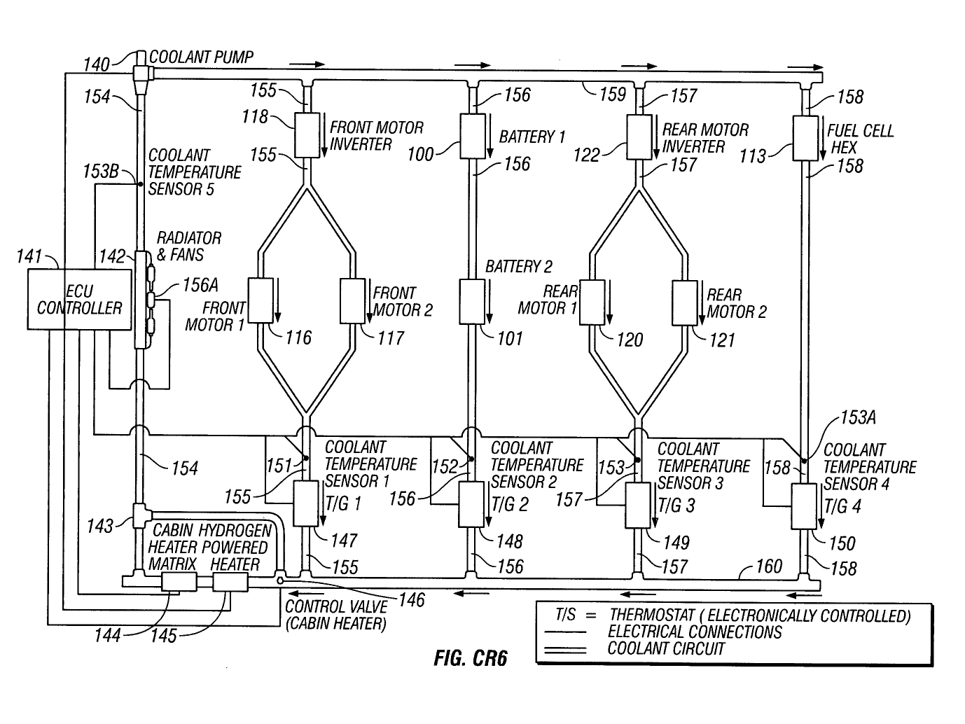

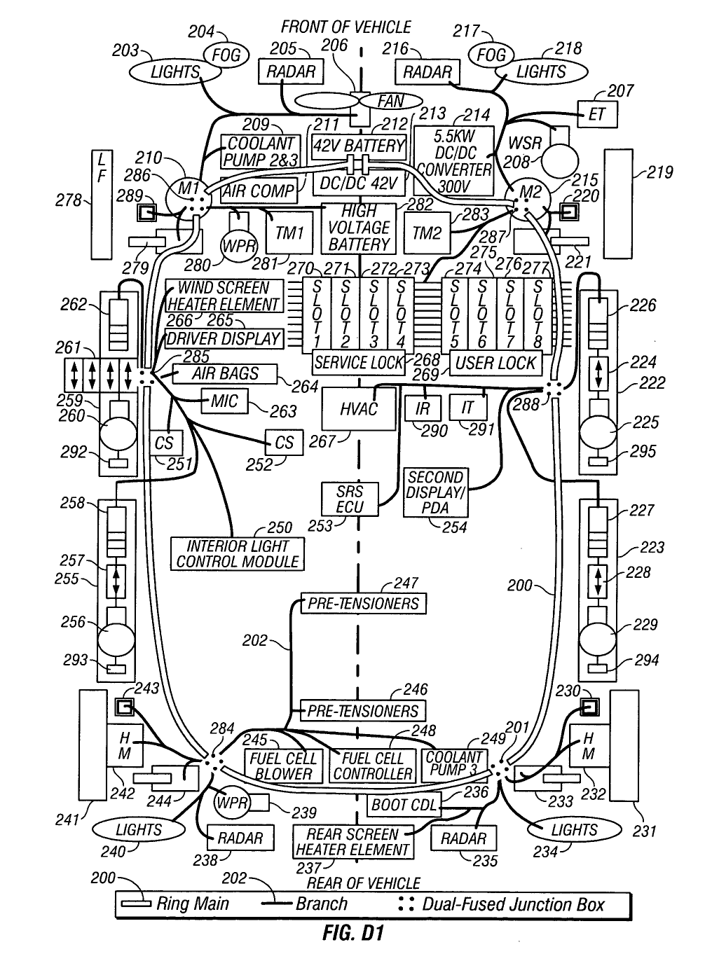

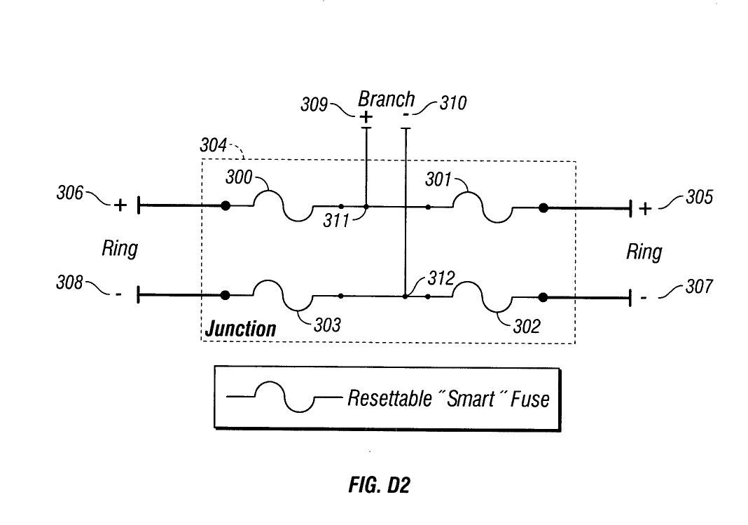

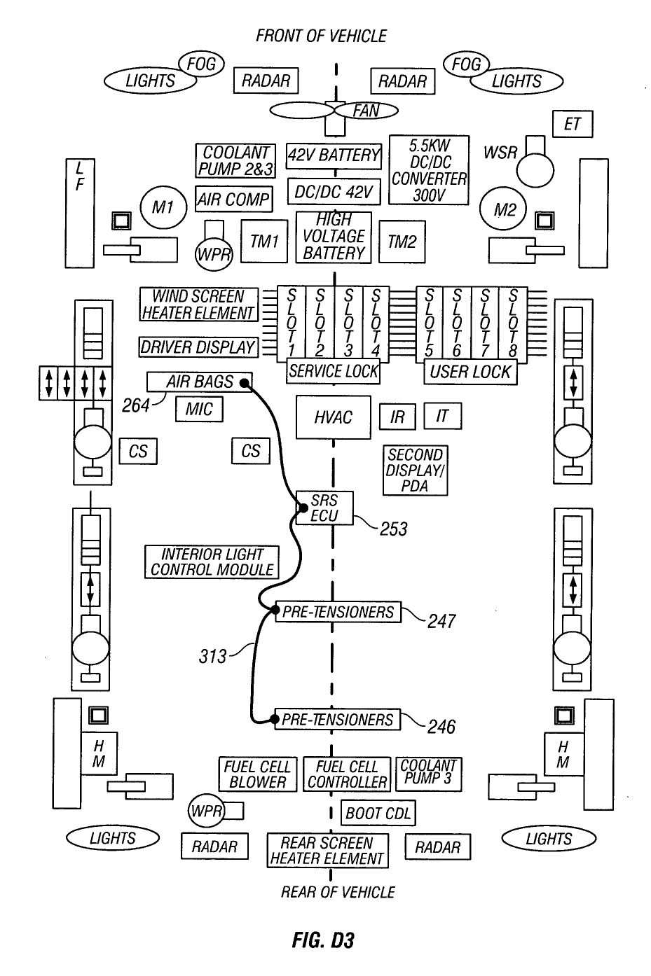

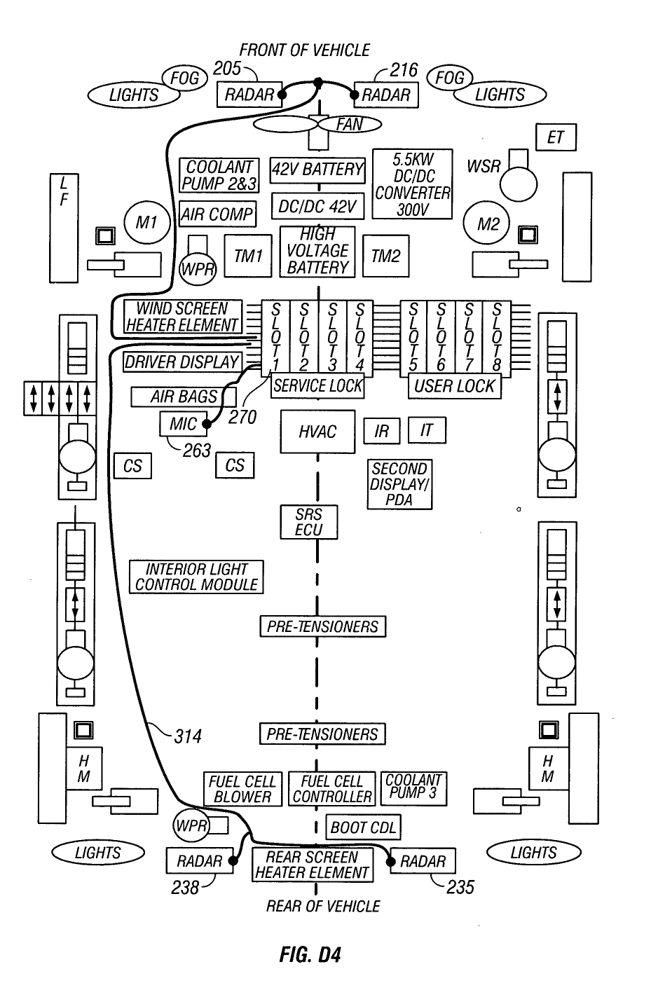

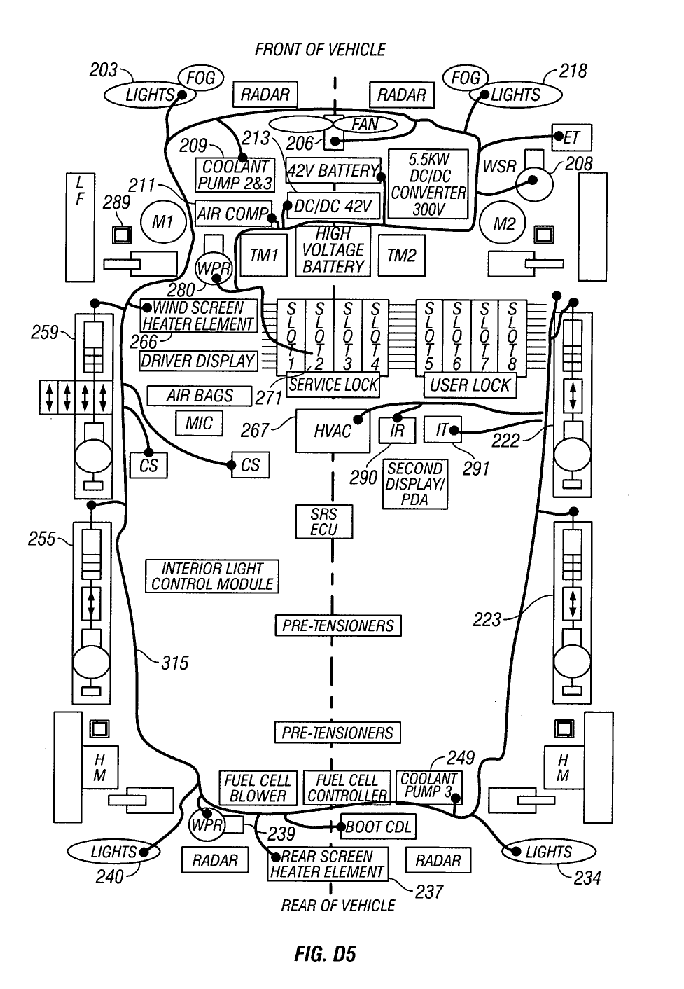

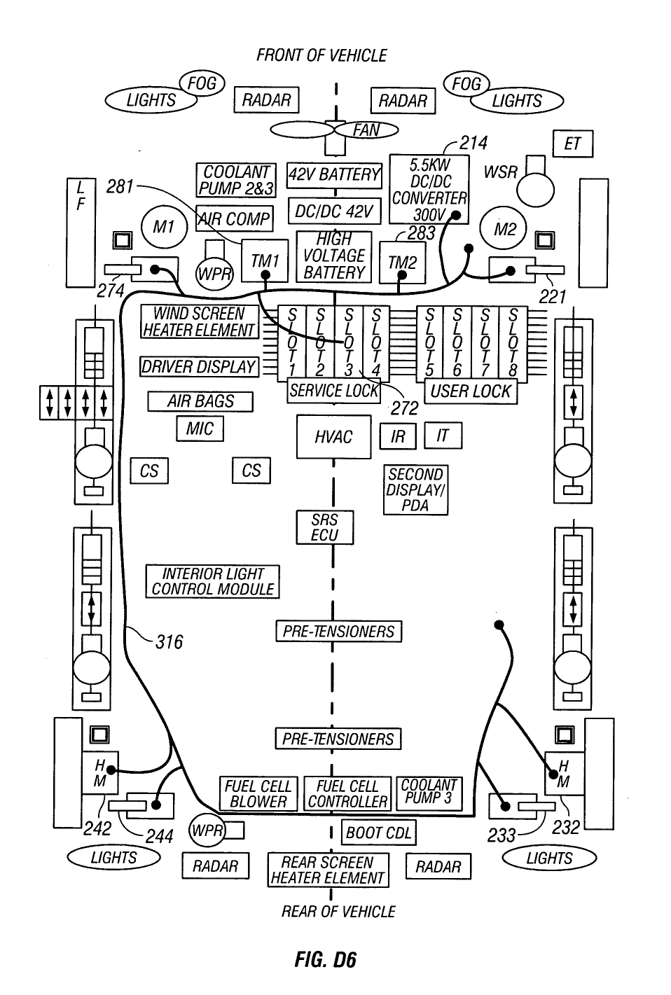

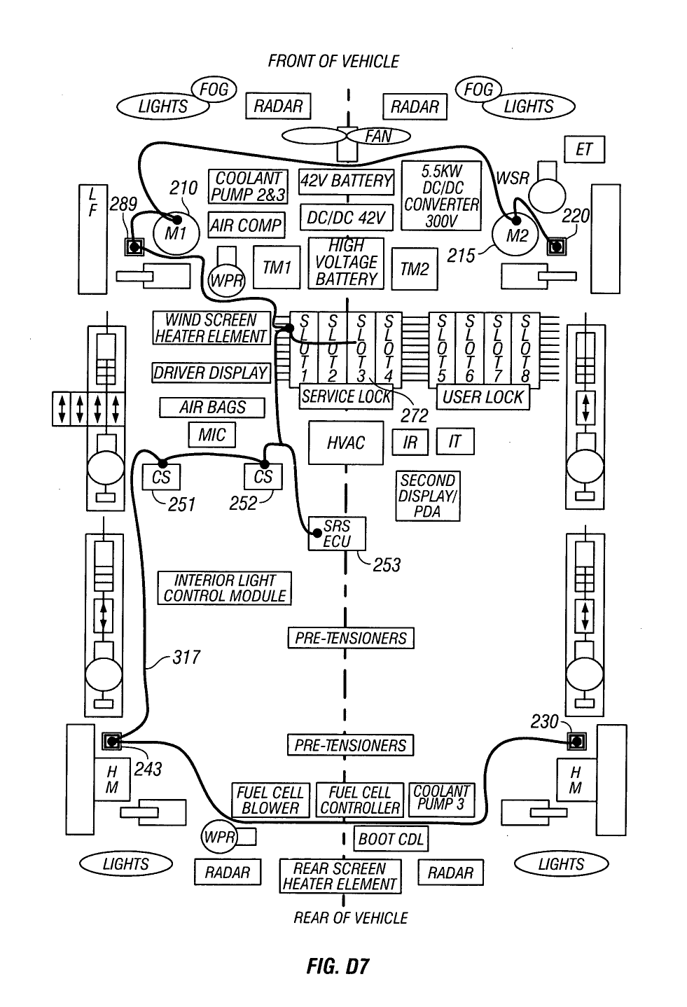

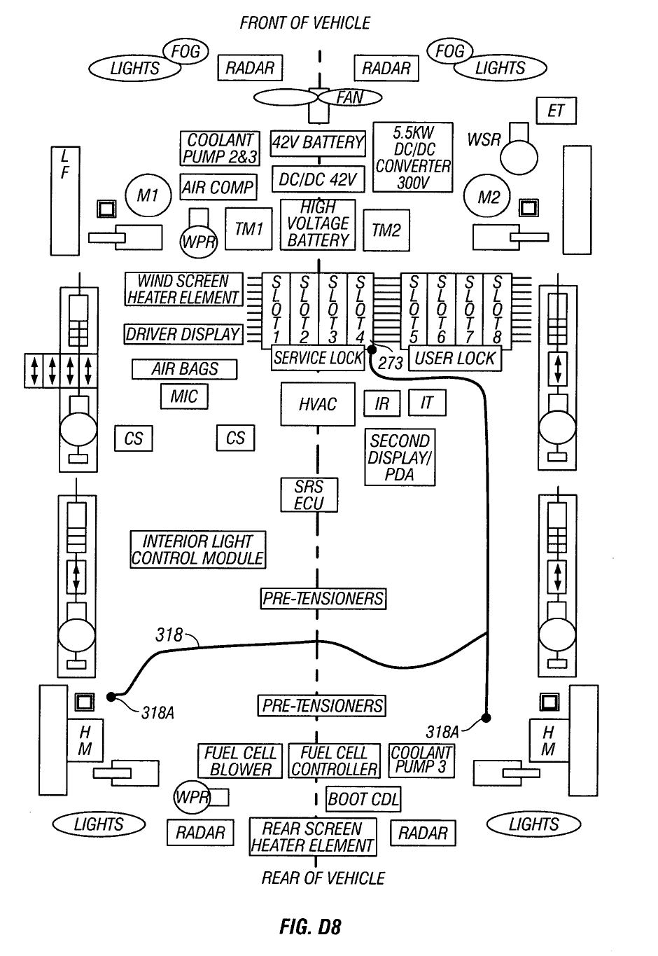

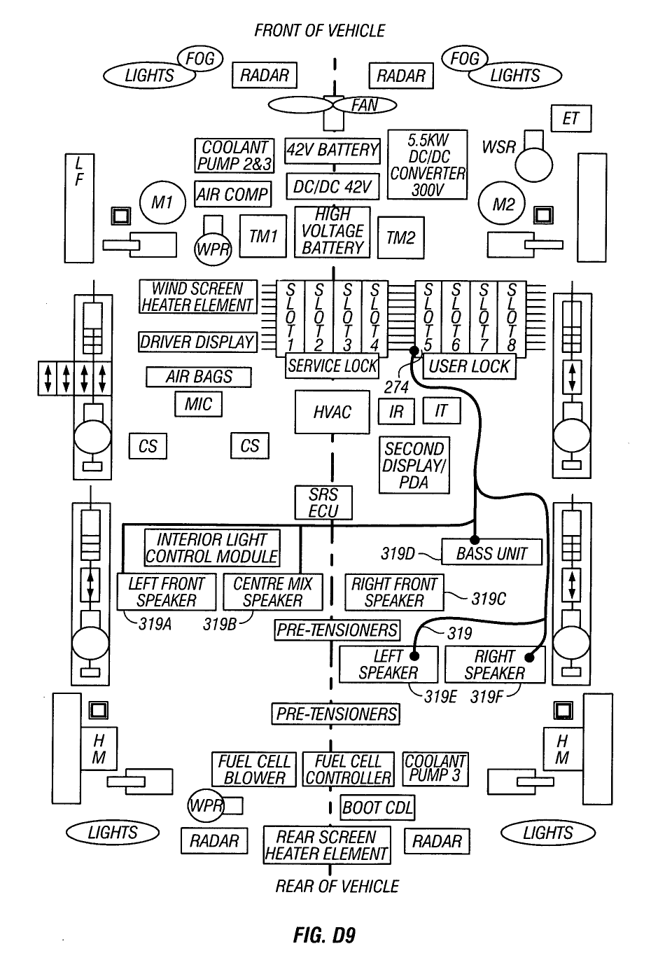

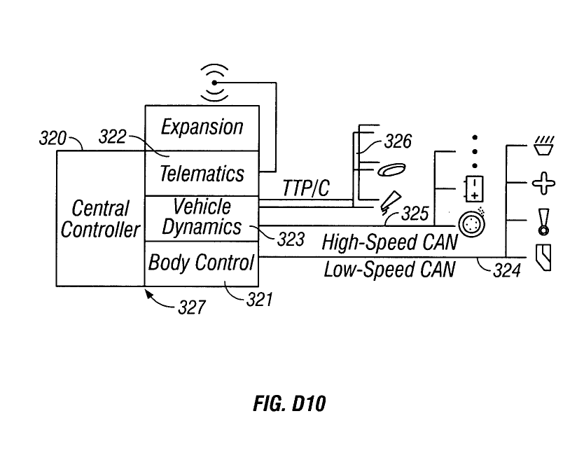

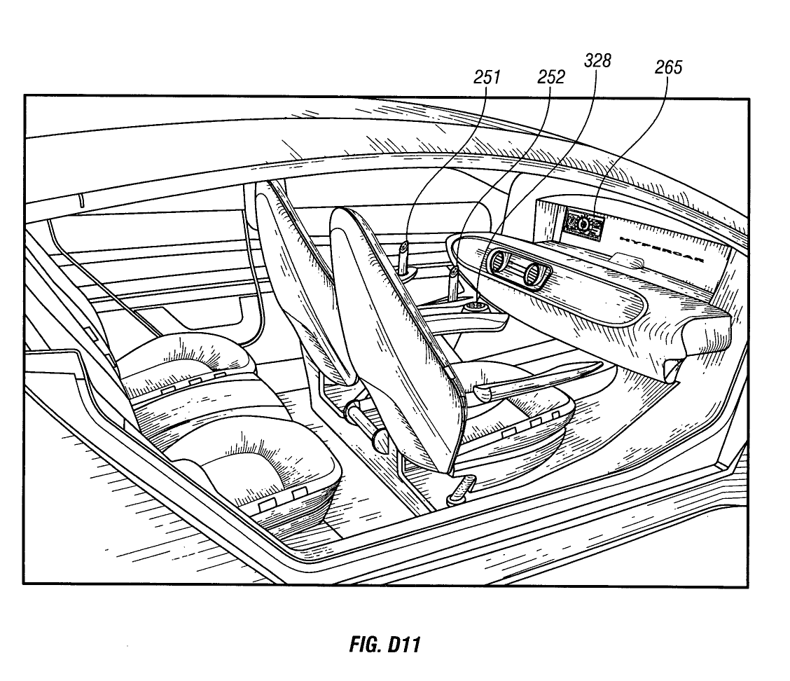

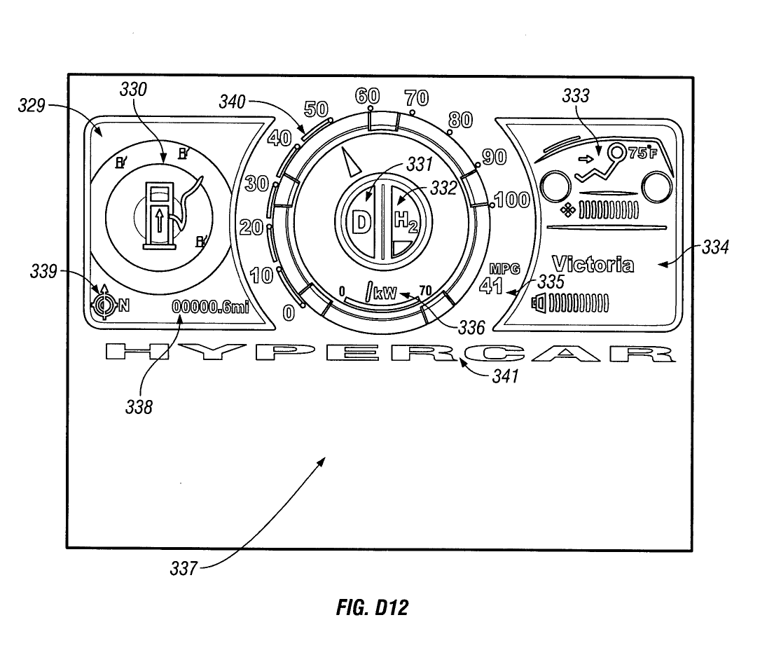

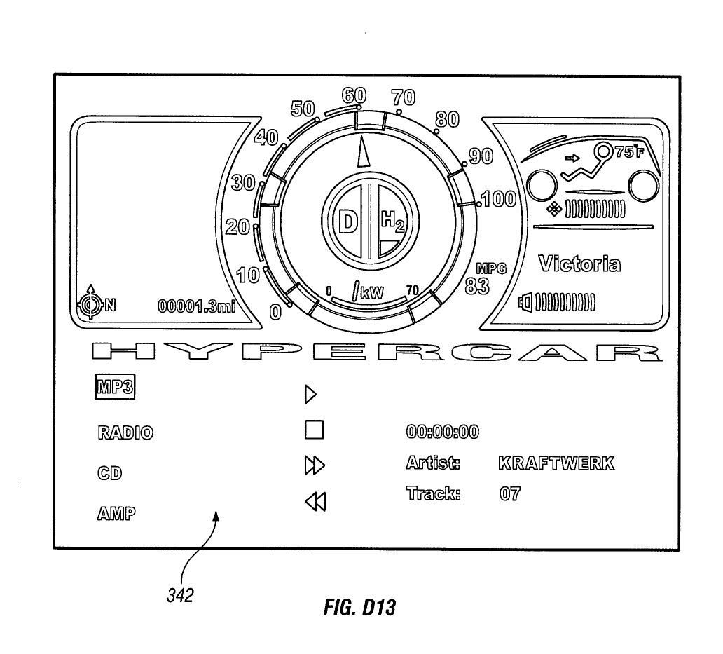

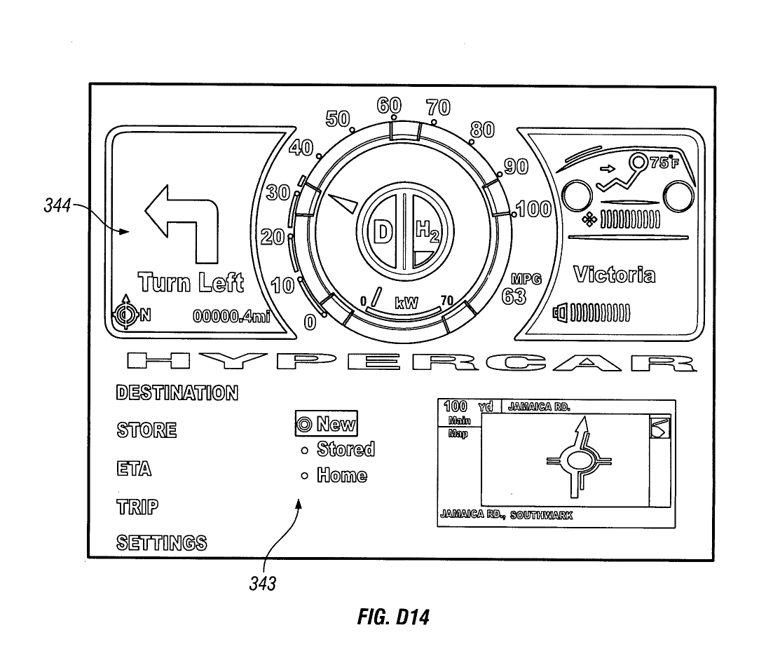

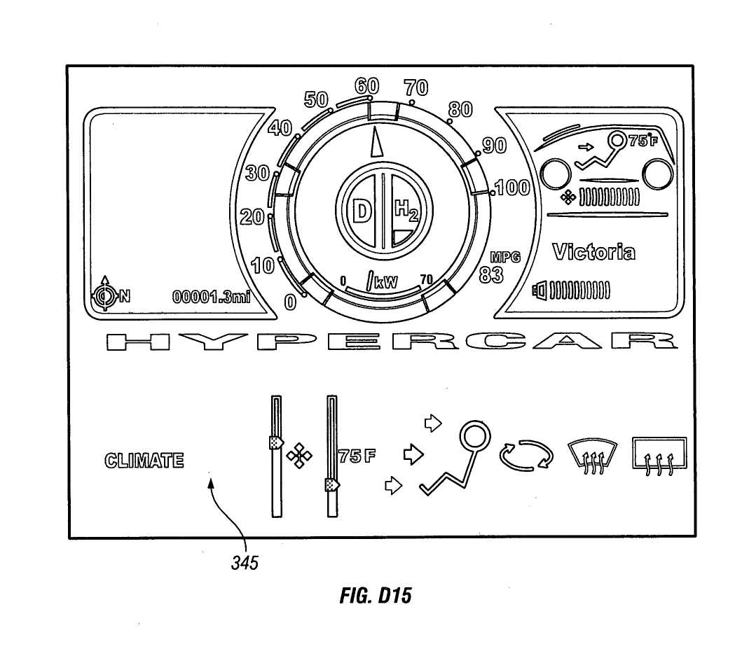

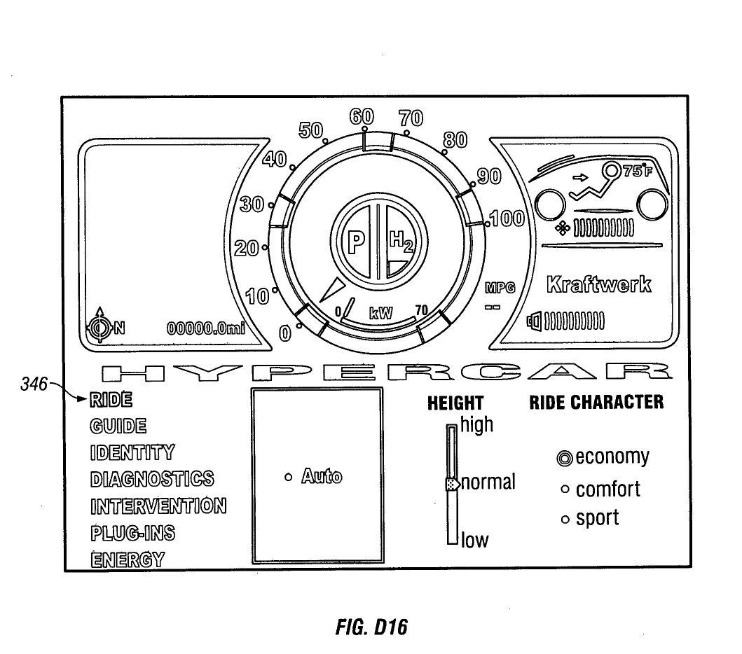

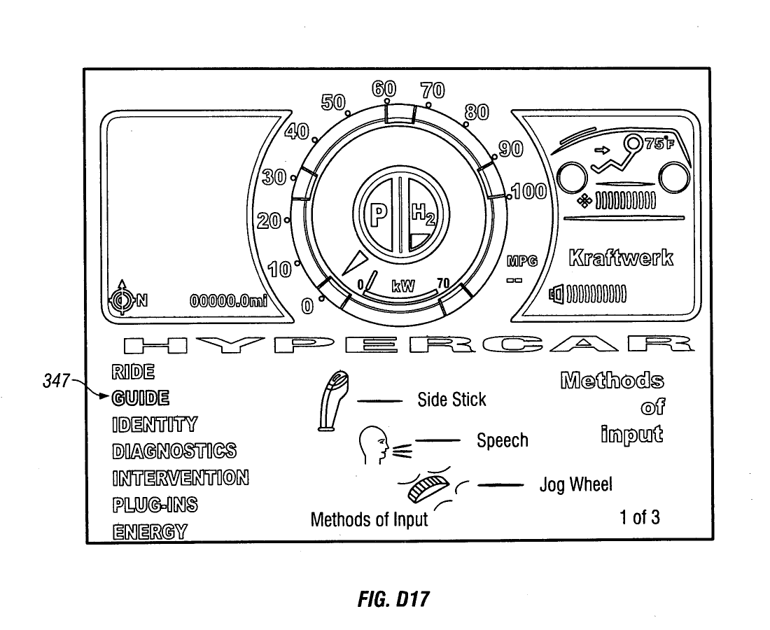

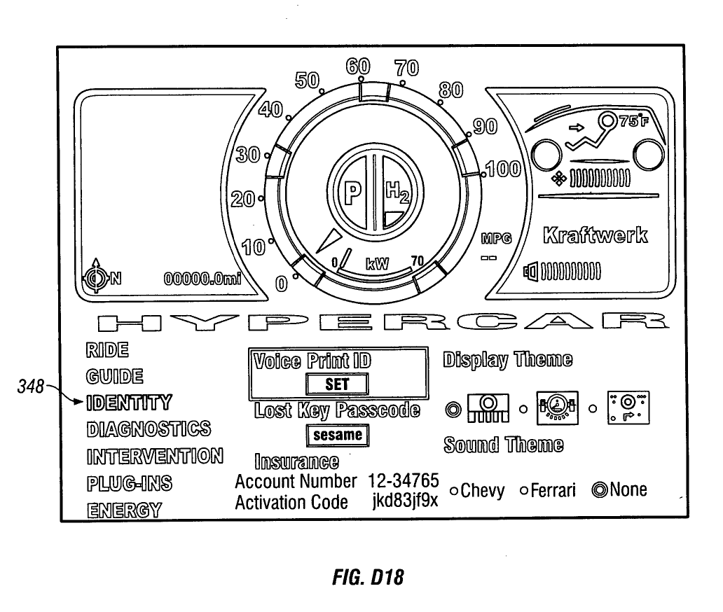

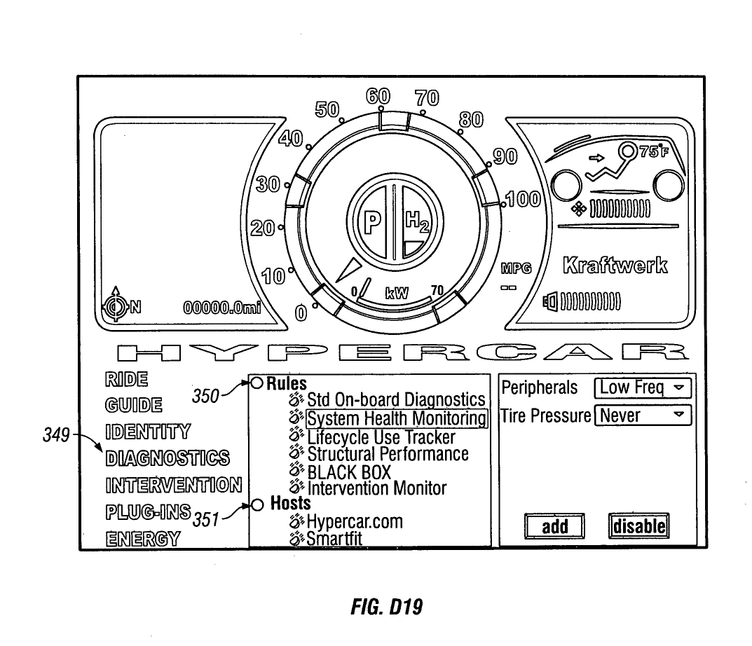

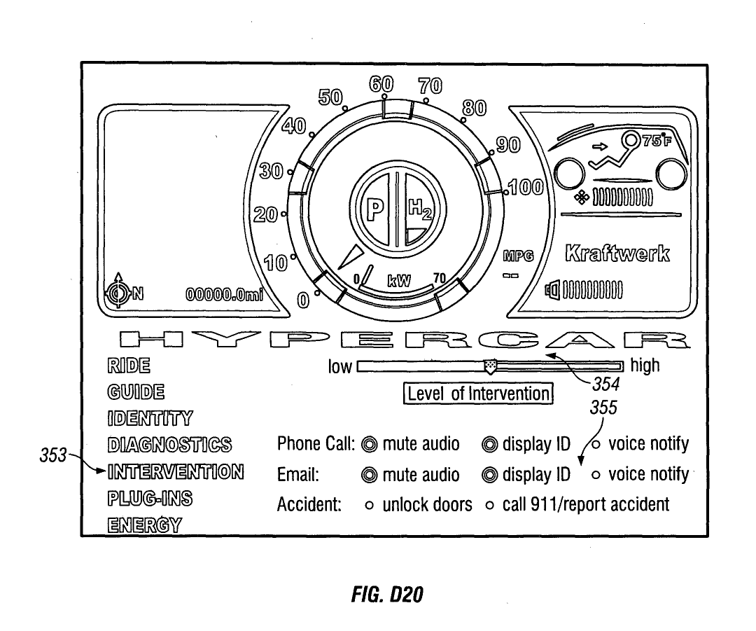

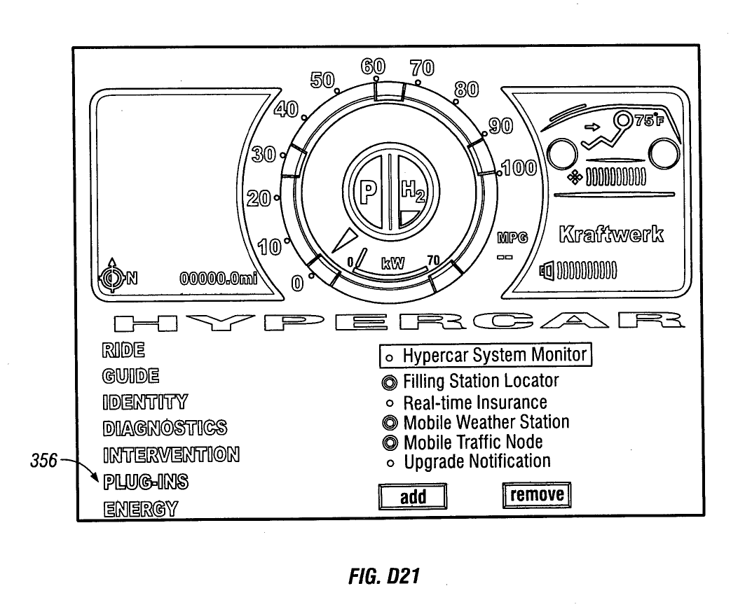

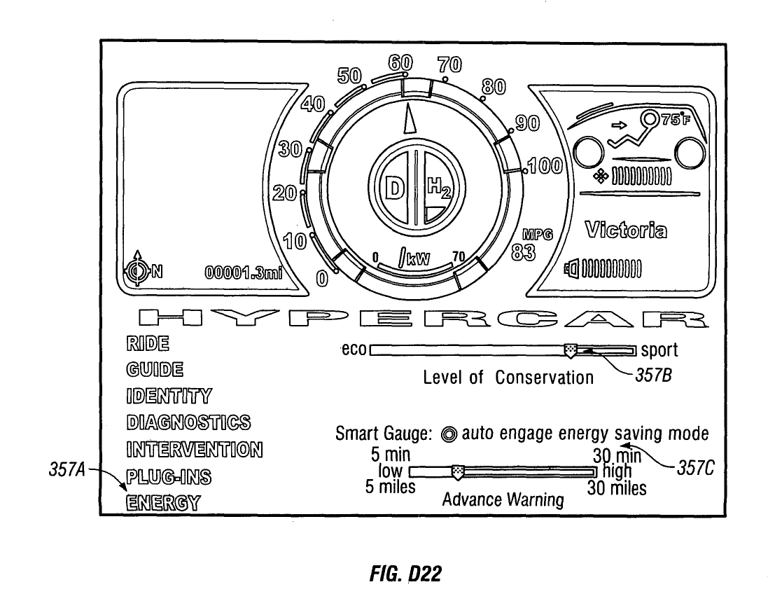

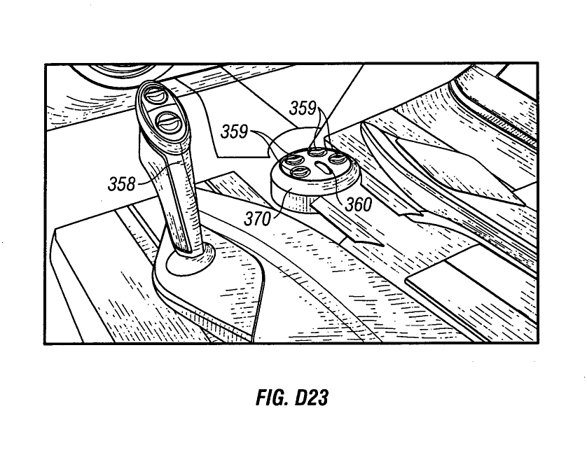

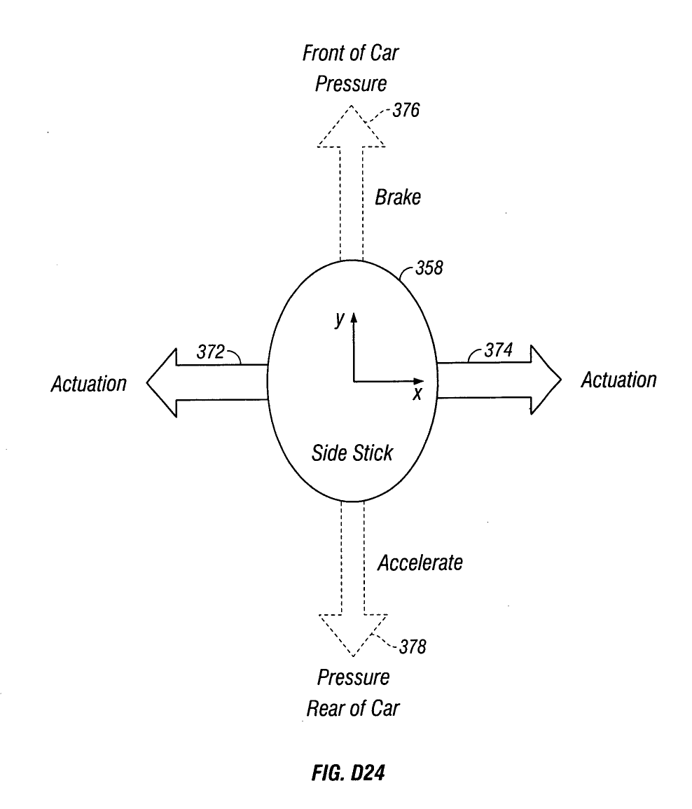

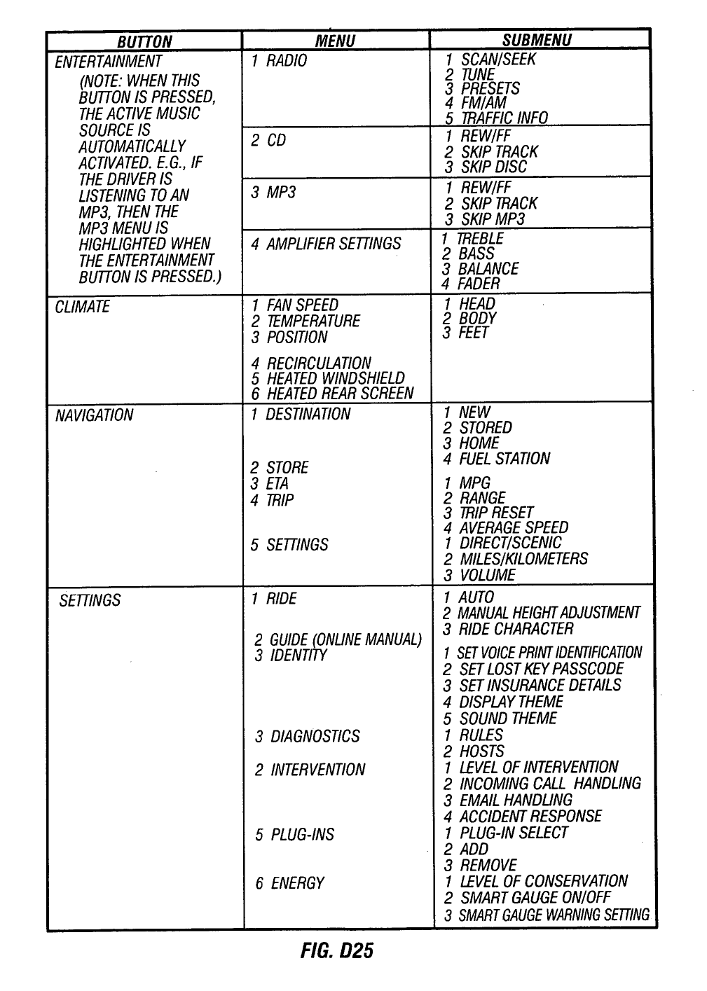

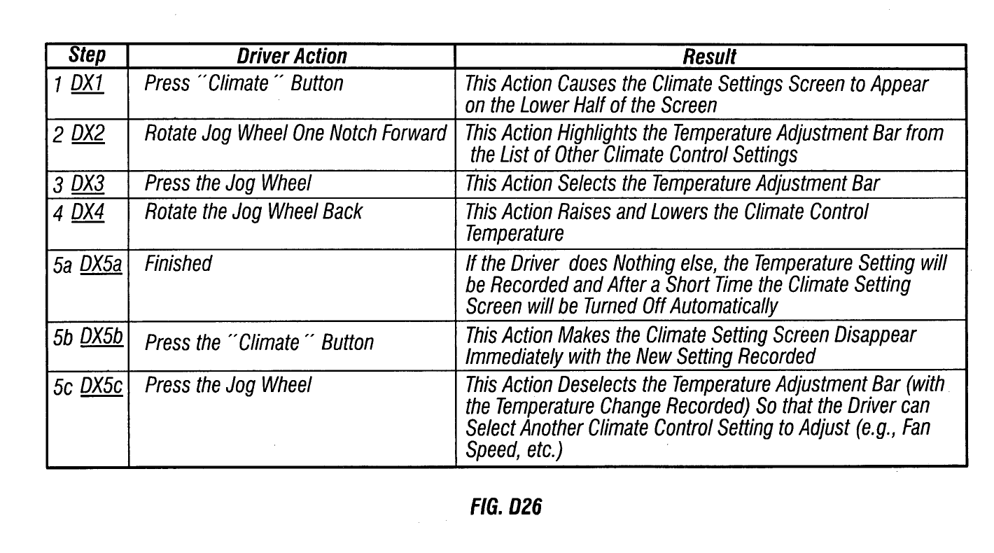

FIG. 36 illustrates rear suspension modules X208 mounted to rear wheels X380 of a vehicle. Arrow X382 indicates the direction of the front of the vehicle. In this configuration, the single-piece advanced composite trailing arms X350 of modules X208 reacts the traction loads of the traction motor X354, and reacts suspension loads into the floor component of the vehicle. The active electromagnetic/pneumatic suspension struts X358 of modules X208 adjust the ride height of the vehicle and thus the vehicle pitch, while also providing high-resolution real-time modification of the dampening of the strut for superior control of vehicle dynamics.

Based on the large cross-section and tapered geometry of trailing arm X350, this aspect of the present invention provides an advanced composite suspension component that is producible with an economically acceptable volume production process (e.g., 50,000 vehicle sets per year or more). In a further embodiment, the invention incorporates tailored reinforcement and co-processed metallic interfaces. In particular, the invention applies a large included volume (LIV) design philosophy that plays to the positive attributes of composite materials, by avoiding locally complex design features, maximizing the moment of inertia of a component's cross-section, and maximizing a component's long-term durability by reducing the applied load on the component. Further features of the invention include the use of large diameter bonded metallic interfaces (e.g., bushing X350A) to facilitate the low load concentration transfer of applied loads and the incorporation of conventional automotive bushings to avoid the cost of custom designed bushings.

The design and fabrication approach of this aspect of the present invention results in a very lightweight trailing arm component X350, which thereby reduces unsprung mass. Trailing arm component X350 is stiffer structurally than a conventional (e.g., stamped) trailing arm component, and therefore enables design optimizations that minimize intrusion into the interior volume of the vehicle. By integrating traction motor X354 with transmission X356, the present invention achieves a significant reduction in parts count, with commensurate production cost savings and weight reduction, and also negates the need for driveshafts and their associated efficiency losses.

System Element: Active Tire Contact Patch Control System to Manage Rolling Resistance and Dynamics of Automobiles:

In this aspect of the present invention, on board sensors monitor a range of vehicle parameters to actively optimize tire rolling resistance and contact patch geometry by adjusting tire pressure. The optimization results in an overall improvement in vehicle efficiency and safety under a wide range of operating conditions.

Conventional tire pressure monitoring systems typically include a pressure and temperature sensor that simply feeds back to the driver to provide a warning when a tire starts to lose pressure. In addition to providing this tire failure warning function, this aspect of the present invention monitors and adjusts tire pressure to optimize performance. Using the vehicle's central information management and control system X212 (see FIG. 21), this aspect of the present invention uses an active tire pressure monitoring system X210 to feed back information about where the tire contact patch is on the performance map of the vehicle. This additional functionality, combined with information from other vehicle sensors already in the vehicle (e.g., wheel speed sensors, accelerometers, and air spring pressure sensors) enables the dynamics controller X212 to tune the dynamic parameters of the vehicle for optimum stability and efficiency at any point in the performance map of the vehicle. This added control results in improved braking response and shorter braking distances, improved steerability, traction, and ride in response to a wider range of road conditions and driver inputs. Dynamics controller X212 also ensures that the tire is inflated to a pressure that optimizes fuel consumption and safety.

According to an embodiment of the present invention, an exemplary tire control patch system includes sensors, wiring infrastructure, and computer algorithms and application software. Sensors embedded in the tires and around the vehicle monitor tire pressure and temperature, vehicle mass and center of gravity, traction, and environmental data and report that data through the wiring infrastructure to the vehicle's central information management and control system X212. System X212 uses a vehicle dynamics and stability algorithm to interpret the data in conjunction with the driver's input. In response, system X212 actively increases or decreases the tire pressure to optimize the contact patch geometry that the tire makes with the road surface. The optimized patch geometry provides the optimum combination of rolling resistance and traction, thereby improving overall vehicle efficiency and safety.

Design of Fuel-Cell Hybrid-Electric Powertrain System for Automobiles

This aspect of the present invention provides a powertrain system for hybrid-electric vehicles. Embodiments of the present invention involve layout (i.e., packaging), configuration, electrical design and control strategy, and thermal management of the powertrain.

A preferred embodiment of the powertrain system includes a fuel cell and battery that together provide power to four independently controlled electric motors (one for each wheel). A digital power manager controls high-power switches to dynamically allocate battery or fuel-cell power to each wheel from either source and also to manage regenerative braking.

FIG. CR1 illustrates the layout of the major propulsion components of an exemplary powertrain system, according to an embodiment of the present invention. As shown, the powertrain system includes pressure vessels 107, 108, and 109 that store compressed hydrogen for use in the fuel cell 110, load-leveling batteries 100 and 101 that increase the total propulsion power available, propulsion motors 116, 117, 120, and 121 that drive the wheels through planetary reduction gears 127, 128, 129, and 130 and store energy recovered from braking, and a cooling system that maintains proper operating temperatures for each component. The cooling system includes a heat exchanger 103 for batteries 100 and 101; a coolant expansion tank 105 for heat exchanger 103; a heat exchanger 113 for fuel cell 110; fuel cell cooling lines 136, a coolant pump 114, and a coolant expansion tank 115 for heat exchanger 113; propulsion motor heat exchanger 124; and motor cooling lines (not shown), a coolant pump (not shown, but referred to herein as item 125), and an expansion tank 126 for propulsion motor heat exchanger 124.

During operation of the exemplary powertrain system of FIG. CR1, fuel cell 110 converts hydrogen from the pressure vessels 107, 108, and 109 and oxygen from the ambient air. The incoming air is passed through an air intake filter 112 and a blower 111. The cooling system for fuel cell 110 includes a coolant pump 114, a heat exchanger 113 to transfer heat from the cooling circuit within the fuel cell stack 110 to the heat exchanger 138 at the front of the vehicle that rejects heat to the ambient atmosphere, and an expansion tank 115. Coolant lines 136 connect the two heat exchangers 113 and 138, with coolant circulated by pump 114.

This exemplary powertrain system includes four electric motors, two 9-kW peak switched reluctance motors 120 and 121 in the rear hubs, and two 21-kW peak permanent magnet motors 116 and 117 mounted inboard to power the front wheels. Front motors 116 and 117 and rear motors 120 and 121 are connected to front 118 and rear 122 motor inverters, respectively, which are in turn connected to a power converter/switching controller 131 that manages how power is distributed through the vehicle. The power management system of power converter/switching controller 131 is described in detail below in reference to FIG. CR3.

The output shaft of each rear motor 120 and 121 is coupled to its associated wheel through a hub-mounted planetary reduction gear set 129 and 130, respectively. Front motors 116 and 117 are coupled to half-shafts through constant mesh twin reduction gears 127 and 128, respectively.

A battery controller module 102 monitors and controls the operating environment (e.g., cell temperature and voltage, current, and module temperature) for the battery modules. The propulsion system's microcontroller 119 interprets user input (e.g., accelerate, brake, and turn), vehicle dynamics data (e.g., pitch, yaw, roll, speed, and wheel slip), and propulsion system status (e.g., battery state of charge and fuel level) and determines the power level for each wheel. All of the propulsion components are sized to meet market requirements for acceleration, hill-climbing, driving range, and top speed.

FIGS. CR2A, CR2B, and CR2C illustrate the layout of the major propulsion components of FIG. CR1 in plan, side, and front views, respectively.

FIG. CR3 schematically represents the exemplary powertrain system of FIG. CR1 with additional detail related to how power converter/switching controller 131 works. The system uses a network of switches to manage power distribution between the fuel cell, load-leveling device, accessory power supply, and propulsion motors. It allows the fuel cell or load-leveling device (LLD) to be connected either via a bus or separately to the propulsion motors and low-voltage accessory power bus. The network of switches is managed by incorporating driver input (desired torque at the wheels) with the state of each motor and associated controller, LLD, fuel-cell system, and accessory loads.

As shown in FIG. CR3, the positive terminal of fuel cell 110 is connected through a diode 134 to a junction 131E of power converter/switching controller 131. A capacitor 135 connects the output of diode 134 to the negative terminal of fuel cell 110, which is the propulsion system's common ground. This capacitor 135 acts as a low pass filter for fuel cell 110's output.

The positive terminal of load-leveling battery modules 100 and 101 connects to power converter 131 at the output 131F to a switch 131B. Switch 131B connects to a dc/dc converter 131A. The output 131G to switch 131C and the output 131H to switch 131D connect to the front and rear inverters 118 and 122 for the traction motors, respectively. Power converter 131 connects to a dc/dc converter 132 that delivers power onto the vehicle's low-voltage battery 133 and power bus 139. Power bus 139 supplies non-traction electrical power (for accessories such as lights, air conditioning fan, door locks, and entertainment systems). Although the example of FIG. CR3 shows low-voltage power bus 139 as a 42-volt bus, this voltage could be set at any other level as required by a specific vehicle design.

Switches 131B, 131C, and 131D of FIG. CR3 are bi-directional, meaning that current can flow in either direction across the terminals of the switches. Their switching speed is also relatively slow, in a range of approximately a few Hertz. In a preferred embodiment, switch 131B is rated at approximately 35 kW, switch 131C is rated at approximately 47 kW, and switch 131D is rated at approximately 23 kW. These switch power ratings are determined by the maximum power of inverters 118 and 122. Fuel cell 110 supplies dc/dc converter 131A with up to 5.5 kW in a voltage range of about 175 V to 245 V in this exemplary design. (At zero load, the dc/dc converter sees an input voltage of approximately 280 V.)

The output voltage of dc/dc converter 131A to the high power bus sees the voltage of the traction battery, which also ranges from 175 (the instance after the traction battery is relieved from delivering 35 kW power to the electric motors) to 275 V (the instance the traction battery's SOC has reached its maximum (80%) at the end of a charging event).

Switches 131B, 131C, and 131D have different functionalities. Switch 131B controls three states of connectivity between fuel cell 110 and LLD 100 and 101: (1) charging LLD 100 and 101 through dc/dc converter 131A; (2) connected directly to LLD 100 and 101, and (3) not connected to LLD 100 and 101. When connected directly, the system acts as a common bus where the output voltage of fuel cell 110 and LLD 100 and 101 must be the same. Switches 131C and 131D determine the source of the power for front and rear inverters 118 and 122, respectively. The motors are then disconnected from the traction battery. Switches 131C and 131D are meant to provide traction motor inverters 118 and 122 with fuel cell power, with battery power, or with a combination of both.

Although FIG. CR3 illustrates a power management system in the context of front/rear motor control, as one of ordinary skill in the art would appreciate, these same principles could be applied to independent wheel motor control.

The various states allowed by the exemplary switching network of FIG. CR3 are listed in the power management system state table shown in FIG. CR4. The “switch” columns show the position of the switches. The “Power source” columns show, for both the front and rear inverters, whether the power source is the fuel cell, LLD, or both. The “Regen possible” column shows which switch settings allow regenerative braking for the front and rear motors. The “LLD charge” column lists the switch settings that allow the fuel cell to charge the LLD. Not all of these states would necessarily be used for any given control strategy. However, the flexibility of the multiple operating states allows the fuel cell and/or LLD to deliver power to the traction motors without using a common bus, which would require that their voltages match.

Referring again to FIG. CR3, switches 131B, 131C, and 131D are connected together so that dc/dc converter 131A can be used primarily for charging LLD 100 and 101 from fuel cell 110 and either power source can supply power directly to the traction motor inverters 118 and 122. This configuration improves electrical efficiency, reduces mass, and reduces the size of dc/dc converter 131A, since only a fraction of the total rated power needs to be conditioned by dc/dc converter 131A. The arrangement of switches 131B, 131C, and 131D and their connections also allows fuel cell 110 and LLD 100 and 101 to power traction motor inverters 118 and 122 independently or simultaneously, depending on the control strategy. Additionally, using dc/dc converter 131A to charge LLD 100 and 101 at a relatively low rate (5.5 kW maximum rate) is an efficient way to charge LLD 100 and 101.

The sizing of components in FIG. CR3 illustrates an exemplary vehicle design and could be modified to meet the requirements of different vehicles with larger or smaller powertrain requirements, while still maintaining the same overall architecture. Additionally, although this exemplary system includes a rear motor inverter 122 and a front motor inverter 118 that control two motors, any other propulsion system design having more than one inverter would work with this system. For example, there could be four inverters (one for each wheel), three inverters (e.g., two inverters for the front motors and one inverter for one or two rear motors), two inverters that control two front motors and no rear motors (i.e., a front-wheel-drive system), or other arrangements in which there are more than one traction motor inverter.

The table of FIG. CR5 describes an exemplary propulsion control strategy for the powertrain components of FIGS. CR1 and CR2, according to an embodiment of this aspect of the present invention. As shown, the “Traction power required” lists, in kW, the different operating ranges that require different control strategies. The “LLD full?” column indicates whether LLD 100 and 101 is fully charged, which is defined, for example, as 80% of its maximum state of charge. The “Source of traction power & LLD charging” column indicates the source from which the motors draw power and whether the LLD is charging. “FC” corresponds to fuel cell. Finally, the “Switching state options” column lists the options for switching states, which correspond to the switching state numbers listed in the leftmost column of the table in FIG. CR4.

Notably, FIG. CR5 describes only which power source delivers power to the wheels and when the LLD is charged, and does not describe whether the power is delivered to the front or rear motors. In all the cases described in the table of FIG. CR5, the power could be delivered to the front, rear, or both motors from the power source listed.

In normal driving when the LLD is not fully charged and the tractive power demand is less than 5.5 kW, dc/dc converter 131A draws a constant 5.5 kW from fuel cell 110, charging LLD 100 and 101 with whatever power remains after providing the desired power to the traction motors. When the car is stationary, LLD 100 and 101 is also charged, up to its upper limit of 80% of its maximum capacity (80% state of charge (SOC)). As soon as the power demand exceeds 5.5 kW, dc/dc converter 131A is shut off, and all demanded power is delivered directly to inverters 118 and 122 by fuel cell 110 without conversion, which improves efficiency. Once the SOC reaches it upper charge limit (80% SOC), the charging procedure is stopped, and the vehicle is driven by battery power or fuel cell+LLD power, until SOC has reached about 74%. Then the process starts all over again (charging to 80%). LLD 100 and I 01 is charged only to 80% SOC, where no gases are generated and coulombic efficiency stays high (near 1).

LLD 100 and 101 will occasionally be charged to a full 100% to keep the SOC tracking device calibrated. Only then would a constant current/constant voltage charge procedure be followed. Otherwise, charging is done as described above.

In an alternate propulsion control strategy, the rear motors are only used when front motor power is insufficient (e.g., >44 kW electrical demand in the case of the illustrative vehicle design described herein). The conditions span a fairly short timeframe and cannot be sustained because the fuel cell is sized to deliver a maximum of 35 kW (again, in this illustrative design). In this condition, dc/dc converter 131A is bypassed. As soon as less than full fuel cell power is required, a maximum of 29.5 kW is used for traction and the remaining 5.5 kW for charging the battery from, for example, 40% SOC to 80% SOC. The battery is thus charged at a fairly low power (5.5 kW is low load for a 35 kW battery), which improves charging efficiency because it is an efficient rate for the battery and is in an efficient output zone for the fuel cell (efficiency for a 35-kW fuel cell peaks at about 5.5 kW).

Having electric motors at each wheel enables a very high degree of control of vehicle dynamics. Combined with a torque-based (rather than speed-based) control strategy, this hardware/software combination offers high-resolution (in control angle and rate) traction control, braking, and stability control. The control strategy for the drive train also accommodates the extremes of driving behavior in graceful ways without having to oversize components or curtail driving performance.

The motor types, sizing, and configuration also contribute to the system's energy efficiency. Permanent magnet front motors located inboard of the wheels are preferably sized to be most efficient in the speed/torque range most often required by the vehicle. Since the control strategy biases the power distribution toward the front motors over the rear during cruising, these motors get more use and are thus specified to be permanent magnet motors.

The rear motors are preferably located in the hubs of the wheels (to improve packaging space) and are sized smaller than the front motors. These motors are used intermittently (as tasked by the propulsion controller) and are thus specified to be switched reluctance motors. This improves efficiency because there are no idling losses from exciting the magnetic fields of a permanent magnet motor.

An important aspect of the propulsion system of the present invention places inboard motors in the front of the vehicle and hub motors in the rear, with the front motors being more powerful than the rear motors.

Another important aspect of the present invention provides a power distribution approach that uses a set of high-power switches and a small dc/dc converter in contrast to the conventional approach of including a dc/dc converter sized to condition the full fuel-cell output that is then connected to a common bus.

Another important aspect of the present invention provides a vehicle control strategy and system sizing that addresses diverse driving scenarios. The invention achieves the goal of providing consistent, predictable driving performance under many types of driving situations by sizing the fuel cell to have a peak power sufficient to maintain highway speeds at gross vehicle mass up a 6.5% grade. The energy capacity of the load leveling device is preferably sized to be able to handle several accelerations in this circumstance (e.g., gross vehicle mass, highway speed, and 6.5% grade) and, after a certain point, to progressively reduce the power available from the load-leveling device until it is at its lowest allowable state of charge.

Costs savings are a significant benefit of the configuration of the power electronics components of FIG. CR3. In particular, in distributing electricity between the propulsion system components (fuel cell, load-leveling batteries (“LLD”), electric motors, and accessories), the configuration obviates the need to maintain a consistent bus voltage between the components. Therefore, instead of having a dc/dc converter sized to condition the entire output of the fuel cell to be a consistent voltage (e.g., 35 kW in this case), a smaller (e.g., 5.5 kW in this case) dc/dc converter can be used just to support battery charging at any fuel-cell load and battery state of charge, and to provide fuel-cell power at less than a certain threshold (5.5 kW in the case of the illustrative design) in a voltage range that is usable by the inverters. Each component operates within a specific voltage range. The fuel cell output voltage varies with load, the LLD voltage varies as a function of several factors (including rate of discharge (voltage sags at high rates of discharge), state of charge (the voltage generally drops with state of charge), temperature (in general, lower temperatures result in a lower effective state of charge), materials, etc.), and the motors and their inverters operate within a fixed range of voltages and currents based on load required. Forcing a narrow voltage range within the power distribution network requires each component to have more sophisticated (and thus costly) power conditioning electronics. This is particularly true of the fuel cell. The present invention uses a network of switches and a small dc/dc converter to connect the fuel cell and LLD either via a bus (in which the output of the fuel cell and LLD provide power to the electric motors along the same power lines) or directly to each motor (separating the outputs of the fuel cell and LLD, thus avoiding the bus and resulting common voltage level).

The propulsion system of the present invention also improves electrical efficiency. In particular, the switching network employed to manage power distribution improves electrical efficiency because it avoids the higher efficiency losses associated with having the fuel cell output always pass through a dc/dc converter.

An important aspect of this exemplary power management system is the way in which the components are connected, i.e., the network of switches and small (e.g., 5.5 kW) dc/dc converter.

Another important aspect of this exemplary power management system is the use of the switches to avoid needing a very high power dc/dc converter that is sized to handle the maximum output of the fuel cell (e.g., 35 kW in this case).

Another important aspect of this exemplary power management system is the use of a switching logic that incorporates the state of all of the components of the system (including the motor controllers).

In addition to power management, a further aspect of the present invention provides an efficient propulsion system cooling approach for hybrid electric vehicles. This aspect of the present invention uses an electronically controlled, variable speed cooling pump, and electronically controlled valves in a common rail system architecture, to provide cooling for the fuel cell, electric motors, and traction batteries. The cooling system is integrated with the passenger compartment heater core and an in-line, hydrogen burning supplementary heater for the passenger compartment.

FIG. CR6 illustrates an exemplary cooling system design for a powertrain system, according to an alternative embodiment of the present invention. Although other portions of this specification describe a cooling system having separate dedicated cooling circuits for each system with unique cooling loads (as shown by, for example, separate heat exchangers), this alternative embodiment of the present invention provides a cooling system that uses a single coolant circuit for all powertrain components. The system uses a common rail topology to supply coolant to the powertrain components, with the flow to each component group controlled using a single electric, variable-speed coolant pump 140 and electronically controlled thermostat valves 147, 148, 149, and 150. This system allows for each component group to be kept at different service temperatures without the need for multiple coolant pumps, heat exchangers, and cooling lines. It also allows the passenger compartment to be heated by the combined heat generated by the powertrain components.

The common rails 159 and 160 provide coolant to four branches. One branch 155 supplies coolant to front motors 116 and 117 and inverter 118. Another branch 156 supplies coolant to the load-leveling batteries (100, 101). Another branch 157 supplies coolant to rear motors 120 and 121 and their inverter 122. The fourth branch 158 supplies coolant to fuel cell heat exchanger 113.

An electronic control unit (ECU) 141 receives coolant temperature measurements from temperature sensors 151, 152, 153, and 153A in the branches as well as sensor 153B and other input such as passenger compartment temperature, desired passenger compartment temperature, ambient temperature, and vehicle speed. Using these inputs, ECU 141 controls the speed of coolant pump 140, thermostat valves 147, 148, 149, and 150, the cabin heater control valve 146, a hydrogen-powered heater 145, the cabin heater matrix 144, and variable-speed, electrically driven radiator fans 156A to properly cool the powertrain components and heat the cabin.

The exemplary coolant system design of FIG. CR6 reduces the total mass of the cooling system compared to a system in which the various components each have their own cooling system, since the common rails avoid a number of cooling pipes, radiators, and coolant pumps. Also, efficiency gains are achieved by having pipes with larger sections (which reduces pumping losses due to friction, to variable-speed pumps, and to tightly controlled coolant flow to each component). The centralized, dynamic control of pump speed and valve positions minimize wasted pumping energy and appropriately cool each component without excess coolant flow (which avoids energy being wasted in pumping losses from pump inefficiency and friction loss in the pipes).

The system described could include fewer or more branches depending on its specific application. Issues to consider in the design of the system would include the number of components needing cooling, their specific cooling requirements, and their layout within the vehicle.

All components that manage energy within the vehicle (e.g., motors, fuel cell, batteries, power electronics, and brakes) generate waste heat that must be dissipated. In conventional vehicles, the engine generates ample waste heat that is used to supply the passenger compartment with heat. In fuel-efficient hybrid-electric vehicles, the engine alone or the engine and batteries in a hybrid-electric system generally do not generate sufficient waste heat to effectively heat the cabin in cold climates. Thus, this system captures waste heat from many sources, meaning more of the waste heat generated on board the vehicle is captured for use in heating the cabin.

In addition, an embodiment of the present invention includes a small in-line combustion heater 145 (in this case a hydrogen powered heater) within the cabin heating circuit to supplement the waste heat captured. This heater 145 provides both quick warm-up time and additional heating power, if necessary.

Overall, the cooling system of this aspect of the present invention addresses thermal management in a holistic fashion, minimizing pumping losses and using the excess heat from many components to contribute to cabin heating. Any number (the more, the better) of components can be cooled with the same cooling system. Indeed, the system is scalable.

As a reference, the following Table 1 lists each component of FIGS. CR1, CR3, and CR6, along with a brief description of the component and, in some cases, exemplary specifications.

TABLE 1
Exemplary System Components

| Number | Component and Description |
|---|---|
| 100, 101 | Load-leveling device (LLD) |
| | The LLD includes approximately 35-kW of nickel metal hydride high power batteries that |
| | provide power to the motors and can also be used to store energy captured through |
| | regenerative braking. They are sized to provide sufficient acceleration in most driving |
| | conditions when used in conjunction with the fuel cell 110. The cooling lines and electric |
| | poles of the two modules are connected with click-on connectors. There are twenty battery |
| | modules, organized in two ten-module packs that are connected in series in order to have |
| | an open-circuit voltage of 240 volts. In an embodiment, each module is approximately 167 |
| | mm in length, 102 mm in width, 125 mm in height, weighs about 3.2 kg, and has a volume |
| | of about 2.2 liters. Other battery types such as lead acid, lithium ion, or lithium polymer |
| | could also be used. |
| 102 | LLD controller module |
| | The LLD controller module tracks battery temperature, voltage, and current flow to |
| | determine the state of charge and the flow of coolant through the modules,. In an |
| | embodiment, the LLD controller module is about 15 × 15 × 10 cm and weighs approximately |
| | 1 kg. |
| | cooling |
| 103 | LLD heat exchanger |
| | The LLD heat exchanger cools the battery coolant with ambient air. In an embodiment, the |
| | LLD heat exchanger is about 40 × 15 × 3 cm and weighs approximately 1 kg. |
| 104 | LLD coolant pump |
| | The LLD coolant pump circulates coolant through the battery modules and the heat |
| | exchanger. In an embodiment, the LLD coolant pump is about 6 cm in diameter and 10 cm |
| | long, and weighs approximately 0.5 kg. |
| 105 | LLD coolant expansion tank |
| | The LLD coolant expansion tank is a resevoir for the battery coolant to fill as it heats up |
| | and expands. In an embodiment, the LLD coolant expansion tank is about 10 × 10 × 10 cm |
| | and weighs approximately 0.2 kg. |
| 107, 108, | Hydrogen tank system |
| 109 | The three hydrogen tanks are preferably sized to give the vehicle a range of approximately |
| | 530 kilometers, and are located within the passenger safety cell to protect them from minor |
| | collisions and abuse and damage. In an embodiment, the tanks are type IV, 5,000 psi |
| | carbon-fiber/polymer tanks with internal pressure valves. In an embodiment, two of the |
| | tanks 107 and 108 are approximately 250 in diameter, 1000 mm long, with an internal |
| | volume of 36.7 liters, an H₂ mass of 0.84 kg, and weighs approximately 7 kg. The other |
| | tank 109 is approximately 310 in diameter, 1100 mm long, with an internal volume of 63.6 |
| | liters, an H₂ mass of 1.46 kg, and weighs approximately 12.2 kg. |
| | Fuel cell system |
| 110 | Fuel cell stack |
| | This PEM (proton exchange membrane) fuel-cell stack is an ambient-pressure fuel cell |
| | with a maximum power output of 35 kW. The module includes manifolds and mount |
| | points. In an embodiment, the fuel cell stack specific power is approximately 0.9 kW/kg, |
| | weighs about 38.9 kg, and is about 100 volts. |
| | air inlet |
| 111 | blower |
| | The blower forces air into the fuel cell. In a high pressure fuel-cell system, this would be a |
| | compressor. In an embodiment, the blower is about 20 cm in diameter and 15 cm long and |
| | weighs about 5 kg. |
| 112 | air filter |
| | This filter cleans the incoming air. In an embodiment, the air filter is about 10 × 10 × 20 cm |
| | and weighs about 1 kg. |
| | cooling |
| 113 | Fuel cell heat exchanger |
| | The fuel cell heat exchanger removes heat from the fuel cell stack using coolant. The |
| | coolant within the fuel-cell stack differs from the collant used in the rest of the system, so |
| | this heat exchanger is required to remove heat. In an embodiment, the fuel cell heat |
| | exchanger is about 60 × 40 × 3 cm and weighs about 5 kg. |
| 114 | fuel cell coolant pump |
| | This pump circulates coolant to the heat exchanger. In an embodiment, the fuel cell |
| | coolant pump is about 8 cm in diameter, 15 cm long, and weighs about 1 kg. |
| 115 | fuel cell coolant expansion tank |
| | In an embodiment, the fuel cell coolant expansion tank is about 15 × 15 × 10 cm and weighs |
| | about 0.5 kg. |
| | Electric motors |
| | Front permanent magnet motors |
| 116, 117 | Motor |
| | The front motors are preferably permanent magnet motors each with a peak power output |
| | of 21 kW peak (15 kW continuous) and a maximum torque of 88 Newton-meter (60 |
| | Newton-meter continuous). Each motor is about 165 mm in length, 200 mm in diameter, |
| | and weighs about 20 kg. |
| 118 | Inverter |
| | There is a single inverter for both front electric motors. In an embodiment, the inverter is |
| | about 380 × 350 × 118 mm and weighs about 13 kg. |
| 119 | Microcontroller |
| | In an embodiment, the microcontroller is about 245 × 161 × 40 mm and weighs about 0.53 kg. |
| | Rear |
| 120, 121 | Motor |
| | The rear motors are preferably switched reluctance motors with a peak power of 9 kW (˜6 |
| | kW continuous) each and a maximum torque of 26 Newton-meters peak (˜16 Newton- |
| | meters continuous). Switched reluctance motors are chosen because they freewheel with |
| | low inertia and no parasitic losses due to the motor's electromagnetic fields. In an |
| | embodiment, the motors are about 110 mm in length, 100 mm in diameter, and weigh |
| | about 8 kg. |
| 122 | Inverter |
| | There is a single inverter for both rear electric motors. In an embodiment, the inverter is |
| | about 165 × 350 × 118 mm and weighs about 5 kg. |
| 123 | microcontroller |
| | In an embodiment, the microcontroller is about 105 × 161 × 40 mm and weighs about 0.25 kg. |
| | cooling |
| 124 | motor heat exchanger |
| | In an embodiment, the motor heat exchanger about 40 × 40 × 3 cm and weighs about 3 kg. |
| 125 | motor coolant pump |
| | In an embodiment, the motor coolant pump is about 6 cm in diameter, 10 cm long, and |
| | weighs about 0.5 kg. |
| 126 | motor coolant expansion tank |
| | In an embodiment, the motor coolant expansion tank is about 20 × 10 × 10 cm and weighs |
| | about 0.5 kg. |
| | Reduction gears |
| 127, 128 | front |
| | In an embodiment, front gears 127 and 128 are constant mesh twin gears, weighing about |
| | 10.2 kg. |
| 129, 130 | rear |
| | In an embodiment, rear gears 129 and 130 are hub-mounted planetary gears, weighing |
| | about 3 kg. |
| 131 | dc/dc converter and switching controller |
| | 5.5 kW power output |
| 131A | 5.5 kW dc/dc converter |
| 131B | switch 1 (three position switch with a, off, and b positions) |
| 131C | switch 2 (three position switch with a, off, and b positions) |
| 131D | switch 3 (three position switch with a, off, and b positions) |
| 131E | junction 1 |
| 131F | output to switch 1 |
| 131G | output to switch 2 |
| 131H | output to switch 3 |
| 132 | Low power dc/dc converter |
| 133 | 42-volt battery |
| 134 | High-power diode |
| 135 | Capacitor |
| 136 | Coolant lines |
| 137 | High-voltage power cables |
| 138 | Heat exchanger at front of vehicle |
| 139 | 42-volt bus |
| 140 | Coolant pump |
| 141 | Electronic Control Unit controller for the cooling system |
| 142 | Radiator heat exchanger for the integrated cooling system |
| 143 | Junction for the cabin heating bypass loop |
| 144 | Cabin heater matrix |
| 145 | Hydrogen-powered heater |
| 146 | Control valve for the cabin heater, which controls flow through the cabin heating elements |
| 147 | Thermostatically controlled valve for the front motor coolant branch |
| 148 | Thermostatically controlled valve for the LLD |
| 149 | Thermostatically controlled valve for rear motor coolant branch |
| 150 | Thermostatically controlled valve for the fuel coolant branch |
| 151 | Coolant temperature sensor for the front motor coolant branch |
| 152 | Coolant temperature sensor for the LLD coolant branch |
| 153 | Coolant temperature sensor for the rear motor coolant branch |
| 153A | Coolant temperature sensor for the fuel cell |
| 153B | Coolant temperature sensor for radiator heat exchanger |
| 155 | Front motor coolant branch pipe |
| 156 | LLD coolant branch pipe |
| 156A | Radiator fan |
| 157 | Rear motor coolant branch pipe |
| 158 | Fuel cell coolant branch pipe |
| 159 | Upper coolant common rail pipe |
| 160 | Lower coolant common rail pipe |

System Design of Electronics and Software Architecture for Automobiles

This aspect of the present invention provides a software and electronics architecture for vehicles. The architecture is an all-digital information management and control architecture that is network-based and includes a central controller that interacts with modular control nodes, a user interface, and a fault-tolerant power supply and distribution system.

According to an embodiment of the present invention, the vehicle control system and information management architecture relies on distributed integrated control, which includes “intelligent” devices (nodes) that perform real time control of local hardware and communicate via multiplexed communications data links. Nodes are functionally grouped to communicate with a specific host controller and other devices on the host network(s). The host controller manages the objectives of devices linked to it.

Host controllers of different functional groups are mounted together in a modular racking system and communicate via a back plane. The back plane provides communication between the different functional controllers and the central controller. This, modular, three level architecture provides local autonomous real time control, data aggregation, centralized control of component objectives, and centralized diagnostics.

The central controller runs additional services and applications related to the operation of the vehicle and data communications. It also provides a seamless graphical user interface to all systems on the vehicle for operation and diagnostics.

According to an embodiment of the present invention, the user interface system includes an automotive man-machine interface that replaces the wheel and pedals of conventional automobiles with control-stick-based steering, acceleration, and braking. The user interface can also incorporate a jog-wheel interface for navigating, changing, and selecting vehicle features and services. In addition, the user interface can include a multi-functional flat-panel display screen for displaying information for the driver. These features improve occupant safety, environmental friendliness, ergonomics, and compatibility to modify, add, or upgrade vehicle features.

According to an embodiment of the present invention, the fault-tolerant power supply and distribution system is a ring-main power supply. The ring main power supply system provides fault tolerant power to all components via a ring main power bus. Nodes are connected to the ring main at one of several junction boxes distributed throughout the vehicle. Components are connected to the ring by either a sub-ring (when supplying fault-tolerant devices) or a simple branch line for non-fault tolerant nodes. The junction boxes within the ring main system are fused so that power is supplied to the branches from either leg of the ring main and so that power passes freely across the junction box during normal operation.

Continuing from the summary above, the following three important aspects of the software and electronics architecture of the present invention are discussed below under corresponding subheading: 1) ring main power supply; 2) control system and information management architecture; and 3) user interface.

Ring Main Power Supply:

The ring main power supply is designed to supply power to all non-traction power systems within the vehicle in a fault-tolerant way. As illustrated in FIG. D1, this system comprises a power bus that forms a ring 200 around the vehicle, several junction boxes 201, 284, 285, 286, 287, and 288, and branches 202 connecting components to ring 200 at junction components.

Ring main 200 is the non-traction power bus in the vehicle that delivers power to several dual-fused junction boxes that then distribute power to the vehicle's components. Dual-fused junction boxes 201, 284, 285, 286, 287, and 288 serve as the points on ring main bus 200 at which vehicle components are connected. Branch wiring 202 connects vehicle components to dual-fused junction boxes 201, 284, 285, 286, 287, and 288.

For clarity, FIG. D1 uses the following abbreviations: horn (ET); washer (WSR); wiper (WPR); steering motors (M1 and M2); traction motors (TM1 and TM2); battery (BATT); left front wheel (LF); heating, ventilation, and air conditioning unit (HVAC); infra-red camera (IR); rain and thermal loading sensor (IT); control stick (CS); airbag controller (SRS ECU); trunk lock mechanism (Boot CDL); and hub motor (HM).

As shown in FIG. D1, lights 203, 218, 234, and 240 connect to dual-fused junction box 286, 287, 201, and 284, respectively. Lights 203, 218, 234, and 240 are light modules that contain headlights (in the case of lights 203 and 218), parking lights, turn signals, tail lights (in the case of light 234 and 240), and brake lights (in the case of lights 234 and 240). Lights 204 and 217 are fog lights and connect to dual-fused junction boxes 286 and 287, respectively.

Radar 205, 216, 235, and 238 are front and rear radar sensors, which connect to dual-fused junction boxes 286, 287, 201, and 284, respectively. Radiator fan 206 and horn 207 connect to junction boxes 286 and 287, respectively.

Coolant pumps 209 and 249 connect to junction boxes 286 and 284, respectively.

Battery 212 powers non-traction electrical devices, and is preferably a 42-volt battery. Converter 213 is a dc/dc converter that charges battery 212 from the powertrain power bus. Converter 213 replaces the function of an alternator in conventional vehicles.

Converter 214 is a high-voltage (e.g., 5.5 kW and 300 volts) dc/dc converter used to manage power in the powertrain system. Converter 214 is connected to junction box 287.

Steering motors 210 and 215 are electric motors that turn the front wheels.

Wiper motors 208, 239, and 280 connect to junction boxes 287, 284, and 286, respectively.

Air compressor 211 connects to junction box 210.

Electrically actuated brakes 220, 230, 243, and 289 connect to junction boxes 287, 201, 284, and 286, respectively. Likewise, suspension shock/spring systems 221, 233, 244, and 279 connect to junction boxes 287, 201, 284, and 286, respectively.

Front traction motors 281 and 283 are permanent magnet motors that power the front wheels 278 and 219, respectively, and are connected to junction boxes 286 and 287, respectively. The electrical connection shown powers the electronics within the motor and controller.

High voltage battery management 282 is the electronics that manage power from the load-leveling batteries in the powertrain system. High voltage battery management 282 is connected to junction box 286.

Interior light controller module 250, control sticks 251 and 252, microphone 263, air bags 264, windscreen heater element 266, and driver display 265 are connected to junction box 285. Control sticks 251 and 252 control the vehicle. Microphone 263 is a driver microphone for hands-free operation of information, communication, and entertainment systems within the vehicle. Driver display 265 is a flat-panel monitor that displays driver information.

Service lock 268 is a lock for a compartment containing vehicle controller cards. User lock 269 is a lock for a compartment that contains expansion bays for the vehicle electronics system. Controller card slots 270, 271, 272, 273, 274, 275, 276, and 277 are slots adapted to receive vehicle controller cards and other electronics.

Heating, ventilation, and air conditioning system 267, infrared camera 290, rain and thermal loading sensor module 291, air bag controller 253, and a second display/PDA power connection 254 are connected to junction box 288.

Door modules 222 and 223 are connected to junction box 288. Door modules 255 and 259 are connected to junction box 285. Each of the door modules contains various electrical components, including door module controllers 226, 227, 258, and 262, window lift switches 224, 228, and 257, window lift motors 225, 229, 256, and 260, and door locks 292, 293, 294, 295. Door module controller 259 also includes four window lift switches 261 that enable the driver to control all operable windows.

Seat belt pretensioners 246 and 247, fuel-cell blower 245, and fuel cell controller 248 connect to junction box 284.

Rear hub motors 232 and 242 are preferably switched reluctance motors. The electrical connection shown powers the electronics within the motor and controller.

Rear hatchback door lock 236 and rear window defroster 237 connect to junction box 201.

Although the system voltage of FIG. D1 is shown as 42V, the overall design of the ring-main power distribution architecture could be used with any operating voltage. There could also be more or fewer junction boxes than are depicted in FIG. D1 depending on the specific vehicle for which the system is used. Ring main 200 is preferably sized to deliver the maximum power required by all non-traction electrical loads. Devices requiring fault-tolerant power are connected to the junction boxes with a sub-ring to ensure power redundancy from the source to the component. The junction boxes within the ring main system are fused so that power can be supplied to the branches from either leg of the ring main and so that power passes freely across the junction box during normal operation (see FIG. D2 below). The ring main is powered by two power supplies: a battery 212 and a dc/dc converter 213 that draws power from the powertrain. The dc/dc converter 213 performs the function of an alternator in conventional cars.

To illustrate how the ring-main power supply would work, consider the situation in which one segment of the ring main between two junction boxes becomes shorted. This fault would be sensed by the junction boxes on either end of the segment and the fault would be isolated by activating the appropriate resettable fuses within the junction boxes so that the power for the components attached to these junction boxes would come from the other side of the ring. When a fault occurs, the junction box would send a fault code to the vehicle's central controller, which would in turn warn the driver of the fault and instruct the driver to safely stop the car and contact a technician.

FIG. D2 illustrates schematically the design of an exemplary dual-fused junction box 304, according to an embodiment of the present invention. Junction box 304 is connected in line with ring main 200 to two positive terminals 305 and 306 and two negative terminals 307 and 308. Within junction box 304, there are four “smart” fuses, two fuses 300 and 301 connected in series to the positive side (terminals 306 and 305, respectively) of ring main 200 and two fuses 302 and 303 connected in series to the negative side (terminals 308 and 307, respectively) of ring main 200. A variety of technologies could be used for smart fuses 300, 301, 302, and 303, including electronically resettable mechanical fuses, smart FET solid-state fuses, resettable polymer switches, or other fusing devices. A positive terminal 309 and negative terminal 310 for the branch lines 202 are connected between fuses 311 and 312 of junction box 304. Fuse 311 is disposed between fuses 300 and 301. Fuse 312 is disposed between fuses 302 and 303.

Thus, the ring main power supply of the present invention is designed to supply power to all non-traction power systems within the vehicle in a fault-tolerant way. As illustrated in FIG. D1, this system comprises a power bus that forms a ring around the vehicle, several junction boxes, and branches connecting components to the ring at junction components. This bus is sized to deliver the maximum power required by all non-traction electrical loads in the vehicle via a series of junction boxes to which branch lines to the devices are connected. Devices requiring fault-tolerant power are connected to the junction boxes with a sub-ring, to ensure power redundancy from the source to the component.

The ring main power supply of the present invention offers several benefits. For example, the ring main power supply provides fault-tolerance. The failure of any one power source, node, or transmission cable (i) does not result in a loss of power within the vehicle and (ii) can be readily diagnosed so that the driver can be quickly notified of a system fault. In terms of cost, because power is supplied-throughout the vehicle using a bus architecture, there is less duplicative wiring. In terms of fuel economy, the ring main power supply, depending on its configuration, has the potential to weigh less than conventional wiring harnesses used in automobiles. In terms of modularity, new devices requiring fault tolerance can be plugged into the system without extensive rewiring. As a final example, in terms of diagnosability, the intelligent nodes within the ring main can relay information regarding the performance of the system, including faults, to the user interface and to other systems within the vehicle.

Control System and Information Management Architecture:

As shown in FIGS. D3-D10 below, the control system and information management architecture of the present invention includes: 1) a central controller; 2) a body controller; 3) a vehicle dynamics controller; 4) a telematics controller; 5) several task-specific multiplexed networks; 6) a high-speed backbone that connects the main functional controllers (i.e., items 1-4); and 7) several component controllers distributed throughout the car and mostly co-located and integrated with the components that they are controlling.

FIG. D3 is an electrical schematic that illustrates exemplary connections 313 between the vehicle safety systems of the power distribution network of FIG. D1, according to an embodiment of the present invention. As shown, connections 313 provide a vehicle safety system that includes seat belt pretensioners 246 and 247, electronic control unit 253, and air bags 264.

FIG. D4 is an electrical schematic showing exemplary hard-wired inputs 314 to slot 270 of the central controller of FIG. D1, according to an embodiment of the present invention. Other components could be added or some components could be removed, as necessary. As shown, hard-wired inputs 314 to slot 270 connect microphone 263, front radar sensors 205 and 216, and rear radar sensors 235 and 238.

FIG. D5 is an electrical schematic showing body controller wiring 315 to slot 271 of the central controller of FIG. D1, according to an embodiment of the present invention. As shown, wiring 315 connects the following body controller controls: lights 203, 218, 240, and 234; coolant pumps 209 and 249; radiator fan 206; air compressor 211 for the suspension system; 42-volt dc/dc converter 213; windshield wiper motors 280, 208, and 239; front and rear windscreen defrosters 266 and 237; door modules 259, 222, 223, and 255; rear hatch lock 236; heating and cooling system 267; infrared camera 290; and a rain and thermal loading module 291.

FIG. D6 is an electrical schematic showing exemplary controller area network (CAN) wiring 316, according to an embodiment of the present invention. CAN wiring 316 connects to the vehicle dynamics controller card slot 272 of the central controller of FIG. D1. As shown, CAN wiring 316 connects the following vehicle dynamics components to slot 272: electric traction motors 281, 283, 232, and 242; suspension 221, 233, 244, and 274; and the 5.5 kW powertrain dc/dc converter 214. Although a CAN network is specified in this exemplary design, one of ordinary skill in the art would appreciate that other network protocols could be used.

FIG. D7 is an electrical schematic showing exemplary fault tolerant network wiring 317, according to an embodiment of the present invention. Fault tolerant wiring 317 connects to the vehicle dynamics controller card slot 272 of the central controller of FIG. D1. As shown, fault tolerant wiring 317 connects the following vehicle dynamics components to slot 272: control sticks 251 and 252; airbag electronic control unit 253, brakes 220, 230, 243, and 289; and steering motors 210 and 215.

FIG. D8 is an electrical schematic showing exemplary telematics control wiring 318, according to an embodiment of the present invention. Telematics control wiring 318 connects to the telematics controller card slot 273 of the central controller of FIG. D1. As shown, telematics control wiring connects antennae 318A to slot 273. Antennae 318A are preferably printed in the rear and side windows of the vehicle.

FIG. D9 is an electrical schematic showing exemplary audio amplifier wiring 319, according to an embodiment of the present invention. Audio amplifier wiring 319 connects to the audio amplifier located in slot 274 of the central controller of FIG. D1. As shown, audio amplifier wiring 319 connects the following audio components to slot 274: left front speaker 319A, center mix speaker 319B, right front speaker 319C, bass unit 319D, left rear speaker 319E, and right rear speaker 319F.

FIG. D10 is an electrical schematic that depicts an overall controller and network architecture, according to an embodiment of the present invention. The controllers shown in FIG. D10 are located in separate slots of a controller console 320 within the vehicle (corresponding to slots 270-277 in FIG. D1). The controllers are connected to each other via a high-speed data backbone 327. The body controller 321 controls body components via a low-speed CAN network (or similar network) 324. The components to which body controller 321 is connected are shown in FIG. D5. The vehicle dynamics controller 323 controls powertrain, steering, suspension, and braking. The vehicle dynamics components connected to controller 323 through a high-speed CAN network 325 are shown in FIG. D6. The vehicle dynamics components connected to controller 323 through a time-triggered protocol (TTP/C) network 326 are shown in FIG. D7. Expansion cards can also be added until all controller console slots are filled.

As shown in FIGS. D3-D10, the control system and information management architecture of the present invention includes: 1) a central controller; 2) a body controller; 3) a vehicle dynamics controller; 4) a telematics controller; 5) several task-specific multiplexed networks; 6) a high-speed backbone that connects the main functional controllers (i.e., items 1-4); and 7) several component controllers distributed throughout the car and mostly co-located and integrated with the components that they are controlling.

According to an embodiment of the present invention, the central controller controls the user display, performs vehicle-level diagnostics, manages vehicle data storage (both on-board and off-board through the telematics controller), and has the capability to run add-on applets.

According to an embodiment of the present invention, the body controller is a relatively simple controller that sends control signals to all of the body electrical components (interior and exterior lighting, door locks, window lifts, windshield wipers, etc.) and performs simple diagnostics to ensure that the various components are operating properly.

According to an embodiment of the present invention, the vehicle dynamics controller manages, at the top-level, all vehicle dynamics and powertrain functions, including braking, acceleration, steering, and suspension behavior. The vehicle dynamics controller communicates with braking and steering components using a TTP/C (or similar) fault tolerant network, and has greater real-time control requirements than other controllers.

According to an embodiment of the present invention, the telematics controller manages all communication with the outside world. Telematics controller could include, for example, a GPS and one or more wireless communications devices (e.g., mobile telephone or wireless Ethernet) as needed. This telematics controller receives requests for off-board data from other controllers and receives this work using the most appropriate method given the vehicle's position.

According to an embodiment of the present invention, the task-specific multiplexed networks include a low-speed controller area network (CAN) for the body controller to communicate with the devices under its control, a high-speed CAN for the vehicle dynamics controller to ensure that the propulsion commands are received in a timely fashion, and a fault tolerant TTP/C network for communicating with the steering and braking functions.

According to an embodiment of the present invention, the high-speed backbone connects the main controllers (i.e., central controller, the body controller, the vehicle dynamics controller, and the telematics controller) in a data bus similar in concept to the PCI bus used in personal computers. This configuration allows the main controllers to communicate and share data quickly and efficiently. It also allows the controllers to be upgraded more easily since they would be located together and they would communicate between each other using a standard interface.

According to an embodiment of the present invention, several component controllers are included in the control system and information management architecture. The main controllers described above communicate with these component controllers via the various on-board networks to execute the tasks assigned to them by the central controllers and are integrated with the components that they are controlling.

To illustrate how information and control are managed within the vehicle, consider the instance of controlling the rear corner light module. The rear corner light module includes the reverse light, tail light, turn signal, brake light, and (in one of the two modules) license plate light. The rear corner light module is controlled by the body controller via a low-speed CAN (Controller Area Network) bus. The body controller receives control inputs from various other controllers and components connected to it via the CAN bus (e.g., braking signal from the vehicle dynamics controller, turn signal from switch modules connected to the low-speed CAN network, and running-light control from either the central controller or a low-speed CAN switch module).

When braking is initiated, the vehicle dynamics controller sends a signal across the high-speed data bus to the body controller, which in turn instructs the rear light modules to illuminate the brake lights. At the end of the braking event, the vehicle dynamics controller notifies the body controller of the change in state, which then relays the command to turn off the brake lights to the rear corner light modules. If any fault occurs (e.g., if the light modules detect a failure or if the body controller loses contact with the light module), then the body controller announces the fault to the central controller via the high-speed backbone.

Upon receipt of a fault-notice, the central controller would log the fault and, if appropriate, illuminate a warning light on the driver display. In addition, if any alternative control algorithms were available, the central controller would initiate them. For instance, if the turn signal malfunctions, the central controller could have the brake, reverse, and/or running lights blink when the turn indicator is activated. The central controller could also carry out more diagnostics to isolate the fault, such as monitoring electrical power consumption during braking or checking control signals, to determine whether the fault is a communication, power supply, or component failure.

According to an embodiment of the control system and information management architecture, different components on the vehicle collect data continuously during operation. This data can be combined to create knowledge about the car's behavior and about its environment. Combining data from different sources on the vehicle can create new functionality. This capability relies on the use of open architectures and structured, hierarchical controls.

The use of multiplexing reduces wiring and provides greater flexibility. By using a data network on board, the amount and complexity of wiring is greatly reduced. It also allows flexible, high-speed communication between devices located throughout the vehicle, which provides greater capability with less wiring than in conventional cars. For instance, typical vehicles have twenty-five wires on the through-panel connector to a door. An embodiment of the present invention reduces the number of wires to four.

Further, using network communications makes it far easier to make changes, upgrade, and tailor a vehicle to different customer requirements. This is because functionality is not tied to specific wires or control module input/output (“I/O”). Thus, the majority of changes can be made without redesigning specific controllers, interfaces, or harnessing.

With data being shared between different systems, one device can also perform a number of functions in the vehicle. For instance, a charge-coupled-device-type video camera with infrared capability could be used for driver recognition, videophone link, smart air bag control, and driver attention measurement.

Similarly, sharing knowledge between different systems on the vehicle makes it possible to reduce sensing requirements. For instance, it would be possible to interpret elevation from GPS data. This means that there may be no need for a barometric sensor on the vehicle propulsion system control.

The control system and information management architecture of the present invention also provides a desired fault tolerance. Certain aspects of the electrical system are critical to safe operation of the vehicle and thus functional failure cannot be tolerated. Time Triggered Protocol (“TTP/C”) is adapted to communications between safety critical sub-system components. Practically, the protocol employs data time slotting to ensure deterministic latency periods, has redundant data connections, and message-level error control to protect from data stream failure. Additional protection from failure can be achieved by incorporating redundancy within the system design. For example, twin motors can be used to control the steering system. As another example, the 42-V battery and the dc/dc converter can be used to supply electrical power to the low voltage power bus.

The control system and information management architecture of the present invention also provides desired diagnostics and fault management. Similar to the function of electronics systems in typical vehicles, all components of the electrical system of the present invention continually check for correct operation and communications to ensure proper electrical system performance. Any detected malfunctions are interpreted by the central controller and communicated to the user. Preferably, the system is further designed so that the appropriate fault mitigation strategy is implemented at the component and/or system level to ensure a safe system response to the failure. This strategy only detects electrical failures but similar, observer-based logic can be used to check performance of physical items such as steering motors. For example, an under-inflated tire can be detected by the central controller by comparing the four wheel-speed signals. When such a fault is detected, the central controller can warn the driver of the low tire pressure and adapt the vehicle dynamics to best cope with the fault condition.

The control system and information management architecture of the present invention also provides desired prognostics. The performance of many items on the powertrain degrades with use. The life expectancy can be derived statistically in many cases or otherwise observed from changes in performance over time. By tracking the loads that a component has been subjected to during its life and by tracking changes in performance, it will be possible to calculate the life remaining in each high-value component. With this data, it will be possible to schedule component exchange prior to failure, which should reduce running costs by minimizing scheduled and unscheduled maintenance.

Further, components such as motors can be more readily re-manufactured if the unit has not suffered total failure. Thus, there is more value in the used motor that has not failed.

It is also possible to make a data-based valuation of the vehicle by interrogating the condition of the tracked components. This would be useful in maintaining second hand value or recovering useful value from a vehicle at the time of disposal.

With prognostics data, maintenance activities and costs can also be planned.

Statistical data on use and wear rate can also be recorded for an entire fleet of vehicles over time to enable redesign for improved component life.

The control system and information management architecture of the present invention also facilitates desired new services. Indeed, data communication between different systems on the vehicle and the outside world can enable new services and features.

For example, an embodiment of the present invention provides a smart fuel gauge. The navigation system (which includes, for example, map data, a GPS, a database of filling station locations and opening hours, and trip routing system) is integrated with the fuel level monitor and the fuel consumption tracking system to provide a fuel gauge that indicates the driver's risk of running out of fuel, not just fuel level. For example, if car has 150 miles of remaining range but there are no filling stations along the vehicle's route, the gauge will give a warning showing where the nearest filling stations are and provide directions with how to get there.

Data based insurance is another example of a new service facilitated by the present invention. The cost of cover can be based on actual driving behavior. For instance, the insurance rate could be charged by the number of miles driven and when those occurred and/or driving style.

Traffic data collection is another example of a new service facilitated by the present invention. Location, speed, and traffic density data can be collected and transmitted off board to a central data repository. This data can be used to provide real-time traffic flow and historical data to be used in navigation and traffic management systems.

The present invention can also facilitate crash emergency calls. Upon detecting a crash, the system notifies the emergency services of the incident automatically. This call can include information such as crash speed, deceleration force, and number of occupants.

Contract re-fuelling is another example of a new service facilitated by the present invention. The vehicle could transmit its fuel level and location to a refueling contractor that would use this data to schedule deliveries on a local fuelling service.

Remote monitoring and control is another example of a new service facilitated by the present invention. Being connected to the Internet, it would also be possible for the driver to check system status remotely and to perform certain operations off-board such as vehicle cool down or warm up.

The present invention also facilitates new aspects of fleet control. Fleet logistics can be optimized and directed remotely according to changing requirements.

The present invention also facilitates remote diagnostics. The vehicle continuously monitors itself for irregular operation on the vehicle. Any such irregularities can be diagnosed from a remote service center.

The present invention also facilitates voice-activated “emergency” keyless entry. The vehicle can wait to hear a unique (pre-programmed) password to get into the vehicle without a key in an emergency. The system would be activated to listen for the password (or perhaps for a voiceprint of the vehicle's owner) by the individual seeking entry by, for example, lifting on the door handle. The microphone inside of the car would listen for the appropriate password and unlock the door if it is spoken. The driver could then reset the password after entering the vehicle.

Notably, the software and electronics architecture of the present invention is capable of supporting all of these features without requiring added hardware. Further, the total integration of all of the components makes these services, and others not yet considered, more valuable to the user, more capable, and easier to implement.

The control system and information management architecture of the present invention also facilitates several security features. In one embodiment, the vehicle has voice recognition and an optional camera. These devices can be used for driver recognition. The two biometrics: voice print and face print, provide a high level of security against theft. Positive driver identification can be particularly useful to fleet operators.

In another embodiment, drivesystem components are tracked by a unique serial number that is used for life prediction. This has the additional benefit of making these devices traceable and thus very difficult to re-use after theft. This same capability can be used to protect after-market operations.

In another embodiment, when a crash has been detected, the systems on the vehicle can record data such as driver attention, vehicle speed, position, driver inputs, vehicle system status, and global time. This data is sampled continuously at high speed and recorded only upon detection of an incident. The data is preferably center-triggered to give pre and post-crash data.

Another embodiment provides longer-term monitoring and recording of characteristic driving events, such as number emergency stops, speeding, and number of near miss situations.

The control system and information management architecture of the present invention also facilitates advanced control. The data rich architecture and centralized processing power enables advanced control methods to be used such as model-based control, adaptive control, and observer-based diagnostic systems.

One example of this advanced control is the optimized dynamic control of the drive train. In this embodiment, the vehicle tracks steering angles, vehicle yaw, vehicle speed, surface smoothness (from changes in pressure in the suspension rams), corner weights (from average pressure in suspension rams), cornering angle from instantaneous suspension position (ram air pressure), cornering forces (from body controller) and possibly weather conditions from the rain sensor. All of this data can be used to best control the torque at each wheel and thus optimize dynamic control of the vehicle under all conditions. This system provides the opportunity to have such sophisticated control without additional hardware costs. Further, the vehicle's fully electric brakes and traction motor control allows far greater response and resolution of control in comparison to conventional power train systems.

The control system and information management architecture of the present invention also provides a desired upgradability and expandability. The choice of relevant open architectures and the modular design philosophy make it possible to upgrade the vehicle during the course of its life with new hardware and software to change its capability to suit the needs of the user.

User Interface:

According to an embodiment of the present invention, the user interface includes a flat-panel display screen mounted at the base of the windshield centered on the driver's line of sight, a control pad that includes four buttons and a multifunctional jog-wheel, and a side-stick control. The upper half of the flat-panel screen displays all legally mandated driver information (such as vehicle speed, lane change indication, warning lights, and fuel level) as well as climate control and entertainment system status (such as fan speed and radio settings) and a message center for putting up additional information such as navigation information or directions to filling stations. The lower half of the screen is a multipurpose area used for making setting changes to any of the vehicle systems (including, for example, radio, navigation, and climate control) and is activated by either voice commands or using the buttons and jog wheel on the control pad.

FIG. D11 illustrates an exemplary user interface according to an embodiment of the present invention. In particular, FIG. D11 shows preferred positions of the main user interface controls in the vehicle. As shown, control sticks 251 and 252 (also referred to as side sticks) are located on adjustable armrests to either side of the driver. An information console and display screen 265 is located at the base of the windshield centered on the drivers line of sight. A control pad 328 is disposed in the center console between the driver's and passenger's seat, which is used to control services offered by the vehicle (such as entertainment, information, or driver settings).

FIG. D12 is a schematic diagram of an exemplary driver's display screen, according to an embodiment of the present invention. The bottom half 337 of the screen is a multi-functional control panel area where vehicle services (such as entertainment, climate control, or navigation services) can be set. A divider 341 separates the multi-functional control panel 337 from the instrument panel. Dedicated space for warning lights could be placed in this divider area. The left side of the instrument panel contains a message center 329 that shows the vehicle's direction 339, an odometer 338, and driver messages in the main portion of the message center.

In this exemplary screen, a smart fuel gauge 330 is also included. The smart fuel gauge assesses the driver's risk of running out of fuel by tracking fuel level, rate of fuel consumption, time of day, proximity to fueling stations, intended destination, and other relevant factors to provide a more complete assessment of risk associated with running out of fuel. This function is made possible by the underlying electronics architecture that allows for navigation, vehicle, and external data to be integrated into a single feature. The illustration in FIG. D12 shows a conceptual map 330 of the nearest three filling stations relative to the vehicle.

In the middle of the instrument panel area is a speed indicator 340, a gear indicator 331, a fuel level indicator 332, a fuel economy display 335, and a gauge 336 that shows the instantaneous power used by the system and the total power available. On the right side of the instrument panel, a climate control status 333 and an entertainment status 334 are displayed.

FIG. D13 is a schematic diagram of an exemplary entertainment display screen 342 according to an embodiment of the present invention. Entertainment display screen 342 could be used, for example, to select a media source (e.g., MP3, radio, or CD), adjust audio settings (e.g., amp or amplifier), or control the media sources by picking songs or changing the radio station. Screen 342 uses the multi-function display panel area 337 (FIG. D12) to make these settings.

FIG. D14 is a schematic diagram of an exemplary navigation display screen 343 according to an embodiment of the present invention. In this example, navigation control panel 343 provides turn-by-turn directions in the instrument panel area 344 (corresponding to message center 329 of FIG. D12).

FIG. D15 is a schematic diagram of an exemplary climate control display screen 345 according to an embodiment of the present invention. In this example, climate control display screen 345 display settings for fan speed, temperature, vent location, recirculation, and defrost. Any changes in the control panel are reflected in the climate area of the instrument panel 333 (see FIG. D12).

FIG. D16 is a schematic diagram of an exemplary ride setting display screen 346 according to an embodiment of the present invention. In this example, ride setting display screen 346 displays suspension settings. The driver can select between automatic operation, high, low, or normal suspension ride height, and the ride character (economy, comfort, or sport).

FIG. D17 is a schematic diagram of an exemplary guide display screen 347 according to an embodiment of the present invention. In this example, guide display screen 347 illustrates a sample page of an online user's guide that explains various methods of input. Any information typically found in a car's user manual could be accessed via this guide display screen 347.

FIG. D18 is a schematic diagram of an exemplary identity setting display screen 348 according to an embodiment of the present invention. Through this screen 348, a user can set the car's look and feel and the driver's identity. This exemplary screen 348 includes a voice print ID for security, the ability to change different display and sound themes, and to register with insurance providers for new knowledge-based insurance systems.

FIG. D19 is a schematic diagram of an exemplary diagnostics setting display screen 349 according to an embodiment of the present invention. One general concern in having more integrated diagnostics and communication with off-board sources is the loss of privacy. People become concerned that personal information is being used without their knowledge. To address this concern while still offering useful diagnostic capability, the present invention puts the collection of data and the recipients of the data known under the control of the driver. The rules list 350 of diagnostics setting display screen 349 contains suites of diagnostics that are being performed and lets the user choose which data is collected and how frequently. The hosts list 351 of diagnostics setting display screen 349 lists the recipients of the data and allows the user to choose what data the hosts receive and whether the data is received anonymously or not.

FIG. D20 is a schematic diagram of an exemplary intervention settings display screen 353 according to an embodiment of the present invention. The intervention system in the vehicle improves safety by limiting driver distractions based on the context of driving. For instance, during hard braking or acceleration, turning, or other driving circumstances in which the driver's attention should be focused on the task of driving, the vehicle's intervention system would hold incoming phone calls, any non-time-critical warning messages, and, at times, even mute any audio. The intervention monitor would also be able to manage how incoming information is presented to the user and determine what to do in the case of an accident. Intervention settings display screen 353 displays the notification options in area 355. The amount of intervention carried out would also be user-settable. In this example, a simple slider bar 354 determines the level of intervention.

FIG. D21 is a schematic diagram of an exemplary plug-ins setting control panel 355 according to an embodiment of the present invention. Additional software modules could be added by the user to add features to the car. Some potential features include: more advanced system diagnostics (e.g., “Hypercar System Monitor”); a filling station locator; real-time insurance that bills according to how, when, and where the driver is driving; a mobile weather station that tracks the vehicle's position and environmental data such as temperature, humidity, whether the wipers are activated (i.e., whether it is raining), and other environmental variables that would be sent anonymously to a central weather monitoring company; a mobile traffic node that would send position and speed information to a central traffic monitoring service; and automatic upgrade notification. Other new services could also be added to this list.

FIG. D22 is a schematic diagram of an exemplary energy settings control panel 357A according to an embodiment of the present invention. Energy settings control panel 357A allows the user to set the powertrain control strategy between economy and sport modes using a slider bar 357B. Panel 357A also allows the user to adjust the smart fuel gauge settings 357C between how much advance warning the gauge gives the driver before the vehicle could either run out of fuel or get out of range of a filling station.

FIG. D23 is a schematic diagram of an exemplary side stick 358 and control pad 370, according to an embodiment of the present invention. Side stick 358 and control pad 370 are the main physical interfaces for user input to the vehicle. Side stick 358 (also referred to as a control stick) is used to steer the vehicle and control its acceleration and raking (see FIG. D24 below). Control pad 370 in the vehicle's center console contains four selection buttons 359 and a jog-wheel menu selection device 360 that rolls forward and back and presses down to make a selection. The selection buttons allow the user to see the navigation, climate control, entertainment, and settings control panels that can then be navigated using the jog-wheel, and as shown in FIGS. D12-D22 above.

FIG. D24 is a schematic diagram illustrating an exemplary method for actuation of side stick 358. As shown, side stick 358 actuates left 372 and right 374 to steer the vehicle. Side stick 358 also has pressure sensors 376 and 378 that measure forward and back pressure, respectively, on the stick, and adjust the vehicle speed accordingly. The exemplary method of FIG. D24 shows braking in response to forward pressure on the stick and acceleration if the stick is pulled back. This configuration could, of course, be reversed depending on the market requirements and other considerations.

As shown in FIG. D23, an exemplary control pad 370 contains four selection buttons 359. In an embodiment of the present invention, selection buttons 359 are allocated to climate, navigation, entertainment, and settings. Pushing any of these buttons toggles the settings screen for that area in the lower half 337 of the flat panel display (see FIG. D12). When the settings screen is activated, the jog-wheel is used to navigate through the settings and is pressed to make selections. FIG. D25 lists the first two levels of an illustrative hierarchical feature list and a menu list for an illustrative jog-wheel control.

As shown, the entertainment button includes four menus (radio, CD, MP3, and amplifier settings), each with corresponding submenus. In an embodiment of the present invention, when the entertainment button is pressed, the active music source is automatically activated. For example, if the driver is listening to an MP3, then the MP3 menu is highlighted when the entertainment button is pressed.

As shown, the climate button includes six menus (fan speed, temperature, position, recirculation, heated windshield, and heated rear screen), with one submenu (for the position menu, including head, body, feet).

The navigation button includes five menus (destination, store, ETA, trip, and settings). The destination menu has a submenu (new, stored, home, and fuel station). The trip menu has a submenu (mpg, range, trip reset, and average speed). The settings menu has a submenu (direct/scenic, miles/kilometers, and volume).

The settings button includes seven menus (ride, guide (online manual), identity, diagnostics, intervention, plug-ins, and energy), with corresponding submenus as shown.

To illustrate the operation of the user interface, consider the scenario of the driver wanting to lower the temperature in the car using the jog wheel and screen interface. Under normal operation, the lower half of the display screen would be blank (as shown in FIG. D12). To decrease the temperature, the driver would follow the process shown in FIG. D26 and described below.

In step DX1, the driver presses the climate button, which causes the climate settings screen to appear on the lower half of the screen. In step DX2, the driver rotates the jog wheel one notch forward, which highlights the temperature adjustment bar from the list of other climate control settings. In step DX3, the driver presses the jog wheel, which selects the temperature adjustment bar. In step DX4, the driver rotates the jog wheel back, which raises and lowers the climate control temperature. In step DX5a, if the driver does nothing else, the temperature setting is recorded and after a short time the climate setting screen is turned off automatically. The process is then complete.

Steps DX5b and DX5c are alternatives to step DX5a in which the driver elects to do something after step DX4. In step DX5b, if the driver presses the climate button, the climate setting screen disappears immediately with the new setting recorded. In step DX5c, if the driver presses the jog wheel, the temperature adjustment bar is deselected (with the temperature change recorded) so that the driver can select another climate control setting to adjust (e.g., fan speed).

According to an embodiment of this aspect of the present invention, two side sticks are provided for steering, braking, and acceleration, but only one is functional at any one time. Moving either side stick to the left or right steers the vehicle left or right. Pressing the stick forward and back brakes and accelerates the vehicle. The stick does not actuate forward and backward, but rather senses forward and backward pressure and adjusts braking and acceleration based on applied pressure (as shown in FIG. D24).

The exemplary user interface of the present invention offers several benefits relating to the side stick steering, braking, and acceleration. These benefits relate to safety, fuel economy, and cost.

In terms of safety, centralizing control of steering, braking, and acceleration into one control stick allows for simpler execution of complex driving maneuvers such as those required during emergency collision-avoidance maneuvers. Studies have shown that the average driver is not particularly well eye-hand-foot coordinated, which is required during emergency driving using a steering wheel and pedals.

In addition, the steering column and pedals are the leading sources of injury in accidents. Using a side stick removes these systems from the vehicle.

Since pedals do not have to be reached, there is no fore-aft adjustment of the seats. Therefore, very small drivers remain a safe distance from the driver's airbag.

Overall, crash safety is also improved due to the additional time allowed to decelerate the driver.

In terms of fuel economy, mass savings attributable to the side stick system result from removing the fore-aft seat adjustment and removal of the cross-car beam that is typically used to support the steering column.

In terms of cost, there is less development cost associated with the airbag system because the driver's airbag is the same specification as the passenger's airbag. In addition, converting the vehicle between right- and left-hand drive is simpler because there is no steering column.

The jog-wheel-based accessory controls of the exemplary user interface of the present invention also provide benefits. These benefits relate to ease-of-use, safety, cost, and flexibility. In terms of ease-of-use, the jog-wheel-based accessory controls represent an intuitive input device that many people are familiar with because its wide use in personal computing and cell phones. In terms of safety, the jog-wheel-based accessory controls allow a driver to search for a desired button among a panel of buttons without taking her eyes off the road. The jog-wheel also has the potential to be lower cost than a panel full of switches. In terms of flexibility, any new service or feature added to the vehicle can use the jog wheel as its input device, thus simplifying the addition of features or services.

As described above, important aspects of this embodiment of the present invention include: fault-tolerant ring-main-based power distribution network; jog-wheel-based control of vehicle accessories (radio, navigation, climate control, etc.) and other services; smart fuel gauge; tracking and off-board storage of vehicle and component use information in order to assess amount of life left in components and to carry out other data services such as cross-cutting diagnostics for an entire fleet of vehicles; design of the graphical user interface; use of integrated data management to provide enhanced reliability, function, and multiple redundancy modes; and tailorability and upgradability.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An automobile vehicle structure comprising:
a safety cell made of an advanced composite;
a subframe disposed forward of the safety cell and attached to the safety cell; and
a front crush structure disposed forward of the subframe and attached to the subframe and the safety cell.

2. The automobile structure of claim 1, wherein the subframe is made of aluminum.

3. The automobile structure of claim 1, wherein the front crush structure includes an A-pillar upper member that spans the subframe and attaches the front crush structure to the safety cell.

4. The automobile structure of claim 1, wherein the front crush structure is made of an advanced composite.

5. The automobile structure of claim 1, wherein the advanced composite is a highly aligned reinforcement of one of carbon, glass, and aramid fibers in a suitable polymer matrix of one of thermoset resins and thermoplastic resins.

6. The automobile structure of claim 1, wherein components of the safety cell are joined using blade and clevis joints.

7. The automobile structure of claim 1, wherein the safety cell comprises:
a rear floor having a forward portion, middle portion, and rear portion, and a left side and a right side;
a firewall upper attached to the front portion of the rear floor;
a B-frame attached to the middle portion of the rear floor;
a C-frame attached to the middle portion of the rear floor, wherein the C-frame is closer the rear portion of the rear floor than the B-frame;
a left bodyside attached to the firewall upper, the B-frame, the C-frame, and the rear floor;
a right bodyside attached to the firewall upper, the B-frame, the C-frame, and the rear floor;
a tailgate ringframe attached to the left bodyside, the right bodyside, and the rear portion of the rear floor;
a firewall lower attached to the left bodyside, the right bodyside, and the firewall upper;
a main floor attached to the left bodyside, the right bodyside, the rear floor, and the tailgate ringframe;
a roof attached to the left bodyside, the right bodyside, the B-frame, the C-frame, and the tailgate ringframe;
a screen surround attached to the firewall lower, the left bodyside, the right bodyside, and the roof;
a left bodyside wedge attached to the left bodyside, the firewall upper, the firewall lower, and the floor; and
a right bodyside wedge attached to the right bodyside, the firewall upper, the firewall lower, and the floor.

8. The automobile structure of claim 7, wherein the B-frame and the C-frame are attached to the left bodyside and the right bodyside using advanced composite blade and clevis joints.

9. The automobile structure of claim 7, wherein the screen surround includes blades that attach to a clevis of the left bodyside and the right bodyside.

10. The automobile structure of claim 7, wherein the left bodyside and the right bodyside have clevis assembly interfaces adapted to join blades of components that join the left bodyside and the right bodyside.

11. The automobile structure of claim 7, wherein the left bodyside and the right bodyside are made of an advanced composite and have a foam sandwich core.

12. The automobile structure of claim 1, further comprising an exterior skin applied over the safety cell, the subframe, and the front crush structure, wherein the exterior skin is made of an unreinforced thermoplastic.

13. An automobile suspension component comprising a member having a closed cross-section, and wherein the member is made of an advanced composite.

14. The automobile suspension component of claim 13, wherein the closed cross-section is substantially equal to the maximum internal volume for a given surface.

15. The method of claim 13, further comprising a mechanical interface made of a sleeve type single lap bonded metallic insert.

16. The method of claim 13, wherein the advanced composite is a highly aligned reinforcement of one of carbon, glass, and aramid fibers in a suitable polymer matrix of one of thermoset resins and thermoplastic resins.

17. A suspension and traction motor unit comprising:
a trailing arm made of an advanced composite, wherein the trailing arm has a housing;
a motor mounted within the housing;
a transmission attached to housing and coupled to the motor;
a brake assembly coupled to the transmission, wherein the transmission is disposed between the trailing arm and the brake assembly; and
a suspension strut attached to the trailing arm.

18. The suspension and traction motor unit of claim 17, wherein the trailing arm has an integrally molded bushing adapted to attach the suspension and traction motor unit to a vehicle structure.

19. The method of claim 17, wherein the advanced composite is a carbon fiber reinforced polymer.

20. The method of claim 17, wherein the motor is a hub motor.

21. The method of claim 17, wherein the transmission is a step down epicyclic gearbox.

22. A powertrain system for a fuel cell hybrid-electric vehicle comprising:
a fuel cell having a positive terminal and a negative terminal, wherein the negative terminal is grounded;
a diode in communication with the positive terminal of the fuel cell;
a capacitor in communication with the diode and the negative terminal of the fuel cell;
a load-leveling battery module having a positive terminal and a negative terminal, wherein the negative terminal is grounded;
a low voltage dc/dc converter;
a front inverter;
a rear inverter;
a controller having a junction in communication with the diode and the low voltage dc/dc converter, wherein the controller has a high voltage dc/dc converter, a first bi-directional switch, a second bi-directional switch, and a third bi-directional switch,
wherein the input of the first bi-directional switch is in communication with the junction and the high voltage dc/dc converter,
wherein the output of the first bi-directional switch is in communication with the positive terminal of the load-leveling battery module, with the input of the second bi-directional switch, and with the input of the third bi-directional switch,
wherein the input of the second bi-directional switch and the input of the third bi-directional switch are in communication with the junction,
wherein the output of the second bi-directional switch is in communication with the front inverter, and
wherein the output of the third bi-directional switch is in communication with the rear inverter.

23. The powertrain system of claim 22, wherein the first bi-directional switch is rated at approximately 35 kW, the second bi-directional switch is rated at approximately 47 kW, and the third bi-directional switch is rated at approximately 23 kW.

24. The powertrain system of claim 22, wherein the first bi-directional switch provides three states of connectivity between the fuel cell and the load-leveling battery module, wherein the three states are connected through the high-voltage dc/dc converter, connected directly, and not connected.

25. The powertrain system of claim 23, wherein the second bi-directional switch provides the front inverter with power from one of the fuel cell, the load-leveling battery module, and a combination of the fuel cell and the load-leveling battery module, and
wherein the third bi-directional switch provides the rear inverter with power from one of the fuel cell, the load-leveling battery module, and a combination of the fuel cell and the load-leveling battery module.

26. A suspension system comprising:
four pneumatic/electromagnetic linear-ram suspension struts;
a pneumatically variable transverse link at each axle; and
a digital control system.

27. A power supply system for a hybrid-electric vehicle comprising:
a ring main that powers non-traction electrical loads of the vehicle;
a dual-fused junction box within the ring main;
a branch wire in communication with the dual-fused junction box; and
a vehicle component in communication with the branch wire.

28. The power system of claim 27, wherein the ring main is powered by a battery and a dc/dc converter that draws power from a powertrain of the vehicle.

29. A control system for a hybrid-electric vehicle comprising:
a body controller that controls body components of the vehicle via a low-speed controller area network;
a dynamics controller that controls propulsion components of the vehicle via a high-speed controller area network and controls steering and braking components via a fault tolerant TTP/C network; and
a data backbone that connects the body controller to the vehicle dynamics controller.

30. The control system of claim 29, further comprising a telematics controller that receives requests for off-board data from the body controller and the vehicle dynamics controller, wherein the telematics controller is connected to the data backbone.
